(19) United States
(12) Patent Application Publication
(10) Pub. No.: US 2025/0183381 A1
(43) Pub. Date: Jun. 5, 2025

(54) MICROBALLASTED ELECTRODES

(71) Applicant: UT-Battelle, LLC, Oak Ridge, TN (US)

(72) Inventors: GABRIEL M. VEITH, Knoxville, FL (US); KHRYSLYN ARANO, Grenoble (FR); BETH L. ARMSTRONG, Oak Ridge, TN (US)

(73) Assignee: UT-Battelle, LLC, Oak Ridge, TN (US)

(21) Appl. No.: 18/943,433

(22) Filed: Nov. 11, 2024

Related U.S. Application Data
(60) Provisional application No. 63/606,165, filed on Dec. 5, 2023.

(51) Int. Cl. H01M 10/42; H01M 4/02; H01M 4/04; H01M 4/131; H01M 4/36; H01M 4/505; H01M 4/58; H01M 4/62

(52) U.S. Cl. CPC H01M 10/4235; H01M 4/0404; H01M 4/0471; H01M 4/131; H01M 4/366; H01M 4/505; H01M 4/5825; H01M 4/62; H01M 2004/021

(57) ABSTRACT

An electrode includes an electrode active material layer comprising electrode active heteroclusters. The electrode active heteroclusters include an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The metal particles of an electrode active heterocluster are in electrical contact with at least one adjacent electrode active heterocluster. A method of making an electrode, a battery, and a method of making a battery are also disclosed.

### CROSS-REFERENCE TO RELATED APPLICATIONS

This application claims priority to US 63/606,165 filed on Dec. 5, 2023, entitled “MICROBALLASTED ELECTRODES”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by United States Department of Energy. The government has certain rights in this invention.

### FIELD OF THE INVENTION

The present invention relates to electrodes, batteries, methods of making electrodes, and methods of making batteries, and more particularly to electrodes with improved electrical connectivity.

### BACKGROUND OF THE INVENTION

A challenge confronting the development of battery electrodes is the ability to rapidly and reversibly intercalate alkali ions like lithium and sodium in the working electrode material. This is particularly true in materials such as silicon which has extremely high theoretical energy densities, a capacity of ˜3600 milli-amp hours/gram (mAh/g) which is almost 11 times larger than traditional graphite electrodes (330 mAh/g). One of the challenges is that the silicon electrode undergoes extensive volumetric expansion and contraction during lithiation and delithiation resulting in a constant destruction of the passivating solid electrolyte interphase that forms on the outer surface of the silicon during cycling. This constant reformation of the passivation layer consumes electrolyte components including lithium salts like LiPF₆, solvent molecules like ethylene carbonate and ethyl methyl carbonate and additives like fluorinated ethylene carbonate. This consumption reduces calendar life and prevents long term cyclability of the electrochemical cells.

A second challenge with silicon electrodes is that the surface chemistry of silicon powders is dominated by silicon oxide. This silicon oxide has an acidic nature due to the low isoelectric point (<pH=2). Carbon additives can be used in electrode formulation to improve slurry rheology and interconnects, however, carbon tends to have a higher isoelectric point (>pH=5). These differences in isoelectric points prevent suitable interconnections and mixing. The poor interconnects limit ion transport and homogeneity of the lithium insertion process.

A third challenge is the negative role of carbon with respect to electrolyte stability. The addition of carbon introduces catalytic sites that promote the self-catalyzed decomposition of the battery electrolyte made up of lithium salts like LiPF₆, solvent molecules like ethylene carbonate and ethyl methyl carbonate and additives like fluorinated ethylene carbonate. This consumption causes the premature death of the battery electrodes and poor cycling capability.

### SUMMARY OF THE INVENTION

An electrode includes an electrode active material layer having electrode active heteroclusters. The electrode active heteroclusters include an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The metal particles of an electrode active heterocluster are in electrical contact with at least one adjacent electrode active heterocluster.

The non-homogeneous distribution of the metal particles over the outer surface of the electrode active material particle includes a metal particle dense portion relative to other portions of the electrolyte contacting outer surface. The metal particle dense portions can be oriented in a common direction. The electrode can include a current collector. The metal particle dense portions of the electrode active heteroclusters can be substantially oriented toward the current collector. The heteroclusters of metal particles are capable of forming an electrochemical double layer in the electrolyte adjacent the electrolyte contacting surface.

The metal particles can have a largest dimension of from 5 nm to 100 nm. The metal particles can have a thickness of from 1 to 20 monolayers. The electrode active material particles can have a largest dimension of from 10 nm to 10 microns. The electrode active heteroclusters can have a largest dimension of from 5 nm to 1.1 microns. The electrolyte contacting outer surface has a surface area, and the metal particles can cover from 5% to 50% of the surface area of the electrolyte contacting surface.

The electrode can be an anode and the electrode active material can include at least one selected from the group consisting of Si, graphite, Li₄Ti₅O₁₂, Sn, and Sb. The electrode can be a cathode and the electrode active material can include at least one selected from the group consisting of Li(MnNiCo)O₂, LiFePO₄, LiMnPO₄, LiMn_{1.5}Ni_{0.5}O₄, and LiMn₂O₄.

The metal particles can include at least one selected from the group consisting of Cu, Ni, Ag, Al, Fe, Ti, Y, or Ce. The metal particles are confined to the electrolyte contacting outer surface through at least one selected from the group consisting of van der Waals, ionic, static, and steric forces. The metal particles of the electrode active heteroclusters have a reduction potential around ±0.5V relative to H₂/H⁺.

A method of making an electrode can include the steps of providing a plurality of heteroclusters. The heteroclusters include an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The non-homogeneous distribution of the metal particles over the outer surface of the electrode active material particle includes a metal particle dense portion relative to other portions of the electrolyte contacting outer surface.

A solvent mixture is prepared with the heteroclusters in a solvent. The solvent mixture is formed into an electrode preform, wherein the metal particle dense portions are oriented in a common direction under the influence of gravity. The solvent is removed from the electrode preform to form an electrode wherein the metal particles of an electrode active heterocluster are in electrical contact with at least one adjacent electrode active heterocluster.

The step of removing solvent from the electrode preform can include heating the electrode preform. The heating step can include heating the electrode preform to a temperature below 300° C. The step of forming the solvent mixture into an electrode preform can include the step of applying the solvent mixture to a current collector. The mixing step can include ball milling with media having a largest dimension greater than 20 times the largest dimension of the electrode active material particles.

The metal particles can have a largest dimension of from 5 nm to 100 nm. The electrode active material particles can have a largest dimension of from 10 nm to 10 microns. The electrode active heteroclusters have a largest dimension of from 5 nm to 1.1 microns.

A battery can include an electrode comprising an electrode active material layer comprising electrode active heteroclusters. The electrode active heteroclusters can include an electrode active material particle having an electrolyte contacting outer surface and a plurality of metal particles non-homogeneously distributed around and confined to and in electrical contact with the electrolyte contacting outer surface. The metal particles can have a largest dimension that is smaller than the largest dimension of the electrode active material particle to which they are attached. The metal particles of an electrode active heterocluster are in electrical contact with at least one adjacent electrode active heterocluster.

An electrode of the battery can be an anode and the electrode active material can be at least one selected from the group consisting of Si, graphite, Li₄Ti₅O₁₂, Sn, and Sb. An electrode of the battery can be a cathode and the electrode active material can be at least one selected from the group consisting of Li(MnNiCo)O₂, LiFePO₄, LiMnPO₄, LiMn_{1.5}Ni_{0.5}O₄, and LiMn₂O₄. The metal particles can include at least one selected from the group consisting of Cu, Ni, Ag, Al, Fe, Ti, Y, or Ce.

A method of making a battery can include the step of providing a plurality of heteroclusters comprising an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The non-homogeneous distribution of the metal particles over the outer surface of the electrode active material particle can include a metal particle dense portion relative to other portions of the electrolyte contacting outer surface. A solvent mixture of the heteroclusters in a solvent is prepared. The solvent mixture is formed into an electrode preform. The metal particle dense portions are oriented in a common direction under the influence of gravity. The metal particles of an electrode active heterocluster are in electrical contact with at least one adjacent electrode active heterocluster. The solvent is removed from the electrode preform to form an electrode. The electrode is electrically connected to a counter electrode and an electrolyte is added to form a battery. The step of forming the solvent mixture into an electrode preform can include the step of applying the solvent mixture to a current collector.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic cross section of an electrode comprising electrode active heteroclusters.

FIG. 2 is a schematic cross section of the electrode of FIG. 1 in a battery with an electrolyte and alkali metal.

FIG. 3 is a schematic cross section of the electrode of FIG. 2 showing electron transport pathways through the electrode.

FIG. 4 is a schematic cross section of a prior art electrode showing electron transport pathways through the electrode.

FIG. 5 is a schematic cross section of a ball milling process for making electrode active heteroclusters.

FIG. 6 is a schematic cross section of electrode active heteroclusters.

FIG. 7 is a schematic cross section depicting the orienting of electrode active heteroclusters during a process of making an electrode.

FIG. 8 is a schematic cross section depicting a first step in the formation of an electrode by a process according to the invention.

FIG. 9 is a schematic cross section depicting of a second step in the formation of an electrode by a process according to the invention.

FIG. 10 is a schematic cross section depicting a third step in the formation of an electrode by a process according to the invention.

FIG. 11 is a schematic cross section of a first heterocluster design.

FIG. 12 is a schematic cross section of a second heterocluster design.

FIG. 13 is a schematic cross section of a third heterocluster design.

FIG. 14 is a schematic cross section of a first non-preferable heterocluster design.

FIG. 15 is a schematic cross section of a second non-preferable heterocluster design.

FIG. 16 is a schematic cross section of a third non-preferable heterocluster design.

FIG. 17 shows the specific discharge capacity (mAh g_{Si}⁻¹) versus cycle number obtained for baseline material (Si).

FIG. 18 shows the specific discharge capacity (mAh g_{Si}⁻¹) versus cycle number obtained for Si^{Cu} (10 vol % Cu) with a mass ratio of 20:35 for Cu:Si.

FIG. 19 shows the specific discharge capacity (mAh g_{Si}⁻¹) versus cycle number obtained for Si^{Ni} (10 vol % Ni) with a mass ratio of 20:35 for Ni:Si.

FIG. 20 shows the specific discharge capacity (mAh g_{Si}⁻¹) versus cycle number obtained for Si^{Ti} (10 vol % Ti) with a mass ratio of 10:35 for Ti:Si.

FIG. 21 shows the specific discharge capacity (mAh g_{Si}⁻¹) versus cycle number obtained for Si^{Fe} (10 vol % Fe) with a mass ratio of 17:35 for Fe:Si.

FIG. 22 shows the specific discharge capacity (mAh g_{Si}⁻¹) versus cycle number obtained for Si^{Al} (10 vol % Al) with a mass ratio of 6:35 for Al:Si.

FIG. 23 shows the specific discharge capacity (mAh g_{Si}⁻¹) versus cycle number obtained for Si^{Y} (10 vol % Y) with a mass ratio of 10:35 for Y:Si.

FIG. 24 shows the specific discharge capacity (mAh g_{Si}⁻¹) versus cycle number obtained for Si^{Ag} (10 vol % Ag) with a mass ratio of 20:35 for Ag:Si.

FIGS. 25 and 26 show specific discharge capacity (mAh g_{Si}⁻¹) versus cycle number obtained for baseline Si and Si (10 vol % M) with a mass ratio of 20:35 for Cu:Si, 20:35 for Ni:Si, 10:35 for Ti:Si, 17:35 for Fe:Si, 6:35 for Al:Si, 10:35 for Y:Si, and 20:35 for Ag:Si.

FIGS. 27 and 28 show Nyquist plots after the 20^{th} delithiation in half-cell obtained for baseline Si.

FIGS. 29 and 30 show Nyquist plots after the 20^{th} delithiation in half-cell obtained for Si^{Cu} (10 vol % Cu) with a mass ratio of 20:35 for Cu:Si.

FIGS. 31 and 32 show Nyquist plots after the 20^{th} delithiation in half-cell obtained for Si^{Ni} (10 vol % Ni) with a mass ratio of 20:35 for Ni:Si.

FIGS. 33 and 34 show Nyquist plots after the 20^{th} delithiation in half-cell obtained for Si^{Ti} (10 vol % Ti) with a mass ratio of 10:35 for Ti:Si.

FIGS. 35 and 36 show Nyquist plots after the 20^{th} delithiation in half-cell obtained for Si^{Fe} (10 vol % Fe) with a mass ratio of 17:35 for Fe:Si.

FIGS. 37 and 38 show Nyquist plots after the 20^{th} delithiation in half-cell obtained for Si^{Al} (10 vol % Al) with a mass ratio of 6:35 for Al:Si.

FIGS. 39 and 40 show Nyquist plots after the 20^{th} delithiation in half-cell obtained for Si^{Y} (10 vol % Y) with a mass ratio of 10:35 for Y:Si.

FIGS. 41 and 42 show comparisons of the Nyquist plots after the 20^{th} delithiation in half-cell obtained for baseline Si and Si (10 vol % M) with a mass ratio of 20:35 for Cu:Si, 20:35 for Ni:Si, 10:35 for Ti:Si, 17:35 for Fe:Si, 6:35 for Al:Si, 10:35 for Y:Si, and 20:35 for Ag:Si.

FIG. 43 shows the specific discharge capacity (mAh g_{Si}⁻¹) versus cycle number obtained for baseline Si and Si^{M} (10 vol % M) with a mass ratio of 20:35 for Cu:Si, 20:35 for Ni:Si, 10:35 for Ti:Si, 17:35 for Fe:Si, 6:35 for Al:Si, and 10:35 for Y:Si at varying C-rates including C/10, C/10, C/5, C/3, C, 2 C.

FIG. 44 shows the specific discharge capacity (mAh g_{Si}⁻¹) versus cycle number obtained for Si^{Ni} (5 vol % Ni) with a mass ratio of 10:35 for Ni:Si.

FIG. 45 shows the specific discharge capacity (mAh g_{Si}⁻¹) versus cycle number obtained for Si^{Ti} (5 vol % Ti) with a mass ratio of 5:35 for Ti:Si.

FIG. 46 shows the specific discharge capacity (mAh g_{Si}⁻¹) versus cycle number obtained for Si^{Fe} (5 vol % Fe) with a mass ratio of 8.5:35 for Fe:Si.

FIG. 47 shows the specific discharge capacity (mAh g_{Si}⁻¹) versus cycle number obtained for Si^{Al} (5 vol % Al) with a mass ratio of 3:35 for Al:Si.

FIG. 48 shows the specific discharge capacity (mAh g_{Si}⁻¹) versus cycle number obtained for Si^{Y} (5 vol % Y) with a mass ratio of 5:35 for Y:Si.

FIGS. 49 and 50 show the comparison of the specific discharge capacity (mAh g_{Si}⁻¹) versus cycle number obtained for baseline Si and Si^{M} (5 vol % M) with a mass ratio of 10:35 for Ni:Si, 5:35 for Ti:Si, 8.5:35 for Fe:Si, 3:35 for Al:Si, 5:35 for Y:Si, and 10:35 for Ag:Si.

FIGS. 51 and 52 show Nyquist plots after the 20^{th} delithiation in half-cell obtained for Si^{Ni} (5 vol % Ni) with a mass ratio of 10:35 for Ni:Si.

FIGS. 53 and 54 show Nyquist plots after the 20^{th} delithiation in half-cell obtained for Si^{Ti} (5 vol % Ti) with a mass ratio of 5:35 for Ti:Si.

FIGS. 55 and 56 show Nyquist plots after the 20^{th} delithiation in half-cell obtained for Si^{Fe} (5 vol % Fe) with a mass ratio of 8.5:35 for Fe:Si.

FIGS. 57 and 58 show the comparison of Nyquist plots after the 20^{th} delithiation in half-cell obtained for baseline and Si^{M} (5 vol % M) with a mass ratio of 10:35 for Ni:Si, 5:35 for Ti:Si, 8.5:35 for Fe:Si.

FIG. 59 shows the areal charge capacity (mAh cm⁻²) versus cycle number obtained for the baseline Si.

FIG. 60 shows the areal charge capacity (mAh cm⁻²) versus cycle number obtained for SiCu (10 vol % Cu) with a mass ratio of 20:35 for Cu:Si.

FIGS. 61 and 62 shows the areal charge capacity (mAh cm⁻²) versus cycle number obtained for Si^{Ni} (10 vol % Ni) with a mass ratio of 20:35 for Ni:Si.

FIGS. 63 and 64 show the areal charge capacity (mAh cm⁻²) versus cycle number with two different areal loadings obtained for Si^{Ti} (10 vol % Ti) with a mass ratio of 10:35 for Ti:Si.

FIG. 65 shows the areal charge capacity (mAh cm⁻²) versus cycle number with two different loadings obtained for Si^{Al} (10 vol % Al) with a mass ratio of 6:35 for Al:Si.

FIGS. 66 and 67 show the areal charge capacity (mAh cm⁻²) versus cycle number with two different areal loadings obtained for Si^{Fe} (10 vol % Fe) with a mass ratio of 17:35 for Fe:Si.

FIG. 68 shows the areal charge capacity (mAh cm⁻²) versus cycle number obtained for Si^{Y} (10 vol % Y) with a mass ratio of 10:35 for Y:Si.

FIG. 69 shows the areal charge capacity (mAh cm⁻²) versus cycle number obtained for Si^{Ag} (10 vol % Ag) with a mass ratio of 20:35 for Ag:Si.

FIGS. 70-75 show the comparison of the areal charge capacity capacity (mAh cm⁻²) with different areal loadings versus cycle number obtained for Si^{M} (10 vol % M) with mass ratio of Cu:Si (20:35), Ni:Si (20:35), Ti:Si (10:35), Fe:Si (17:35), Al:Si (6:35) Y:Si (10:35), and Ag:Si (20:35).

FIG. 76 shows the areal charge capacity (mAh cm⁻²) versus cycle number obtained for Si^{Ni} (5 vol % Ni) with a mass ratio of 10:35 for Ni:Si.

FIG. 77 shows the areal charge capacity (mAh cm⁻²) versus cycle number obtained for Si^{Ti} (5 vol % Ti) with a mass ratio of 5:35 for Ti:Si.

FIG. 78 shows the areal charge capacity (mAh cm⁻²) versus cycle number obtained for Si^{Fe} (5 vol % Fe) with a mass ratio of 8.5:35 for Fe:Si.

FIG. 79 shows the areal charge capacity (mAh cm⁻²) versus cycle number obtained for Si^{Al} (5 vol % Al) with a mass ratio of 3:35 for Al:Si.

FIG. 80 shows the areal charge capacity (mAh cm⁻²) versus cycle number obtained for Si^{Y} (5 vol % Y) with a mass ratio of 5:35 for Y:Si.

FIG. 81 shows the areal charge capacity (mAh cm⁻²) versus cycle number obtained for Si^{Ag} (5 vol % Ag) with a mass ratio of 10:35 for Ag:Si.

FIGS. 82 and 83 show a comparison of the areal charge capacity (mAh cm⁻²) versus cycle number obtained for Si^{M} (5 vol % M) with mas ratio of Ni:Si (10:35), Ti:Si (5:35), Fe:Si (8.5:35), Al:Si (6:35), and Y:Si (5:35).

FIG. 84 shows parasitic currents for the baseline Si measured during a 180-hour voltage hold period at 4.1 V.

FIG. 85 shows parasitic currents measured for Si^{Cu} (10 vol % Cu) during a 180-hour voltage hold period at 4.1 V.

FIG. 86 shows parasitic currents measured for Si^{Ni} (10 vol % Ni) during a 180-hour voltage hold period at 4.1 V.

FIG. 87 shows parasitic currents measured for Si^{Ti} (10 vol % Ti) during a 180-hour voltage hold period at 4.1 V.

FIG. 88 shows parasitic currents measured for Si^{Fe} (10 vol % Fe) during a 180-hour voltage hold period at 4.1 V.

FIG. 89 shows parasitic currents measured for Si^{Al} (10 vol % Al) during a 180-hour voltage hold period at 4.1 V.

FIG. 90 shows parasitic currents measured for Si^{Y} (10 vol % Y) during a 180-hour voltage hold period at 4.1 V.

FIG. 91 shows parasitic currents measured for Si^{Ag} (10 vol % Ag) during a 180-hour voltage hold period at 4.1 V.

FIG. 92 shows the comparison of the parasitic currents for Si^{M} (10 vol % M) measured during a 180-hour voltage hold period at 4.1 V.

FIG. 93 shows a TEM annular dark-field image of SiCu (20:35 Cu:Si or 10 vol % Cu) and TEM EELS image for Cu showing clusters of Cu dotting the surface of Si.

FIG. 94 shows a TEM annular dark-field image of Si^{Ni} (20:35 Ni:Si or 10 vol % Ni) and TEM EELS image for Ni showing clusters of Ni dotting the surface of Si.

FIG. 95 shows a TEM annular dark-field image of SiTi (10:35 Ti:Si or 10 vol % Ti) and TEM EELS image for Ti showing clusters of Ti dotting the surface of Si.

FIG. 96 shows a TEM annular dark-field image of SiFe (17:35 Fe:Si or 10 vol % Fe) and TEM EELS image for Fe showing clusters of Fe dotting the surface of Si.

FIG. 97 shows a TEM annular dark-field image of SiAl (6:35 Al:Si or 10 vol % Al) and TEM EELS image for Al showing clusters of Al dotting the surface of Si.

FIG. 98 shows a TEM annular dark-field image of Si^{Y} (10:35 Y:Si or 10 vol % Y) and TEM EELS image for Y showing clusters of Y dotting the surface of Si.

FIGS. 99-104 show the impedance data measured for bare silicon, PVD grown silicon and Si^{Cu} electrodes.

FIGS. 105-107 show two unique features as measured in half cell geometries with 3% FEC in 1.2M LiPF₆ EC/EMC (3:7 wt %).

FIGS. 108-111 show the power of the unique microballast geometry measurements in half cell geometries with 3% FEC in 1.2M LiPF₆ EC/EMC (3:7 wt %).

### DETAILED DESCRIPTION OF THE INVENTION

An electrode includes an electrode active material layer comprising electrode active heteroclusters. The electrode active heteroclusters include an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The metal particles of an electrode active heterocluster are in electrical contact with at least one adjacent electrode active heterocluster.

The non-homogeneous distribution of the metal particles over the outer surface of the electrode active material particle includes a metal particle dense portion relative to other portions of the electrolyte contacting outer surface. The metal particle dense portions are oriented in a common direction, usually by gravity during the manufacturing process, but also by such methods as magnetically assisted processes which would have the action of orienting the metal particle enriched portions in a common direction. The particles have a center of mass despite their non-symmetric structures. With the metal heteroclusters the center of mass is shifted towards the highest concentration of metal (heaviest) particles. The result causes the gravitational torque on the particles to change relative to the substrate pulling the heavier part of the electrode material (particle) down to the metal current collector where it orients with the surface.

The electrode can include a current collector. The metal particle dense portions of the electrode active heteroclusters are oriented toward the current collector. Some of the metal particles of heteroclusters are in contact with the current collector and can be attached to the current collector. The nature of the bonding is through van der Waals and electrostatic bonds. The bonds are short range in distance and result in point contact connections. Further compounding the adhesive forces is the application of a polymer binder which act to trap the electrode particles to other particles and the metal current collector through strong adhesive bonds between the current collector and polymer binder through van der Waals and electrostatic attraction.

The size of the electrode active heteroclusters, the metal particles, and the electrode active material particles can vary. The metal particles can have a largest dimension of from 5 nm to 100 nm. The largest dimension of the metal particles can be 5, 10, 15, 20, 25, 30, 35, 40, 45, 50, 55, 60, 65, 70, 75, 80, 85, 90, 95, or 100 nm, and can be within a range of any high value and low value selected from these values. Other dimensions are possible.

The metal particles can have a thickness of from 1 to 20 monolayers. The thickness of the metal particles can be 1, 2, 3, 4, 5, 6, 7, 8, 9, 10, 11, 12, 13, 14, 15, 16, 17, 18, 19 or 20 monolayers. The thickness of the metal particles can be within a range of any high value and low value selected from these values. Other thicknesses are possible.

The electrode active material particles can have a largest dimension of from 10 nm to 10 microns. The largest dimension of the electrode active material particles can be 10, 20, 50, 75, 100, 500, 750, 1000, 1250, 1500, 1750, 2000, 2250, 2500, 2750, 3000, 3250, 3500, 3750, 4000, 4250, 4500, 4750, 5000, 5250, 5500, 5750, 6000, 6250, 6500, 6750, 7000, 7250, 7500, 7750, 8000, 8250, 8500, 8750, 9000, 9250, 9500, 9750 or 10000 nm. The largest dimension of the electrode active material particles can be within a range of any high value and low value selected from these values. Other dimensions are possible. These sizes are for the primary particles not an aggregate or agglomerate of particles to form a larger structure.

The electrode active heteroclusters have the largest dimension of from 5 nm to 1.1 microns. The largest dimension of the electrode active material particles can be 5, 15, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, or 1100 nm. The largest dimension of the electrode active heteroclusters can be within a range of any high value and low value selected from these values. Other dimensions are possible.

The electrolyte contacting outer surface of the electrode active material particle has a surface area, and the metal particles can cover from 5% to 50% of the surface area of the electrolyte contacting surface. The metal particles can cover 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% of the surface area of the outer surface of the electrode active material particle, and can be within a range of any high value and low value selected from these values. Other percentages are possible.

The electrode can be used for many purposes including as an anode or a cathode. The electrode when used as an anode can have an electrode active material that can comprise at least one selected from the group consisting of Si, graphite, Li₄Ti₅O₁₂, Sn, and Sb. Other electrode active materials for an anode are possible. The electrode when used as a cathode can have an electrode active material that can comprise at least one selected from the group consisting of Li(MnNiCo)O₂, LiFePO₄, LiMnPO₄, LiMn_{1.5}Ni_{0.5}O₄, and LiMn₂O₄. Other electrode active materials for a cathode are possible.

The metal particles comprise at least one selected from the group consisting of Cu, Ni, Ag, Al, Fe, Ti, Y, or Ce. Combinations of these metals, other metals, and alloys comprising these metals are also possible. The metal particles are heavier than a similar volume of the electrode active material.

The metal particles are confined to the electrolyte contacting outer surface of the electrode active material. The term confined as used herein means that the metal particles once combined with and secured to the electrode active material particles will not move from their position during normal operation of the electrode. The manner that the metal particles can be so confined to the outer surface of the electrode active material particles can vary. The metal particles can be confined or attached to the outer surface of the electrode active material particles by at least one selected from the group consisting of van der Waals, ionic, static, and steric forces. Other methods of confining the metal particles are possible.

The metal particles of the electrode active heteroclusters have a reduction potential around ±0.5V relative to H₂/H⁺. Metals with reduction potentials greater than ±0.5V relative to H₂/H⁺ are not good candidates due to their readily oxidizing or difficulty in reducing. Materials that reduce at very low potentials (<−0.5 V (vs. H₂/H⁺) are difficult to produce the resulting metallic species and thus remain oxidized and not sufficiently electrically conducting. Species that have a tendency to oxidize (reduction potential >0.5 V vs. H₂/H⁺) want to oxidize and will react with liquid electrolyte to generate gas. Very low reduction potential metals like Na, Ca, K, etc. alloy with Li electrochemically and are not of interest due to this alloying and the resulting poor electrochemical cycling performance of the resulting alloy.

The heteroclusters of metal particles are capable of forming an electrochemical double layer in the electrolyte adjacent the electrolyte contacting surface. The addition of large metal atoms will form large electrochemical double layers e.g. Pb make a large diffuse double layer and increase the activation energy of lithium desolvation impeding lithium transport. Smaller ions like Ti⁴⁺ will generate more condensed double layers forming a driving force to pull lithium ions towards the surface. This pulling to the surface promotes desolvation by pulling the Li density closer to the surface and driving off the solvation sphere from the liquid electrolytes. The metals will create an electrochemical double layer through field effects where the metals under negative polarization promote attraction of the cationic Li⁺ through electrostatics.

A method of making an electrode includes the step of making or providing a plurality of heteroclusters. The heteroclusters comprise an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The non-homogeneous distribution of the metal particles over the outer surface of the electrode active material particle includes a metal particle dense portion relative to other portions of the electrolyte contacting outer surface. A solvent mixture of the heteroclusters in a solvent is prepared. The solvent mixture is formed into an electrode preform. The metal particle dense portions are oriented in a common direction under the influence of a force such as gravity which acts on the metal particles. The step of forming the solvent mixture into an electrode preform can include the step of applying the solvent mixture to a current collector.

The solvent is removed from the electrode preform to form an electrode wherein the metal particles of an electrode active heterocluster are in electrical contact with at least one adjacent electrode active heterocluster. The step of removing solvent from the electrode preform can include heating the electrode preform. The heating step comprises heating the electrode preform to a temperature below 300° C. Drying temperatures that exceed 300° C. promote solid state reactions between the electrode material and the metal heteroclusters forming new crystalline phases that could be electrochemically active as lithium ion anode materials but may have intercalation or alloying potentials greater than the desired potential of the original electrode. This increase in potential is detrimental as it decreases the working voltage of the resulting battery. Second, higher temperatures promotes the decomposition of polymer organic components used to make the resulting battery electrode through use as a binder.

A binder can be added to the solvent mixture to assist in formation of the electrode. Suitable binders include, but are not limited to, polyimide, poly acrylic acid, carboxymethyl cellulose, poly vinyl difluoride, styrene butyl rubber, butadiene, styrene, Teflon, and mixtures therein. The choice of binder depends on the electrode of interest with some materials like polyimide, poly acrylic acid, carboxymethyl cellulose, styrene butyl rubber, butadiene, styrene being more favorable for silicon anodes, while poly vinyl difluoride, Teflon, poly acrylic acid, and carboxymethyl cellulose being more favorable for oxide cathodes, and while poly vinyl difluoride, poly acrylic acid, and carboxymethyl cellulose being more aligned with graphite anodes. The choice of binder molecular weight depends on its use as a dispersant (low molecular weights <25,000 mass units) or as a strong binder (>25,000 mass units). For example it is common for those in the field to use small molecular weight materials as dispersants to homogenize slurries during electrode fabrication and larger molecular weights to hold the electrode together by binding particles of electrode and inactive slurry components with the current collector. Slurries are dried to promote binder segregation and binding to the particles at temperatures between 5° and 450° C. Mixtures of binders are often used to bind materials with different affinities to the various binders (e.g. silicon and graphite) and create layers and porosity within the resulting dried electrode.

The mixing step can be any suitable step. The mixing step can include ball milling with media having a largest dimension greater than 20 times the largest dimension of the electrode active material particles. Alternative approaches include spray coating, and recycling metal coated silicon wafers, solution reduction processes through chemical sols and solution precipitation processes. The heterogeneity of the hydroclusters is important. Homogeneous coatings result in blocking of lithium transport and loss of performance through coating all the surface sites.

A battery can be formed from an electrode comprising an electrode active material layer comprising the electrode active heteroclusters. The electrode can be either an anode, a cathode, or both an anode and a cathode. The electrode active material layer can be joined to a current collector. The electrode can be electrically connected to a counter electrode. An electrolyte is added to complete the battery. The electrolyte can be any suitable electrolyte. Suitable electrolytes include a standard aprotic liquid electrolytes such as 1.2M LiPF₆ in ethylene carbonate/dimethyl carbonate. Other combinations include glyme based solvents like dimethoxyethane (DME), diglyme and tetraglyme. Fluorinated ethers like 1,1,2,2-tetrafluoroethyl-2,2,3,3-tetrafluoropropyl ether or 1,1,1-trifluoro-2,3-dimethoxypropane are possible solvents Other carbonate solvents including propylene carbonate, vinylene carbonate, fluoroethylene carbonate, dimethyl carbonate. Mixtures of these materials can be made. The electrolyte salt can be any suitable electrolyte salt. The electrolyte salt can include at least one material selected from the group consisting of lithium hexafluorophosphate, lithium triflate, lithium perchlorate, lithium tetrafluoro borate, lithium hexafluoro lithium arsenate, lithium bis(trifluoromethane sulphone)imide, lithium bis(oxalate) borate, sodium perchlorate, sodium tetrafluoro borate, sodium hexafluoro arsenate, sodium bis(trifluoromethane sulphone)imide, sodium bis(oxalate) borate, sodium hexafluorophosphate and sodium triflate.

A method of making a battery can include the step of providing a plurality of heteroclusters comprising an electrode active material particle having an electrolyte contacting outer surface and a plurality of metal particles non-homogeneously distributed around and confined to and in electrical contact with the electrolyte contacting outer surface. The metal particles have a largest dimension that is smaller than the largest dimension of the electrode active material particle to which they are attached. The non-homogeneous distribution of the metal particles over the outer surface of the electrode active material particle can include a metal particle dense portion relative to other portions of the electrolyte contacting outer surface. A solvent mixture of the heteroclusters in a solvent is prepared. The solvent mixture is formed into an electrode preform. The metal particle dense portions are oriented in a common direction under the influence of a force acting on the metal particles such as gravity. The metal particles of an electrode active heterocluster are in electrical contact with at least one adjacent electrode active heterocluster. The solvent is removed from the electrode preform to form an electrode. The electrode is electrically connected to a counter electrode and adding an electrolyte to form a battery. The step of forming the solvent mixture into an electrode preform comprises the step of applying the solvent mixture to a current collector.

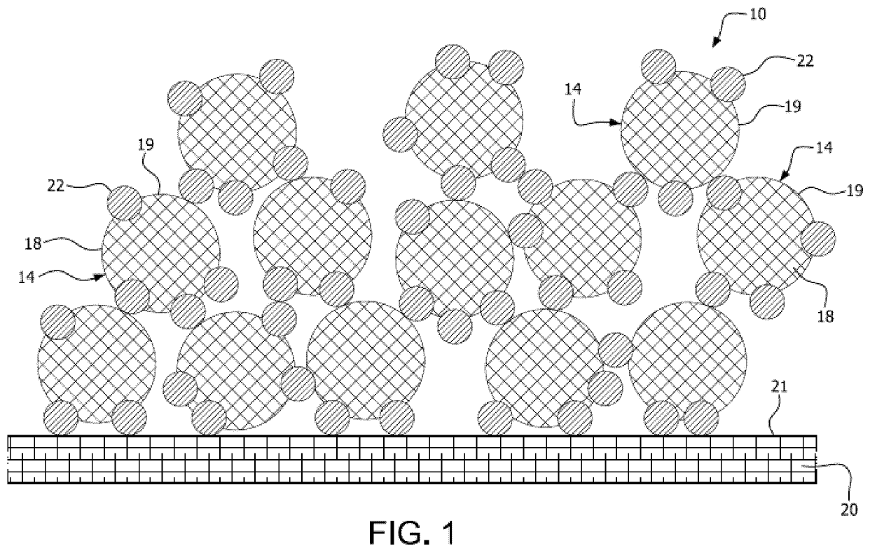

There is shown in FIG. 1 an electrode 10 according to the invention. The electrode 10 includes a plurality of electrode active heteroclusters 14. Each electrode active heterocluster 14 includes an electrode active material particle 18 and a plurality of metal particles 22 confined to an outer surface 24 of the electrode active material particle 18. The heteroclusters 14 can be stacked in contact with one another such that at least one metal particle 22 of each heterocluster 14 is in contact with at least one adjacent heterocluster 14. This contact can be with a metal particle 22 or with an electrode active material particle 18 of that adjacent heterocluster 14.

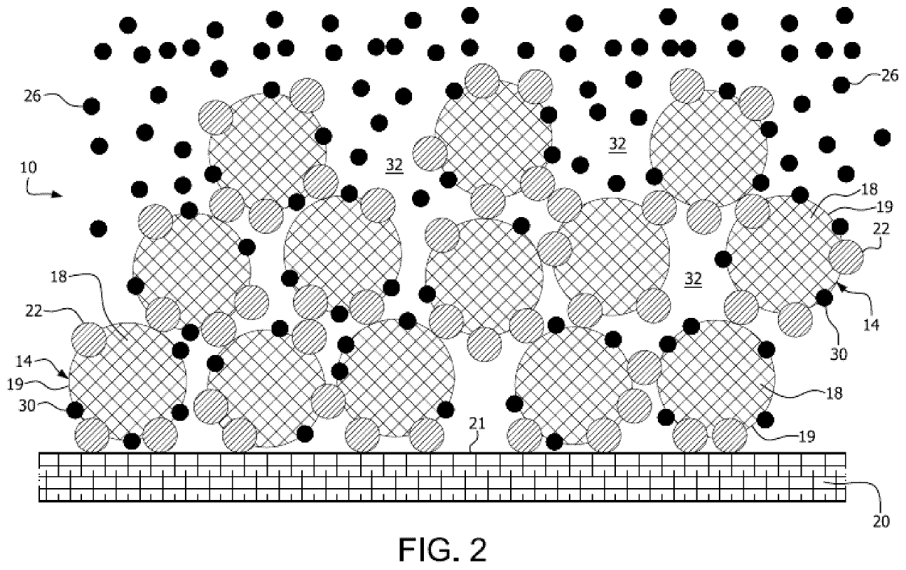

There is shown in FIG. 2 an electrode assembly in which electrolyte 32 has been added along with an appropriate alkali charge carrier such as lithium or sodium ions 26. The alkali ions 26 as is known are reduced at the anode and adhere to the electrode active material particles as elemental lithium or sodium 30.

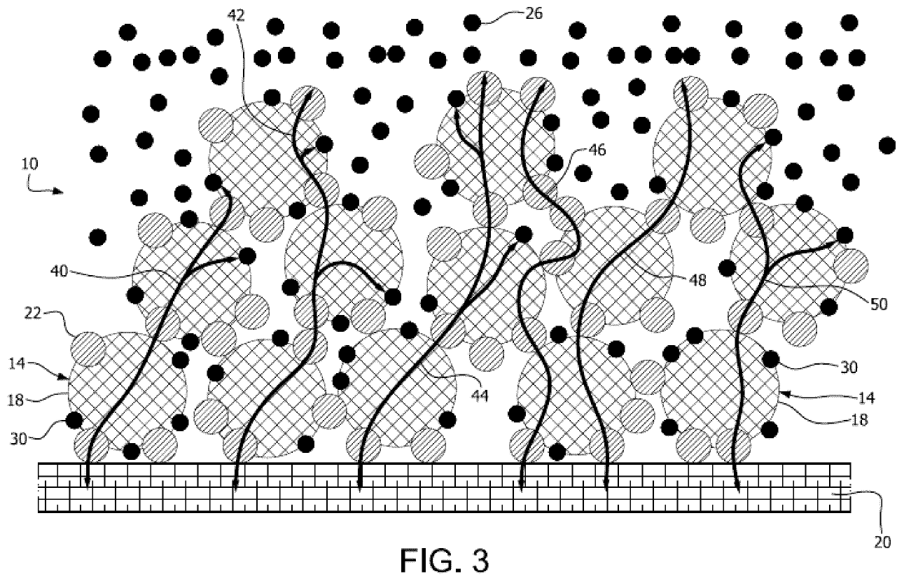

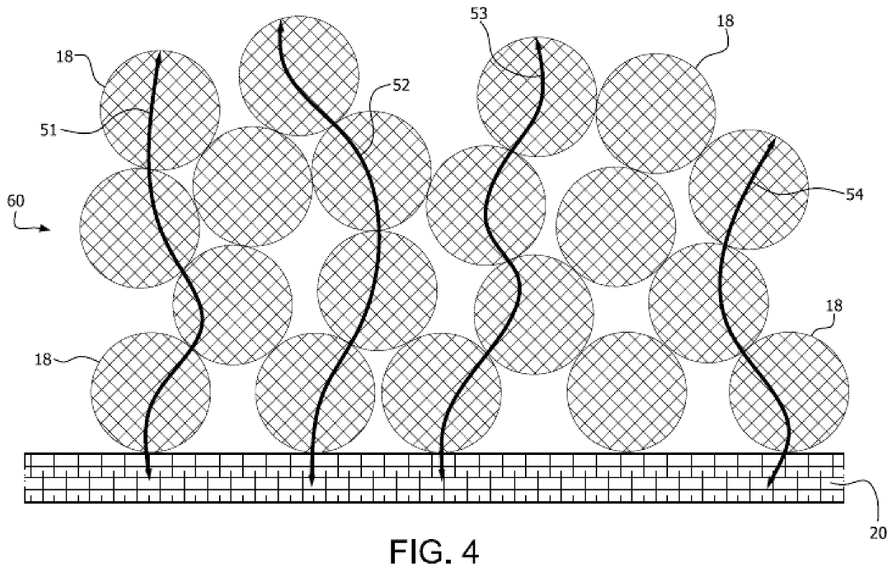

There is shown in FIG. 3 a schematic cross section of the electrode of FIG. 2 showing electron transport pathways 40, 42, 44, 46, 48 and 50 through the electrode 10. It will be understood that the pathways shown are examples of such pathways, and that many other pathways are present in the electrode. As indicated by arrows at each end of the pathways, electron movement can be either in or out of the electrode depending on whether the battery is charging or discharging. Electron flow is facilitated by the presence of the metal particles 22 between adjacent electrode active material particles 18, whether through adjoining metal particles such as Si-M-M-Si, or Si-M-Si. Alternatively, in FIG. 4 there is shown a prior art electrode 60 in which there are no metal particles and thus the electron pathways 51, 52, 53 and 54 are through adjoining electrode active material particles 18 such as Si. Such pathways provide significant resistance to electron flow, whether during charging or discharging.

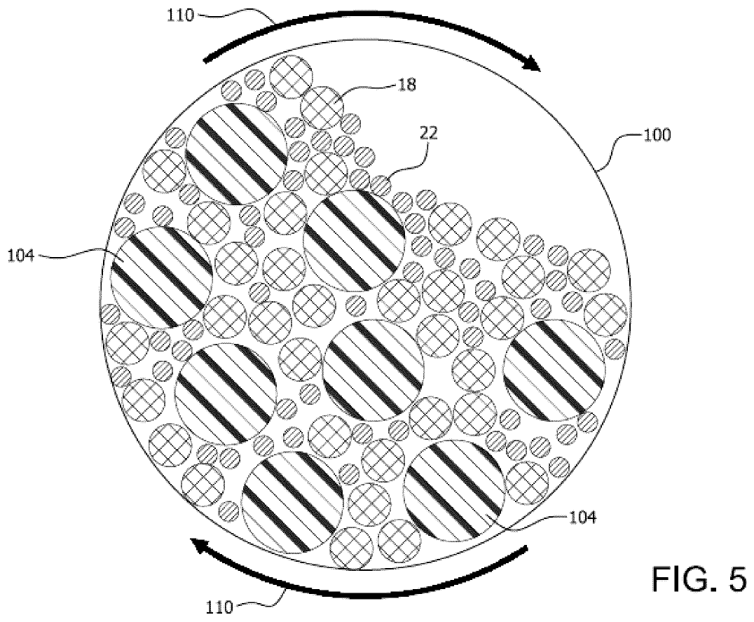

There is shown in FIG. 5 an example of a process to make heteroclusters for use in making electrodes according to the invention. A ball milling apparatus 100 contains ball milling media 104, with electrode active material particles 18 and metal particles 22. The ball milling apparatus is rotated as shown by arrows 110. The rotation of the apparatus 100 causes impacts between the ball milling media 104, the electrode active material particles 18, and the metal particles 22. The imparted energy causes the metal particles 22 to attach to the outer surface of the electrode active material particles in a non-homogeneous coverage of the outer surface of the electrode active material particles 18, forming heteroclusters. Other methods of making the heteroclusters are possible including spray drying, solution precipitation, and crushing metal coated silicon wafers. The heterogeneity of the hydroclusters is important, because a uniform coating is not ideal as this will block surface sites needed for transport as the metal heteroatoms don't alloy with lithium and effectively block transport.

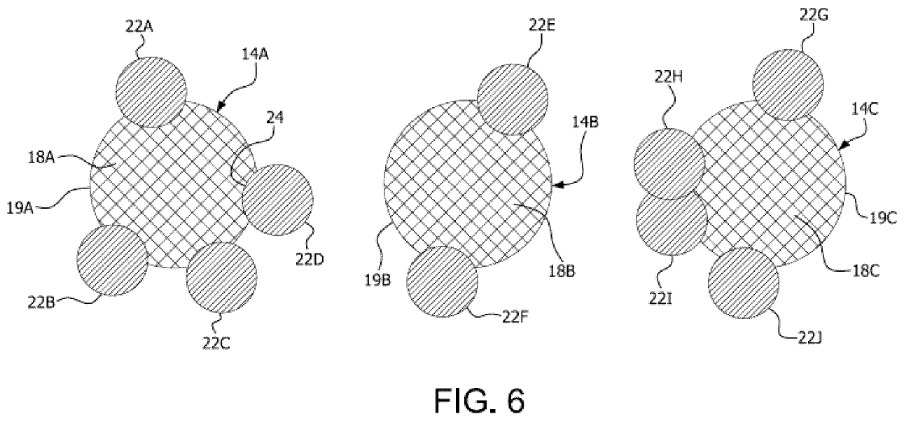

The non-homogeneous distribution of the metal particles on the surface of the electrode active material particles results in non-homogeneous heteroclusters. There is shown in FIG. 6 a heterocluster 14A in which an electrode active material particle 18A has on the outer surface 19A thereof a plurality of metal particles 22 A-D in a first distribution. A heterocluster 14B has metal particles 22 E-F in a second distribution on the outer surface 19B of the electrode active material particle 18B. A heterocluster 14C has metal particles 22 G-J in a third distribution on the outer surface 19C of the electrode active material particle 18C. The attachment of the metal particles is random, and so an almost infinite number of non-homogeneous distributions of metal particles and resulting heteroclusters are possible.

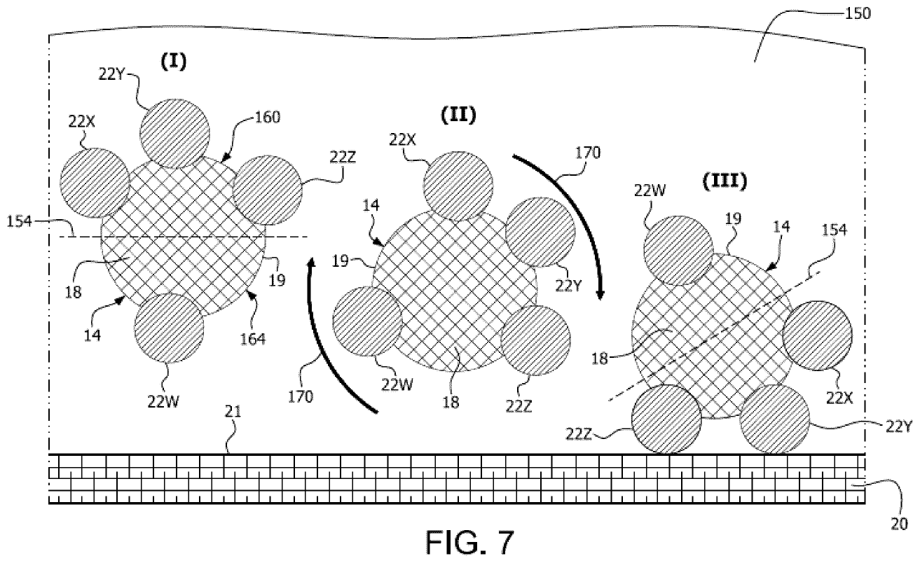

The manner in which the non-homogeneous distribution of metal particles 22 on the electrode active material particle 18 acts to orient the heterocluster is shown in FIG. 7. Step I illustrates a randomly oriented heterocluster 14 which has an electrode active material particle 18 with a plurality of non-homogeneously distributed metal particles 22 W-Z. The metal particles 22X, 22Y and 22Z are on an opposite side of diameter 154 from the metal particle 22W, creating a metal particle dense portion on that opposite side. The heterocluster 14 is suspended in solvent 150 and is applied for example to the current collector 20 to form the electrode. The solvent containing the heteroclusters could be placed into a suitable mold without a current collector. The heterocluster 14 is suspended in the solvent. The force of gravity acts on the heterocluster to pull the metal particle dense portion downward, causing rotation as shown by arrows 170, as shown in step II. The heteroclusters continue to rotate and settle, and eventually contact the current collector 20 or adjacent heteroclusters 14 with the metal particle dense portion oriented substantially downward, in this case toward the current collector 20, as shown in step III.

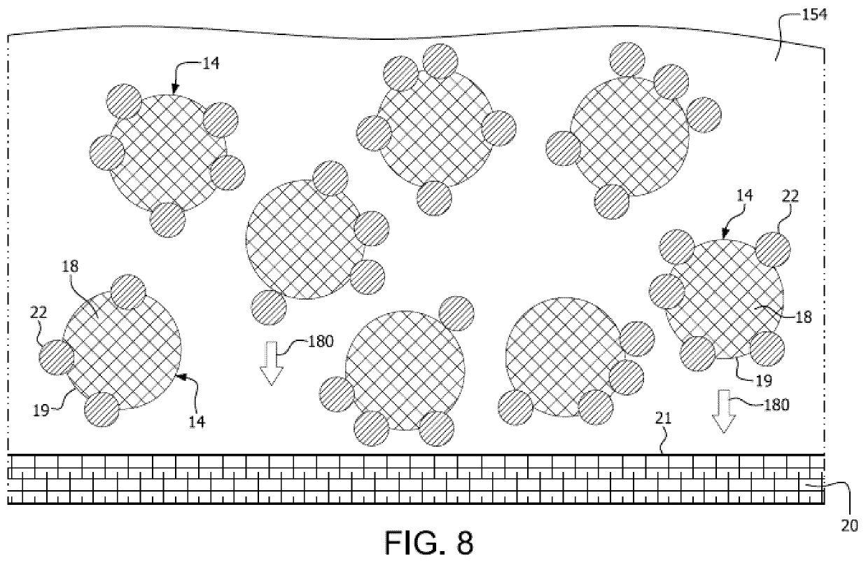

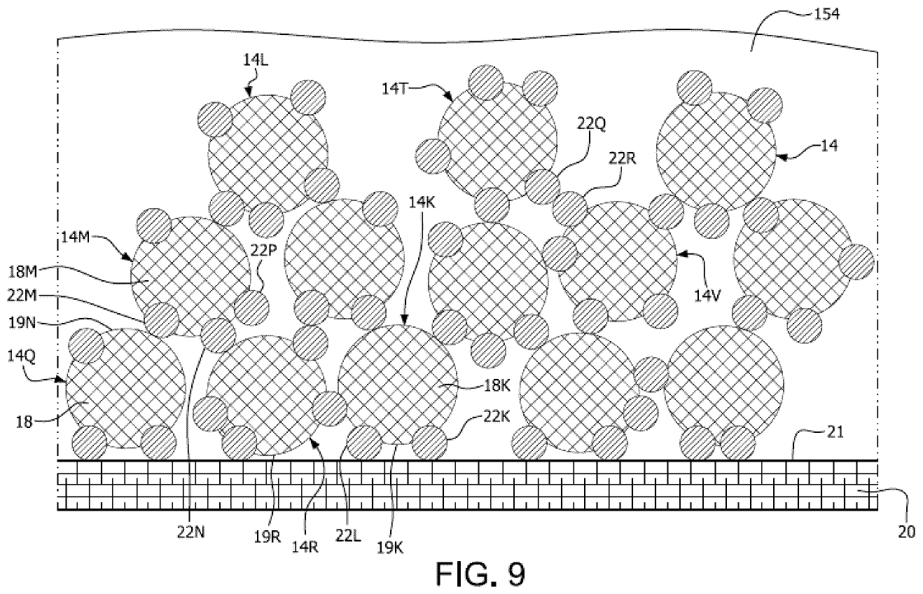

The process to form the electrode begins with a plurality of the heteroclusters 14 suspended in a solvent 154 as shown in FIG. 8. The arrows 180 illustrate that the heteroclusters 14 settle under the influence of gravity downward and toward the current collector 20. The heteroclusters 14 will orient themselves with the most metal particle dense portions of the heterocluster facing in a substantially common direction, as was illustrated in FIG. 7. The heteroclusters 14 settle and adhere to the current collector and to each other to form an electrode preform as shown in FIG. 9. A heterocluster 14K has an electrode active material particle 18K and a metal particle dense portion comprising metal particles 22K and 22L oriented and in contact with the surface 21 of the current collector 20. A heterocluster 14M has an electrode active material particle 18M with a metal particle dense portion comprising metal particles 22M, 22N, and 22P oriented downward and is in contact with adjacent heteroclusters 14Q, 14R and 14L. In some cases, the metal particles of adjacent heteroclusters are in direct electrical contact such as the metal particle 22Q of heterocluster 14T and the metal particle 22R of the heterocluster 14V. Such electrical contact provides an effective pathway for electron transport between the heterocluster 14T and the heterocluster 14V. The metal particles can also be positioned directly between and in contact with adjacent electrode active material particles. Metal particles 22M and 22N associated with heterocluster 14M are in electrical contact with outer surface 19N of heterocluster 14Q and outer surface 19R of heterocluster 14R. The metal particles 22M and 22N thereby provide an electrical pathway between the heterocluster 14M and the heteroclusters 14Q and 14R.

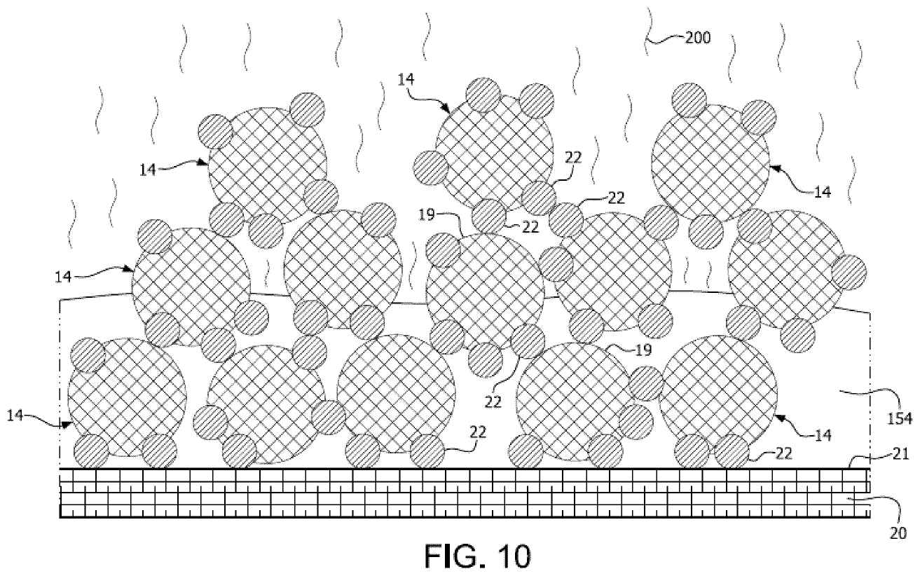

The solvent 154 is removed by suitable methods such as heating, as shown in FIG. 10. Solvent 154 is removed as vapor 200. This produces the electrode 10 shown in FIG. 1. The heat source can be any suitable heat source.

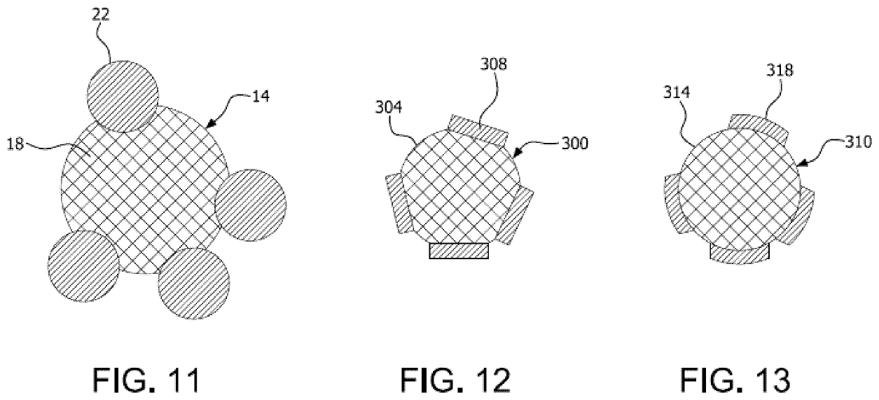

The metal particles can vary in shape. In FIG. 11 there is shown a heterocluster 14 with an electrode active material particle 18 and substantially spherical metal particles 22 confined to the outer surface of the electrode active material particle 18. In FIG. 12 there is shown a heterocluster 300 having an electrode active material particle 304 in which the metal particles are in the shape of small platelets 308. In FIG. 13 there is shown a heterocluster 310 in which an electrode active material particle 314 has metal particles in the form of discreet conformal layers of the metal that do not cover the entire outer surface of the electrode active material particle 314 and are non-homogeneously distributed about that outer surface.

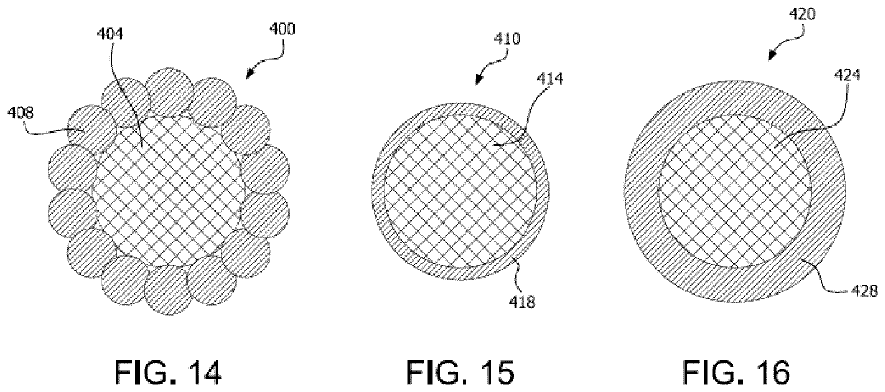

The significance of the non-homogeneous coverage of the metal particles on the electrode active material particle is shown by non-preferable homogeneous cluster particles in FIGS. 14-16. The homogenous cluster particle 400 shown in FIG. 14 includes an electrode active material particle 404 with a homogeneous layer of metal particles 408 covering the outer surface. Lithium transport to the surface of the electrode active material particle 404 will be substantially blocked. There is shown in FIG. 15 a homogeneous cluster particle 410 in which an electrode active material particle 414 is completely covered by a thin metal layer 418. Lithium transport to the surface of the electrode active material particle 414 will again be substantially blocked. There is shown in FIG. 16 a homogeneous cluster particle 420 in which an electrode active material particle 424 is completely covered by a thick metal layer 428. Lithium transport to the surface of the electrode active material particle 424 will be totally blocked.

The heteroclusters of the invention have metal particles that do not completely cover the outer surface of the electrode active material particle and form discreet islands of metal that are non-homogeneously distributed about that outer surface.

The invention addresses the above challenges of carbon promoted electrolyte consumption, poor interconnectedness and transport of lithium ions and electrons during charging and discharging, and the instability of electrode passivation through the addition of a sub-micron sized heteroclusters of metals.

The metal particles are confined to the surface of the electrode active material particles and act as microballast on the silicon during electrode processing. This microballast causes the particles to orient during solution processing such that the metal particle dense portions of the heteroclusters are oriented down due to their heavier nature compared to the lighter electrode active material such as silicon. This orientation down promotes electrical conduction pathways through the sub-micron sized heteroclusters of metals between neighboring particles.

For example, instead of a Si—Si—Si—Si—C orientation of particles where electrons need to diffuse across multiple Si—Si interfaces the resulting materials form a more perfect orientation of Metal-Si-Metal-Si-Metal-Si-Metal-Si (etc.) where electrons have fast pathways of migration between Si particles. This promotes electrode utilization. This increase in utilization minimizes the incommensurate charging of silicon whereby Si clusters close to the outer surface of the electrode are preferentially lithiated over silicon deep within the core of the electrode. This surface lithiation causes larger strain on the solid electrolyte interphase chemistry due to the larger volume expansion confined to a small fraction of the electroactive material instead of homogeneous, and on average, lower net volumetric expansion.

Second, the electrode active heteroclusters of metals act as phase transfer catalysts to promote the desolvation and transport of Li atoms from the electrolyte to the electrode during battery charging. This promoting of the desolvation makes it easier to move Li ions into the silicon anode and operate the cells at faster charge and discharge rates. This is important for fast charging batteries.

Finally, the metal heteroclusters create pore spaces between the active electrode material (e.g. Si) which help accommodate volume expansion during lithium insertion. This porosity allows the silicon to expand into open space and reduces stress on the electrode during cycling by reducing the total volume expansion.

For the technologies provided herein, it is important that the metal particles be smaller than the size of the electrode active material particle. If the metal particles are too big there will be poor electrode utilization as the fraction of silicon will be reduced significantly lowering total energy density. Preferably the electrodes are about 10 volume percent of the total electroactive material.

The below examples demonstrate the benefit of the electrode active heteroclusters on the performance of a silicon anode. The examples include examples where the heteroclusters were detrimental due to side reactions and examples where the heteroclusters provide benefits.

Half Cell Performance of Si^{M} Electrodes with 10 Vol % of M

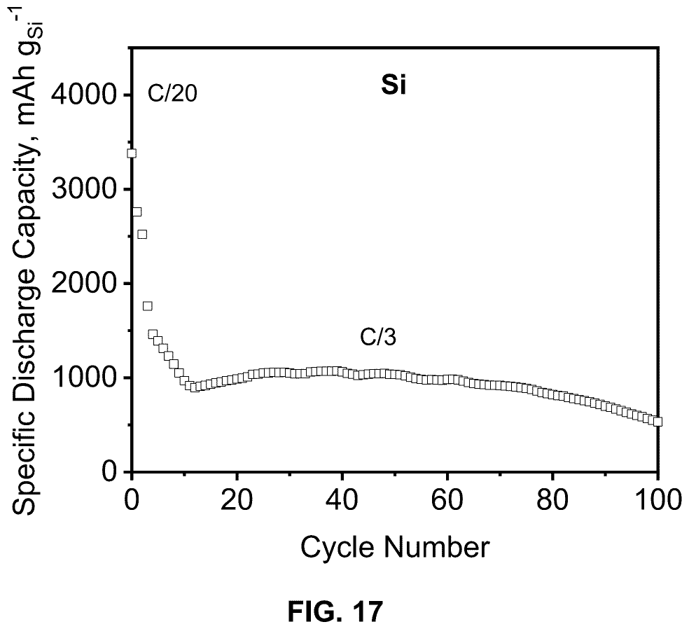

FIG. 17 is a plot of specific discharge capacity (mAh g_{Si}⁻¹) as a function of cycle number obtained for the baseline material (Si). The cells were cycled in half-cell configuration using coin cells and using Li metal as a counter electrode and 1.2 M LiPF₆ in 3/7 w/w ethylene carbonate/ethyl methyl carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

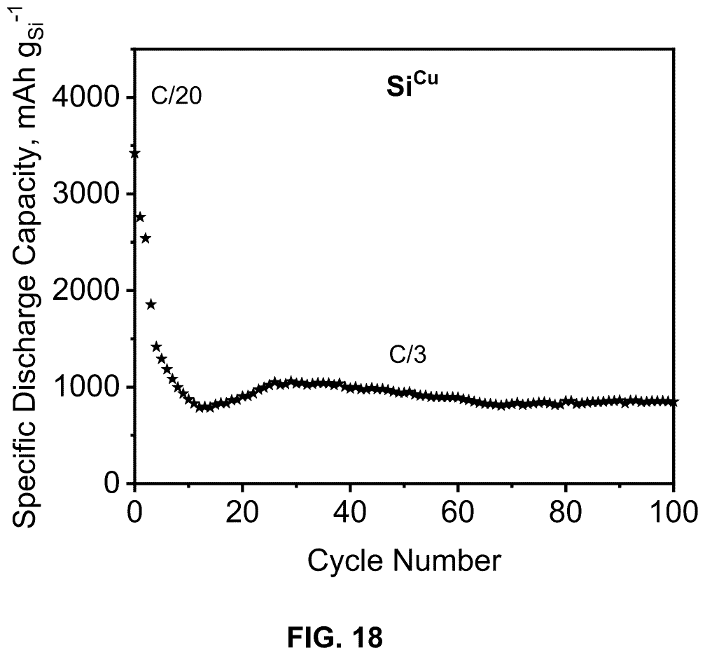

FIG. 18 is a plot of specific discharge capacity (mAh g_{Si}⁻¹) as a function of cycle number obtained for Si^{Cu} (10 vol % Cu) with a mass ratio of 20:35 for Cu:Si. The cells were cycled in half-cell configuration using coin cells and using Li metal as a counter electrode and 1.2 M LiPF₆ in 3/7 w/w ethylene carbonate/ethyl methyl carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

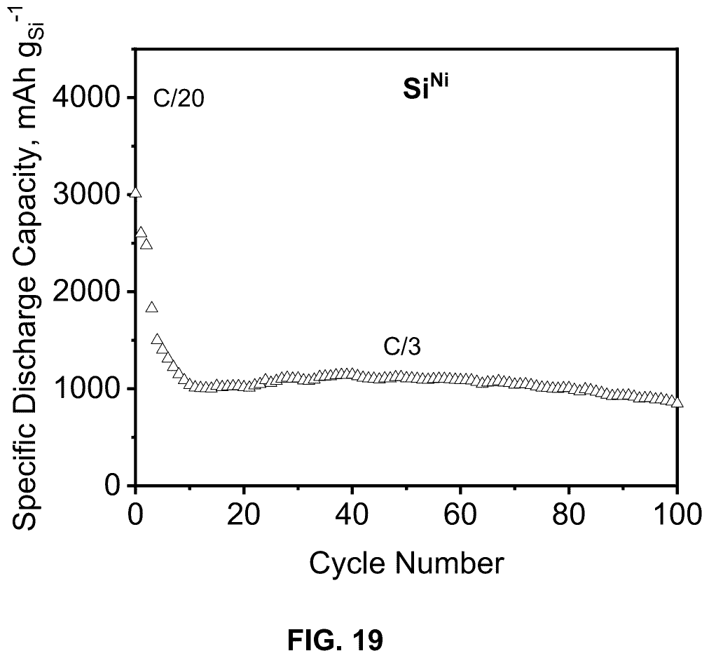

FIG. 19 is a plot of specific discharge capacity (mAh g_{Si}⁻¹) as a function of cycle number obtained for Si^{Ni} (10 vol % Ni) with a mass ratio of 20:35 for Ni:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

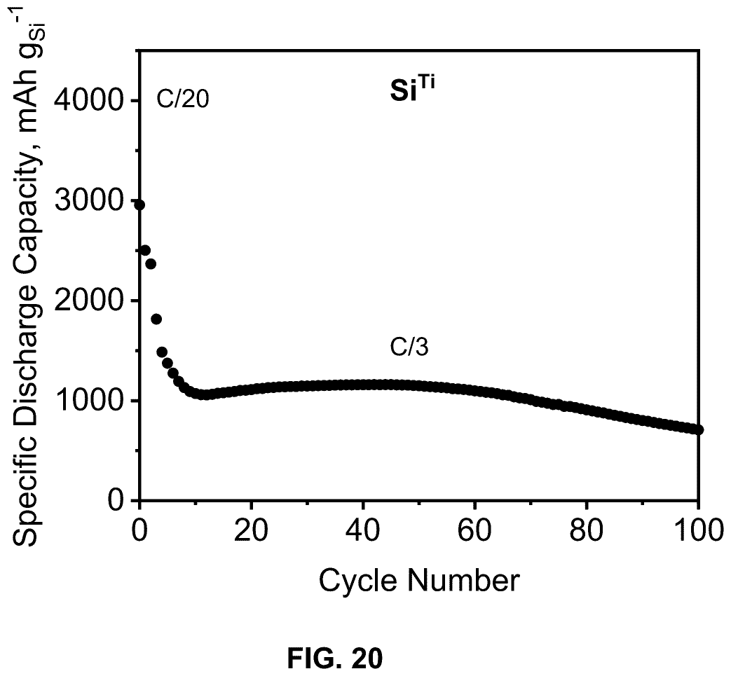

FIG. 20 is a plot of specific discharge capacity (mAh g_{Si}⁻¹) as a function of cycle number obtained for Si^{Ti} (10 vol % Ti) with a mass ratio of 10:35 for Ti:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

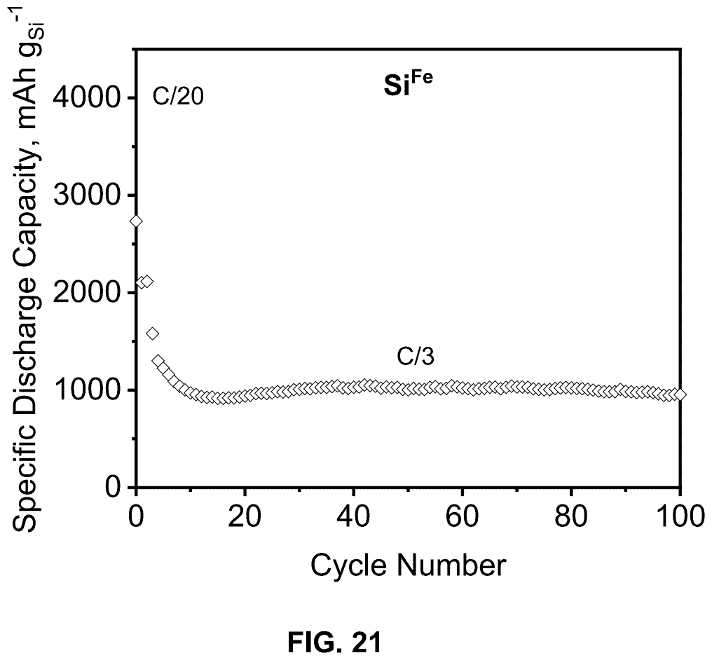

FIG. 21 is a plot of specific discharge capacity (mAh g_{Si}⁻¹) as a function of cycle number obtained for Si^{Fe} (10 vol % Fe) with a mass ratio of 17:35 for Fe:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

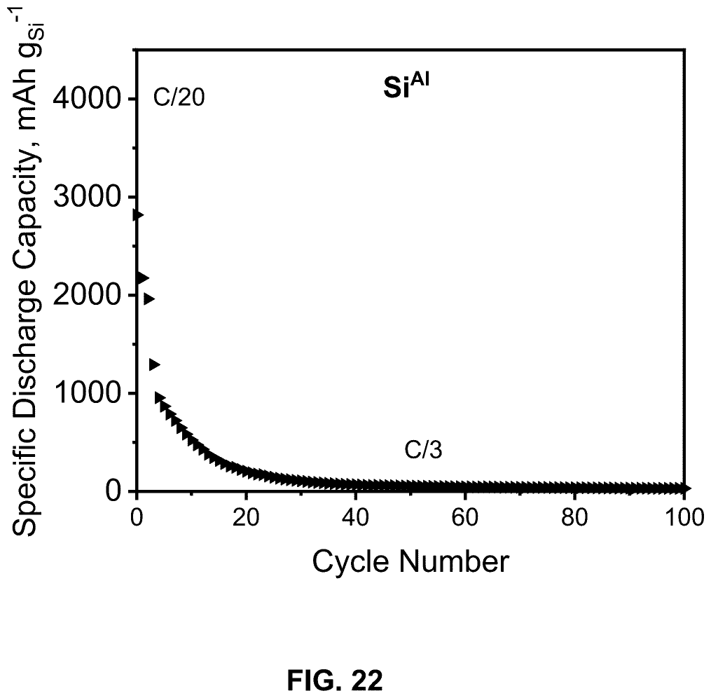

FIG. 22 is a plot of specific discharge capacity (mAh g_{Si}⁻¹) as a function of cycle number obtained for Si^{Al} (10 vol % Al) with a mass ratio of 6:35 for Al:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

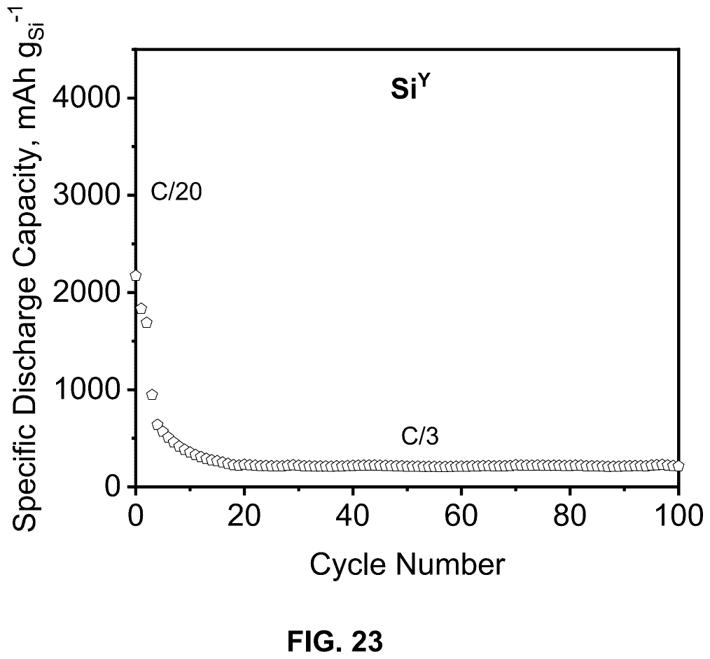

FIG. 23 is a plot of specific discharge capacity (mAh g_{Si}⁻¹) as a function of cycle number obtained for Si^{Y} (10 vol % Y) with a mass ratio of 10:35 for Y:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

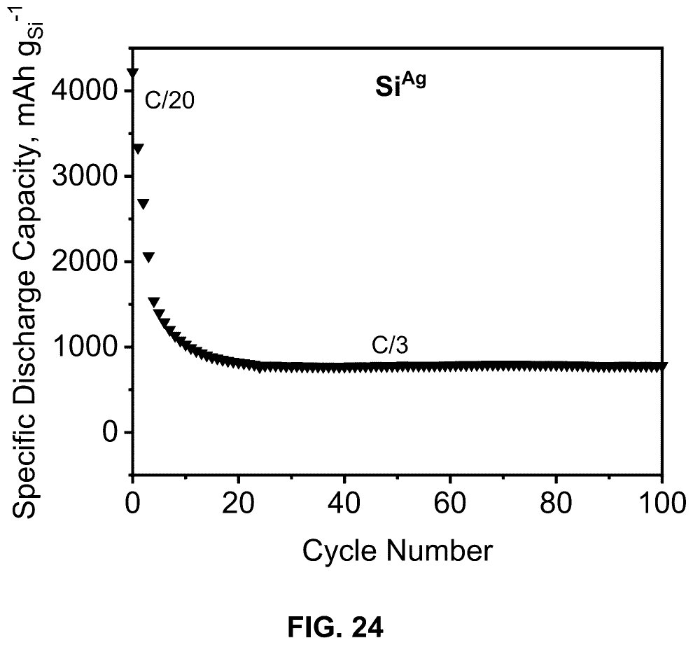

FIG. 24 is a plot of specific discharge capacity (mAh g_{Si}⁻¹) as a function of cycle number obtained for Si^{Ag} (10 vol % Ag) with a mass ratio of 20:35 for Ag:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

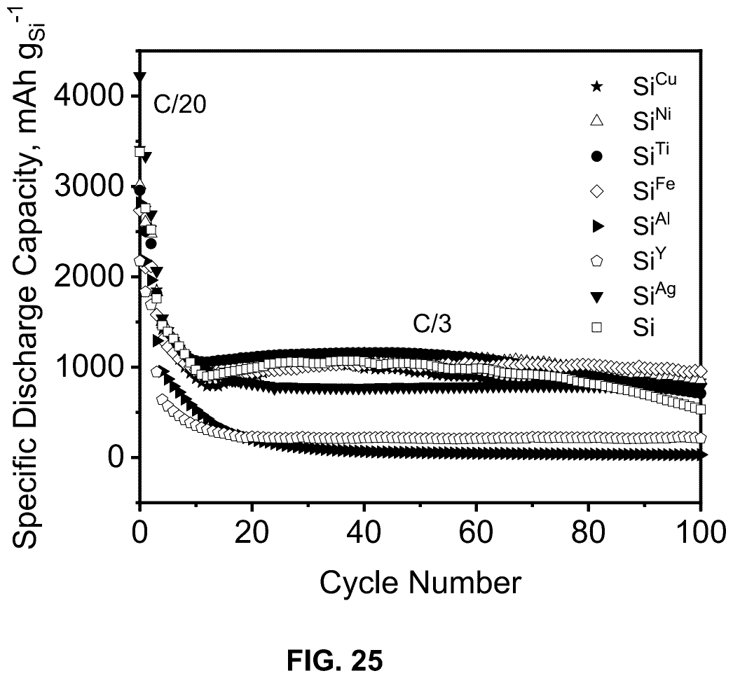

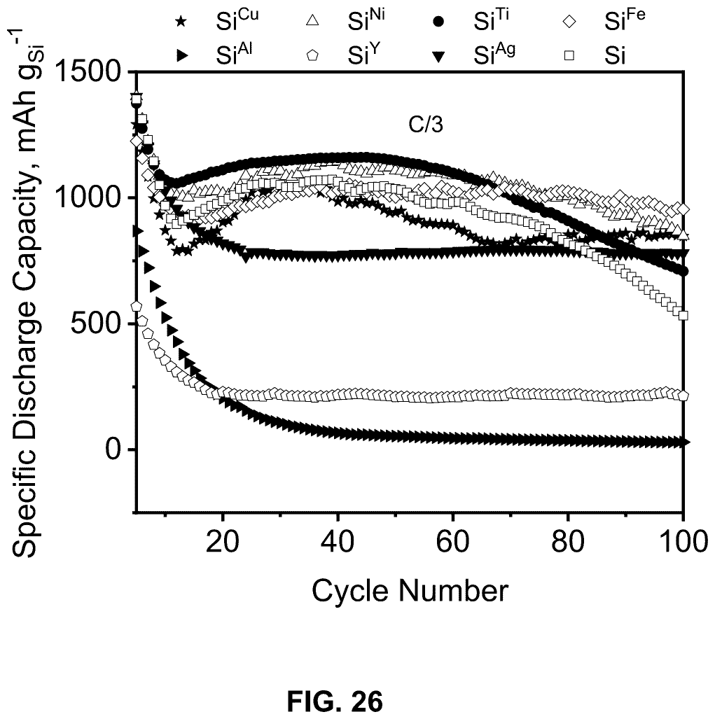

FIGS. 25 and 26 are plots of specific discharge capacity (mAh g_{Si}⁻¹) (FIG. 26 is a magnified image of FIG. 25) as a function of cycle number obtained for baseline Si and Si^{M} (10 vol % M) with a mass ratio of 20:35 for Cu:Si, 20:35 for Ni:Si, 10:35 for Ti:Si, 17:35 for Fe:Si, 6:35 for Al:Si, 10:35 for Y:Si, and 20:35 for Ag:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

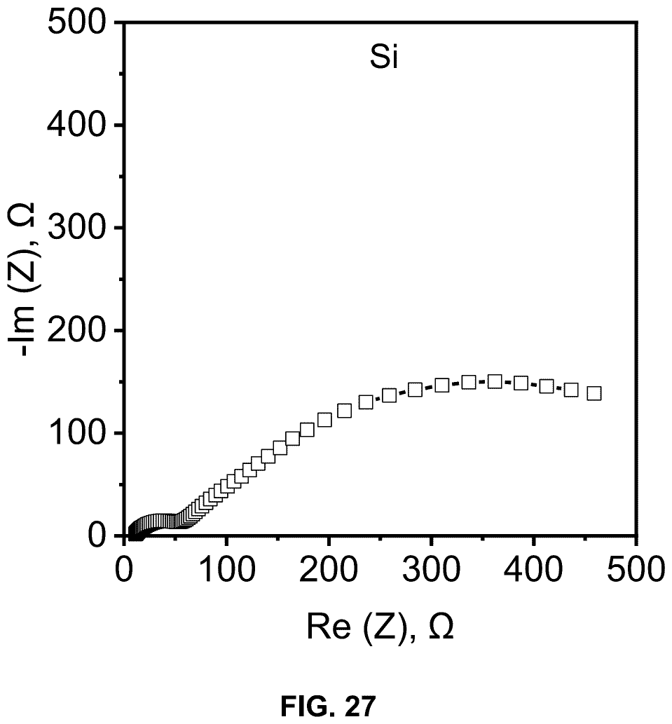

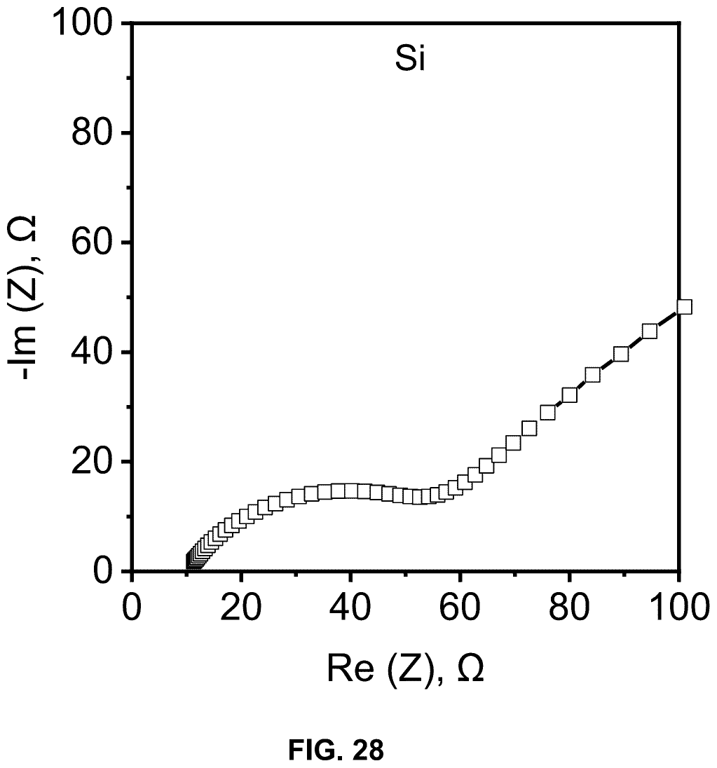

FIGS. 27 and 28 are Nyquist plots (FIG. 28 is a magnified image of FIG. 27) after the 20^{th} delithiation in half-cell obtained for baseline Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

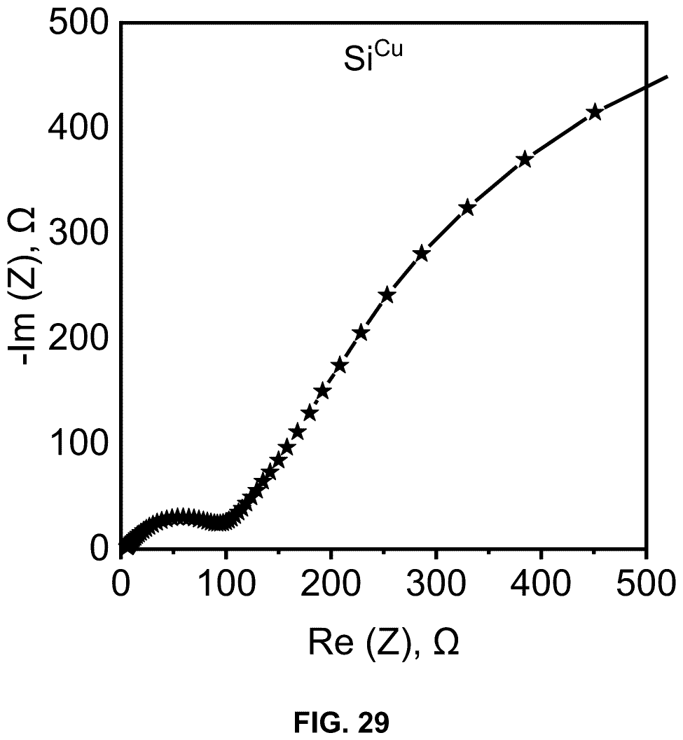

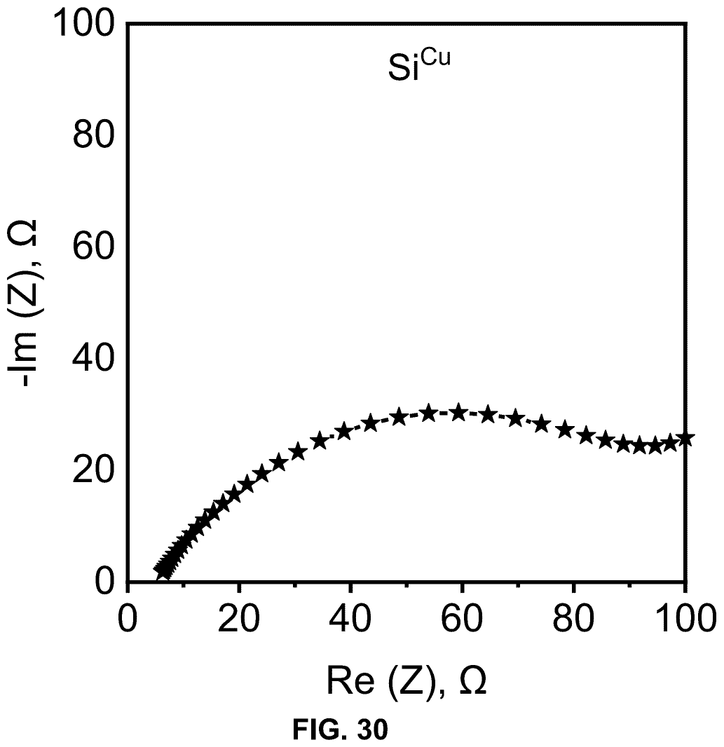

FIGS. 29 and 30 are Nyquist plots (FIG. 30 is a magnified image of FIG. 29) after the 20^{th} delithiation in half-cell obtained for Si^{Cu} (10 vol % Cu) with a mass ratio of 20:35 for Cu:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

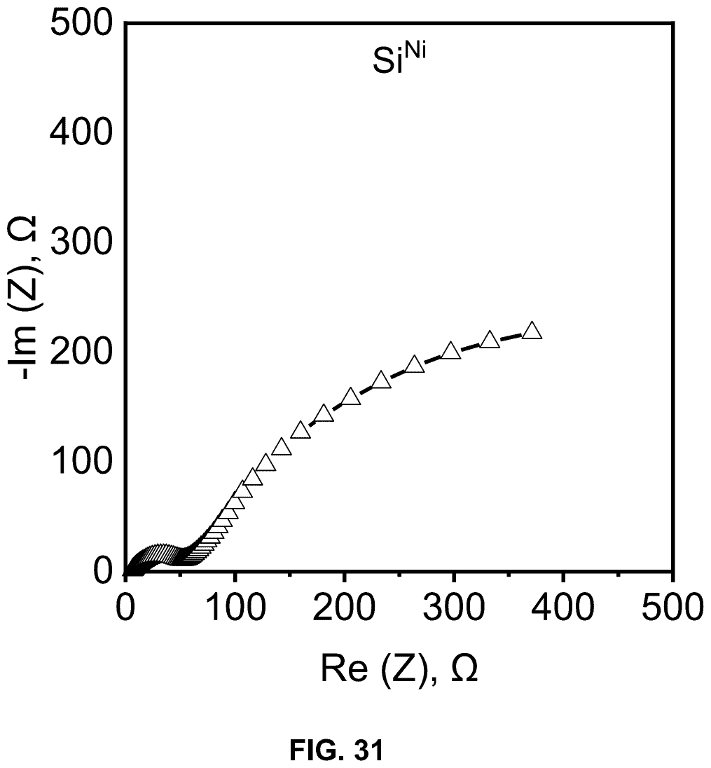

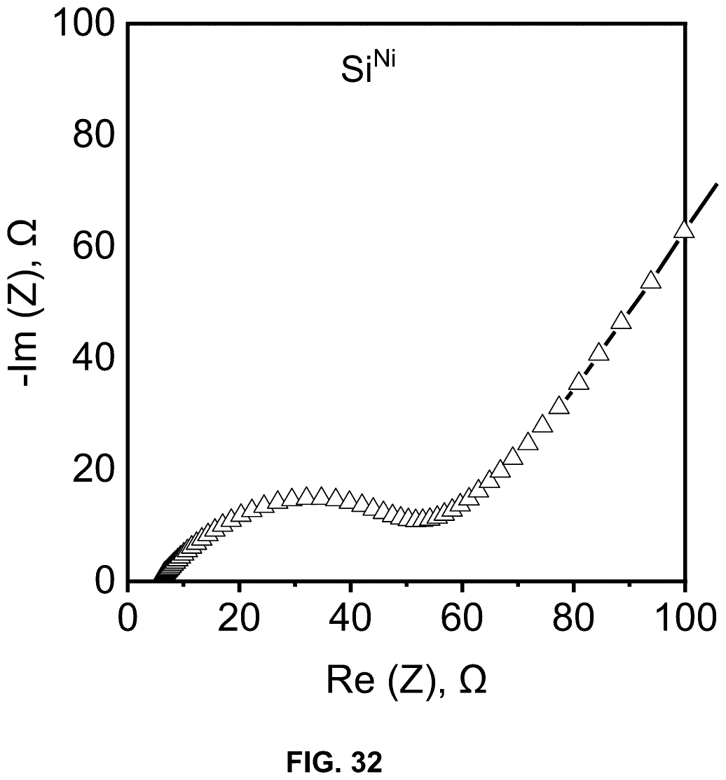

FIGS. 31 and 32 are Nyquist plots (FIG. 32 is a magnified image of FIG. 31) after the 20^{th} delithiation in half-cell obtained for Si^{Ni} (10 vol % Ni) with a mass ratio of 20:35 for Ni:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

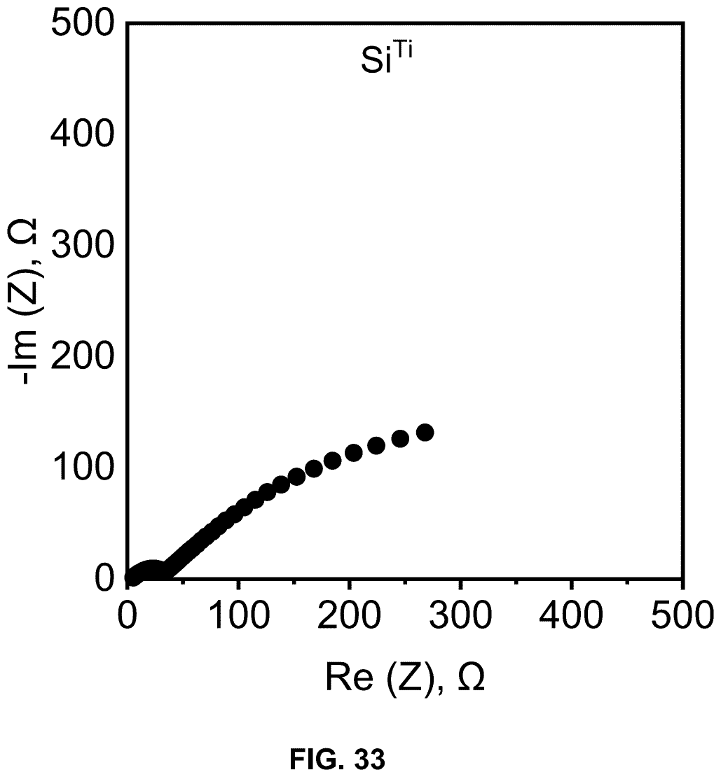

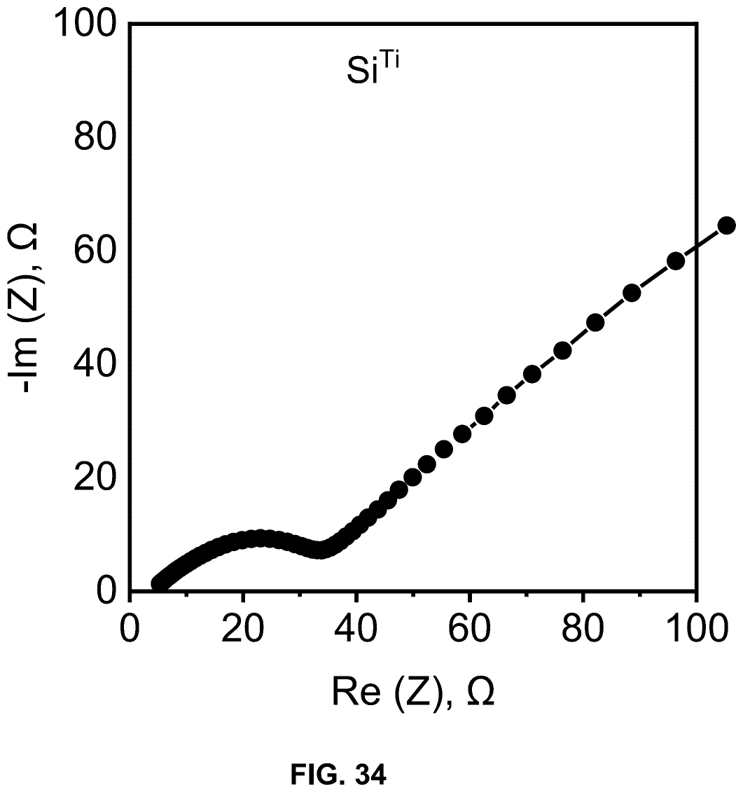

FIGS. 33 and 34 are Nyquist plots (FIG. 34 is a magnified image of FIG. 33) after the 20^{th} delithiation in half-cell obtained for Si^{Ti} (10 vol % Ti) with a mass ratio of 10:35 for Ti:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

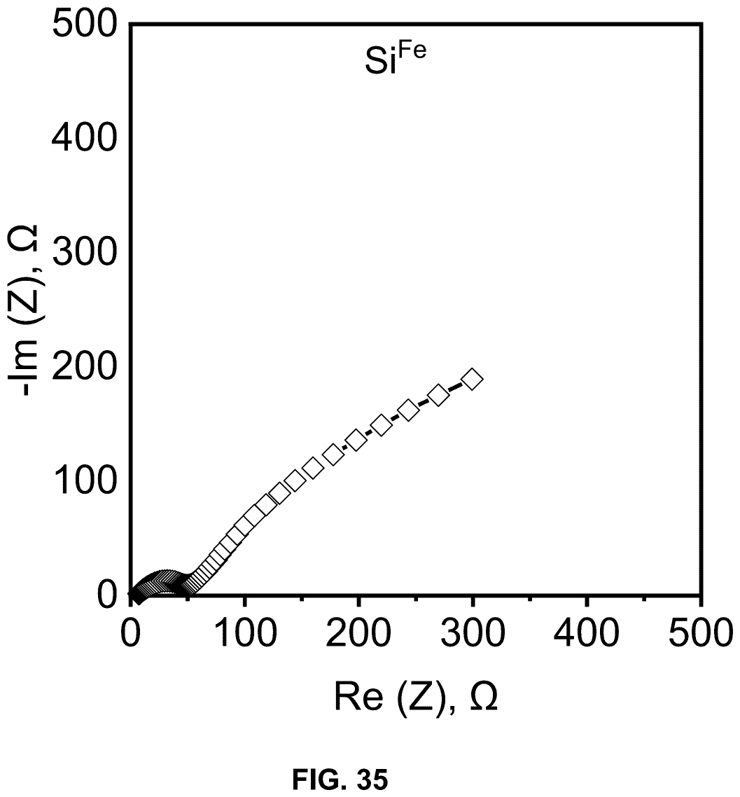

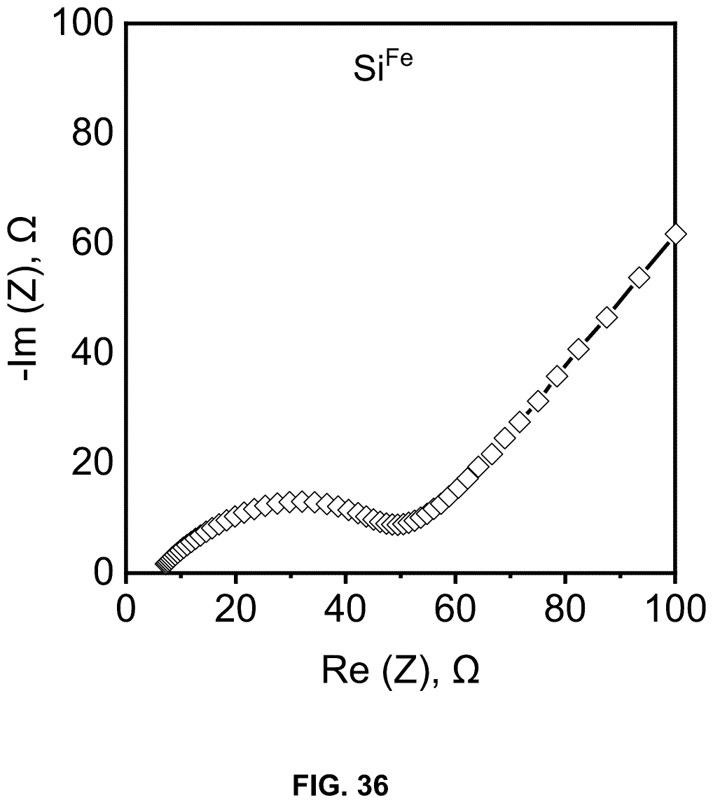

FIGS. 35 and 36 are Nyquist plots (FIG. 36 is a magnified image of FIG. 35) after the 20^{th} delithiation in half-cell obtained for Si^{Fe} (10 vol % Fe) with a mass ratio of 17:35 for Fe:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

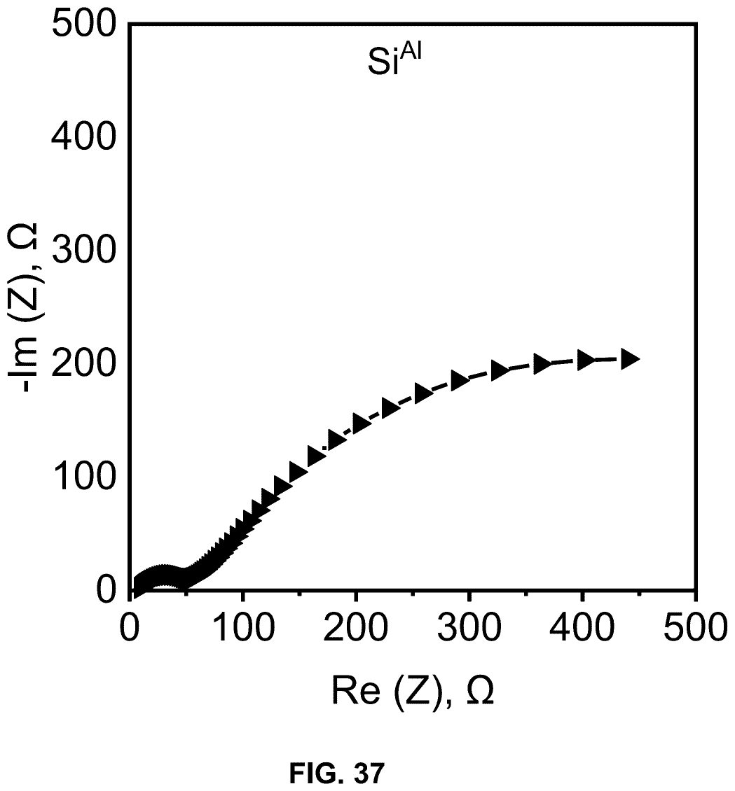

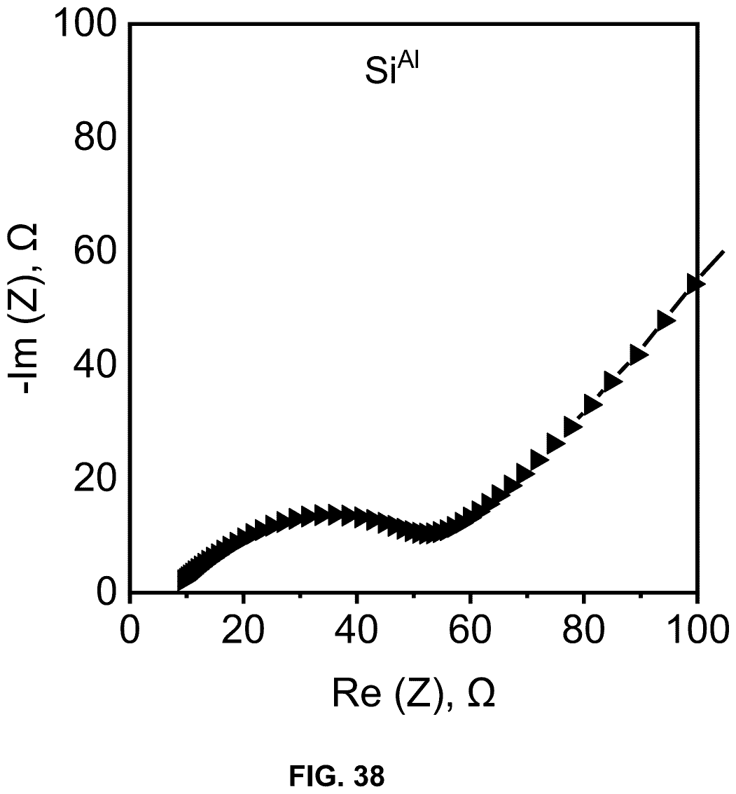

FIGS. 37 and 38 are Nyquist plots (FIG. 38 is a magnified image of FIG. 37) after the 20^{th} delithiation in half-cell obtained for Si^{Al} (10 vol % Al) with a mass ratio of 6:35 for Al:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

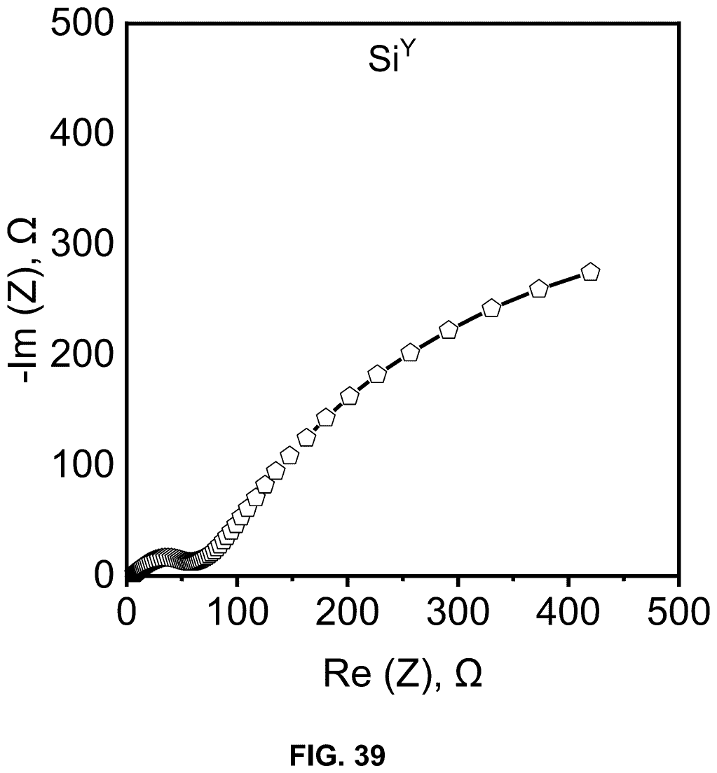

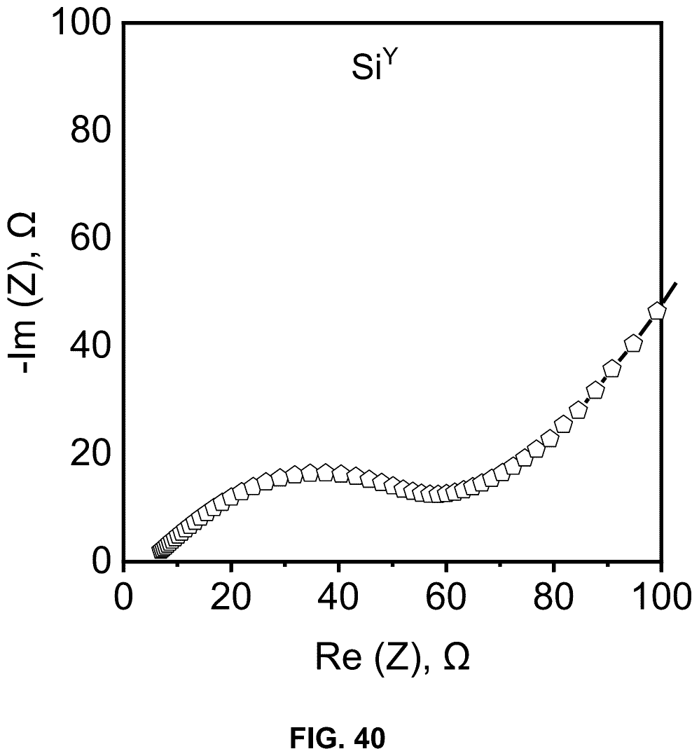

FIGS. 39 and 40 are Nyquist plots (FIG. 40 is a magnified image of FIG. 39) after the 20^{th} delithiation in half-cell obtained for Si^{Y} (10 vol % Y) with a mass ratio of 10:35 for Y:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

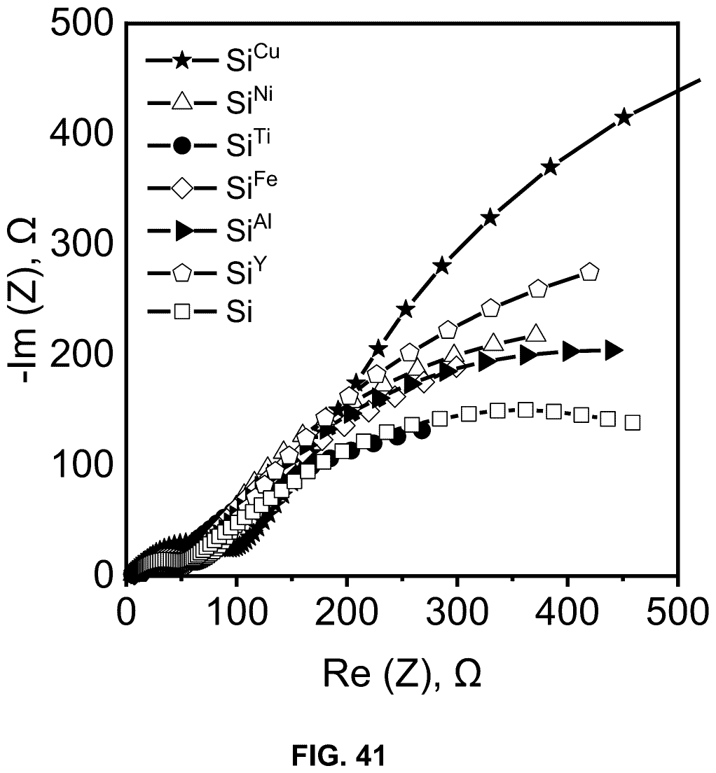

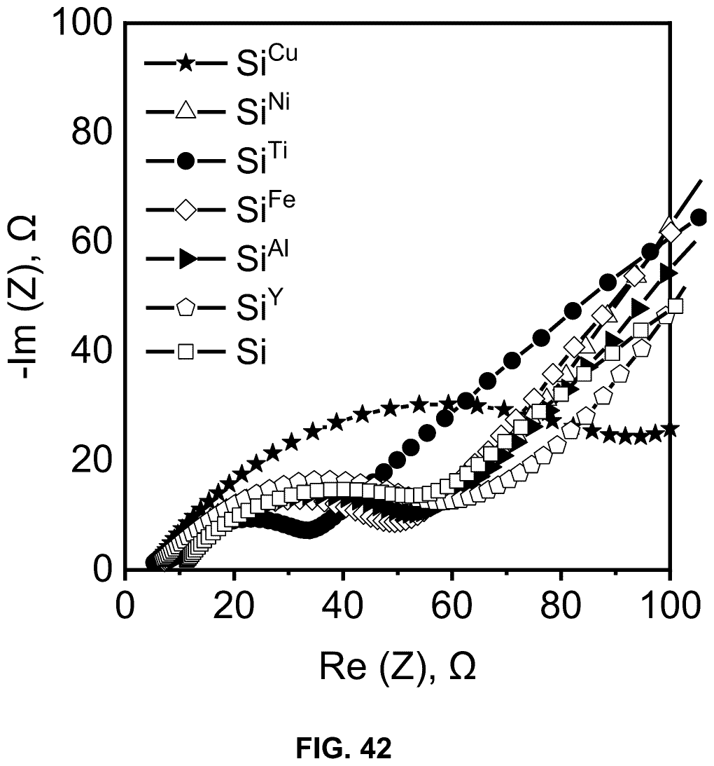

FIGS. 41 and 42 are a comparison of the Nyquist plots (FIG. 42 is a magnified image of FIG. 41) after the 20^{th} delithiation in half-cell obtained for baseline Si and Si^{M} (10 vol % M) with a mass ratio of 20:35 for Cu:Si, 20:35 for Ni:Si, 10:35 for Ti:Si, 17:35 for Fe:Si, 6:35 for Al:Si, 10:35 for Y:Si, and 20:35 for Ag:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

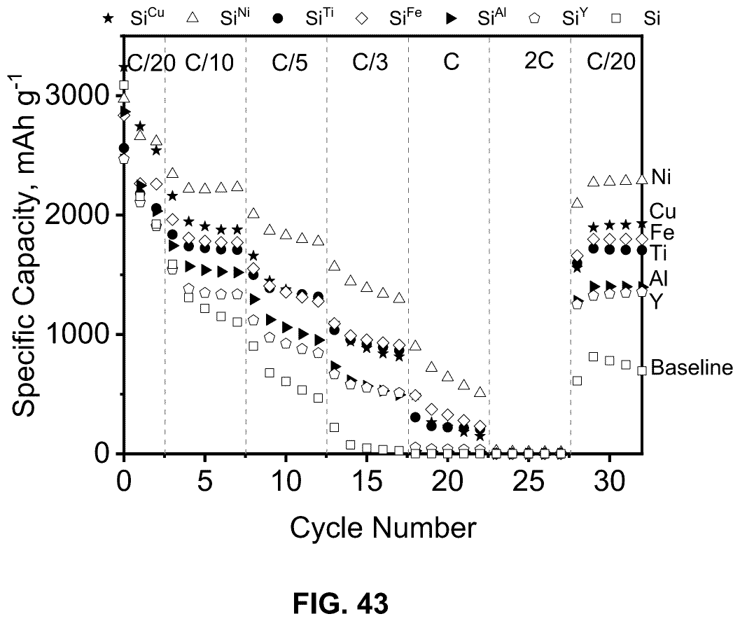

FIG. 43 is a plot of specific discharge capacities (mAh g_{Si}⁻¹) as a function of cycle number obtained for baseline Si and Si^{M} (10 vol % M) with a mass ratio of 20:35 for Cu:Si, 20:35 for Ni:Si, 10:35 for Ti:Si, 17:35 for Fe:Si, 6:35 for Al:Si, and 10:35 for Y:Si at varying C-rates including C/10, C/10, C/5, C/3, C, 2 C. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

Half Cell Performance of Si^{M} Electrodes with 5 vol % of M

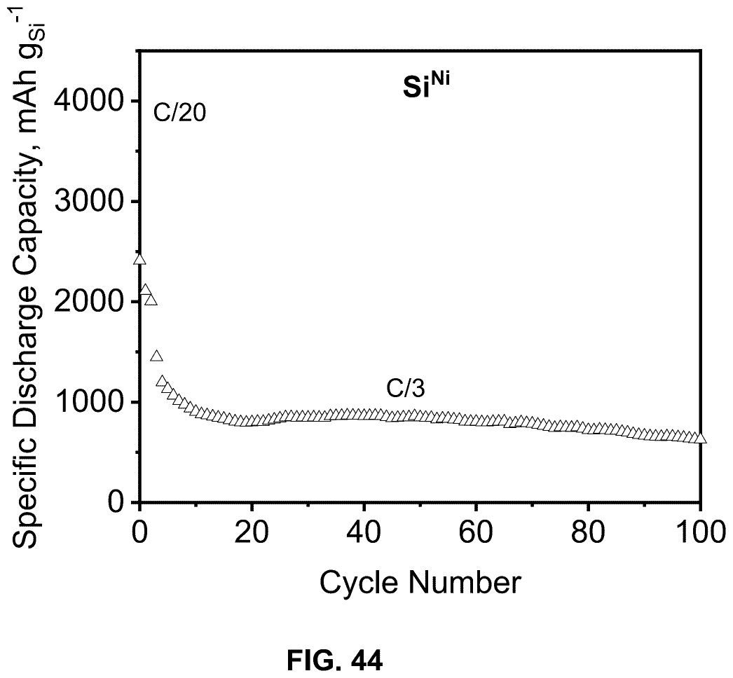

FIG. 44 is a plot of specific discharge capacity (mAh g_{Si}⁻¹) as a function of cycle number obtained for Si^{Ni} (5 vol % Ni) with a mass ratio of 10:35 for Ni:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

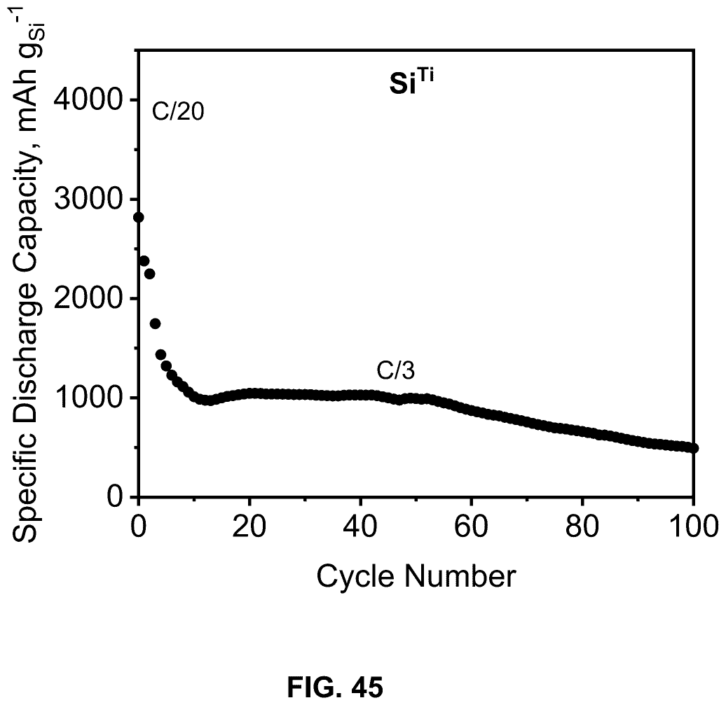

FIG. 45 is a plot of specific discharge capacity (mAh g_{Si}⁻¹) as a function of cycle number obtained for Si^{Ti} (5 vol % Ti) with a mass ratio of 5:35 for Ti:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

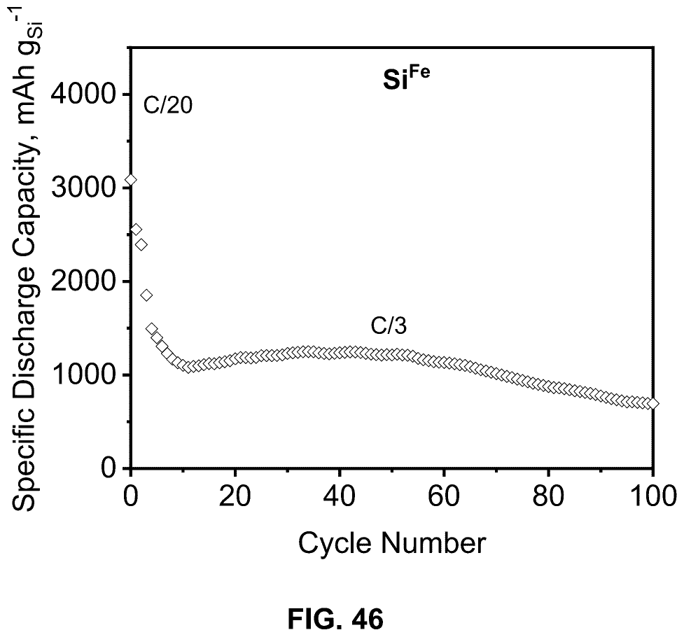

FIG. 46 is a plot of specific discharge capacity (mAh g_{Si}⁻¹) as a function of cycle number obtained for Si^{Fe} (5 vol % Fe) with a mass ratio of 8.5:35 for Fe:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

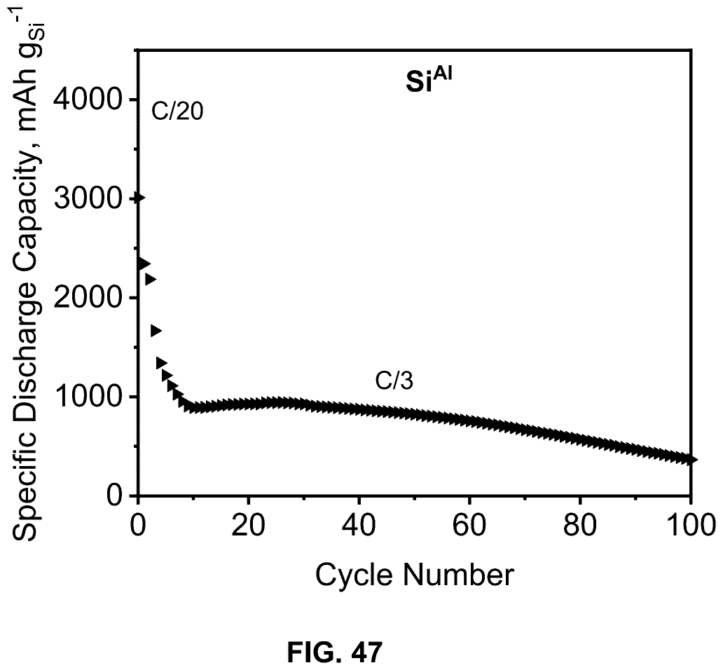

FIG. 47 is a plot of specific discharge capacity (mAh g_{Si}⁻¹) as a function of cycle number obtained for Si^{Al} (5 vol % Al) with a mass ratio of 3:35 for Al:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

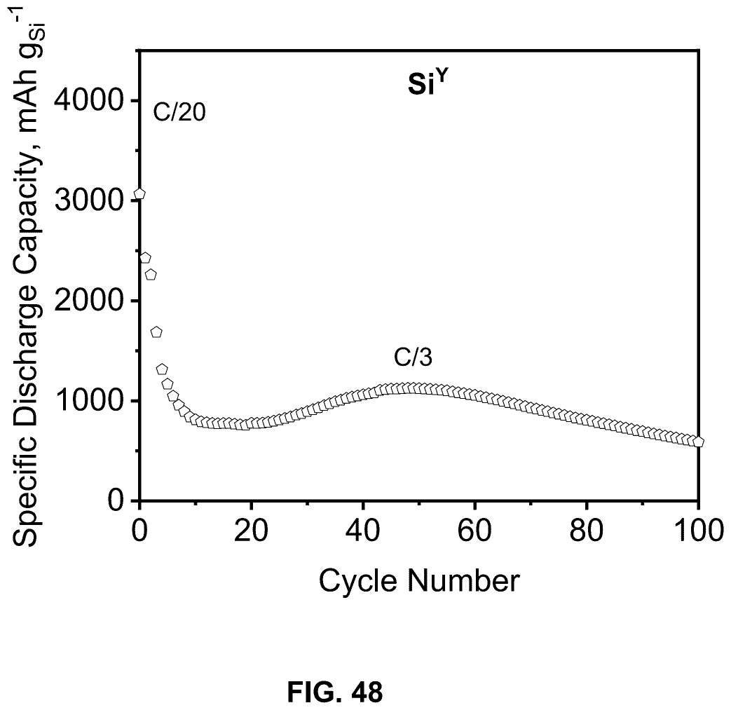

FIG. 48 is a plot of specific discharge capacity (mAh g_{Si}⁻¹) as a function of cycle number obtained for Si^{Y} (5 vol % Y) with a mass ratio of 5:35 for Y:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

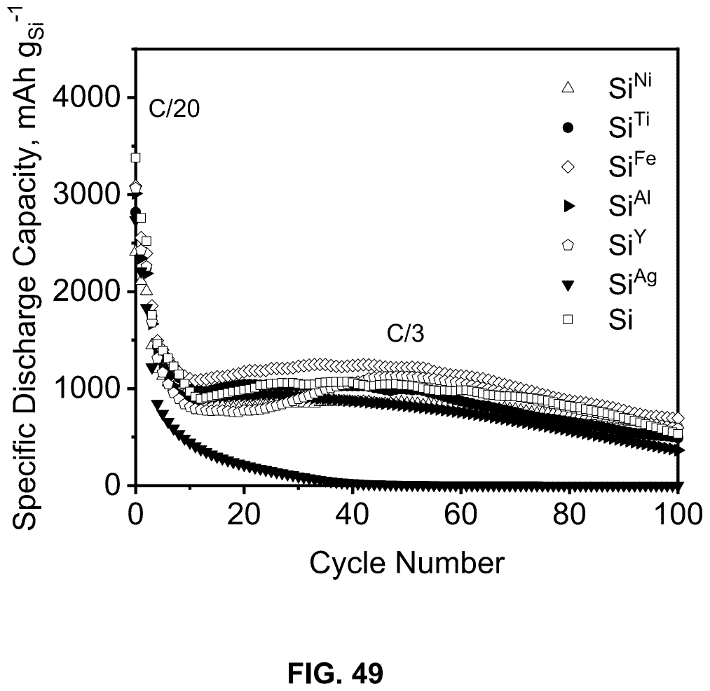

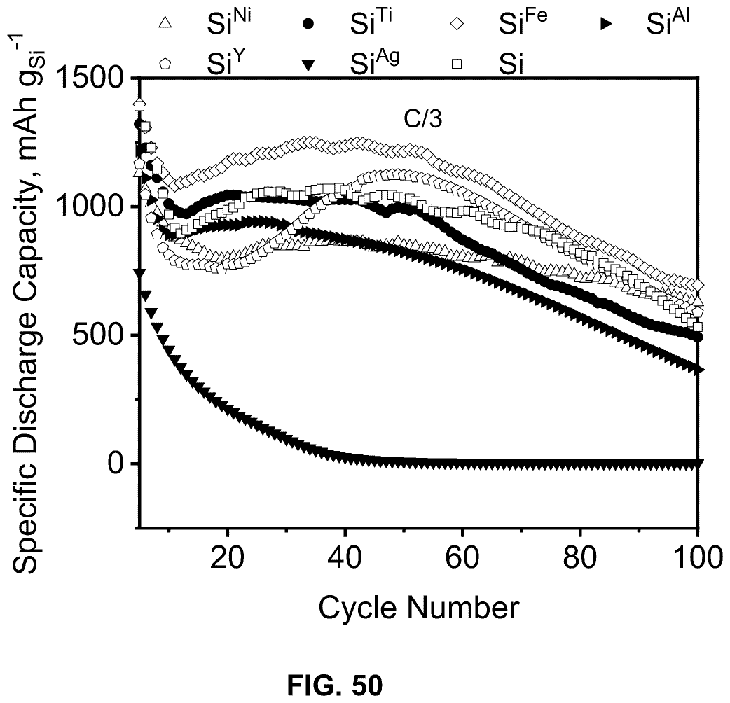

FIGS. 49 and 50 are a comparison of the specific discharge capacities (mAh g_{Si}⁻¹) (FIG. 50 is a magnified image of FIG. 49) as a function of cycle number obtained for baseline Si and Si^{M} (5 vol % M) with a mass ratio of 10:35 for Ni:Si, 5:35 for Ti:Si, 8.5:35 for Fe:Si, 3:35 for Al:Si, 5:35 for Y:Si, and 10:35 for Ag:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

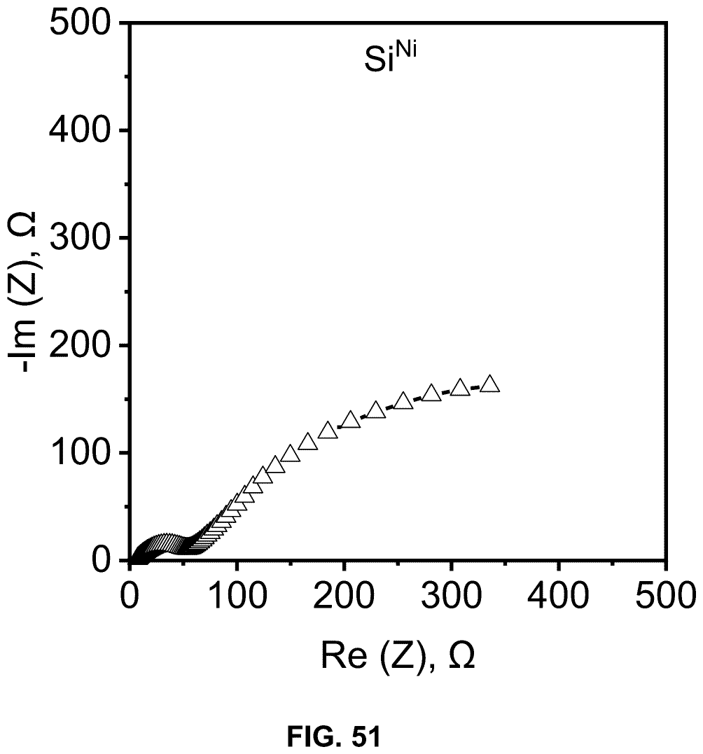

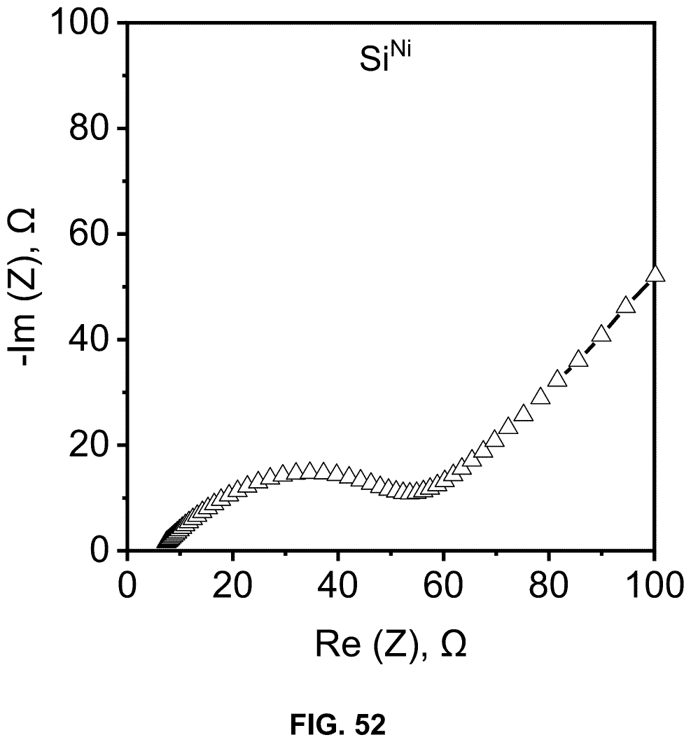

FIGS. 51 and 52 are Nyquist plots (FIG. 52 is a magnified image of FIG. 51) after the 20^{th} delithiation in half-cell obtained for Si^{Ni} (5 vol % Ni) with a mass ratio of 10:35 for Ni:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

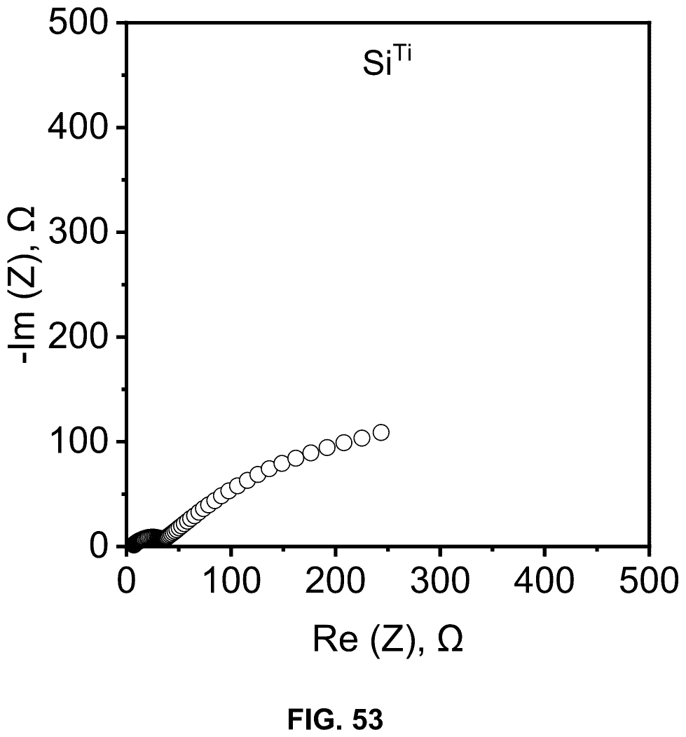

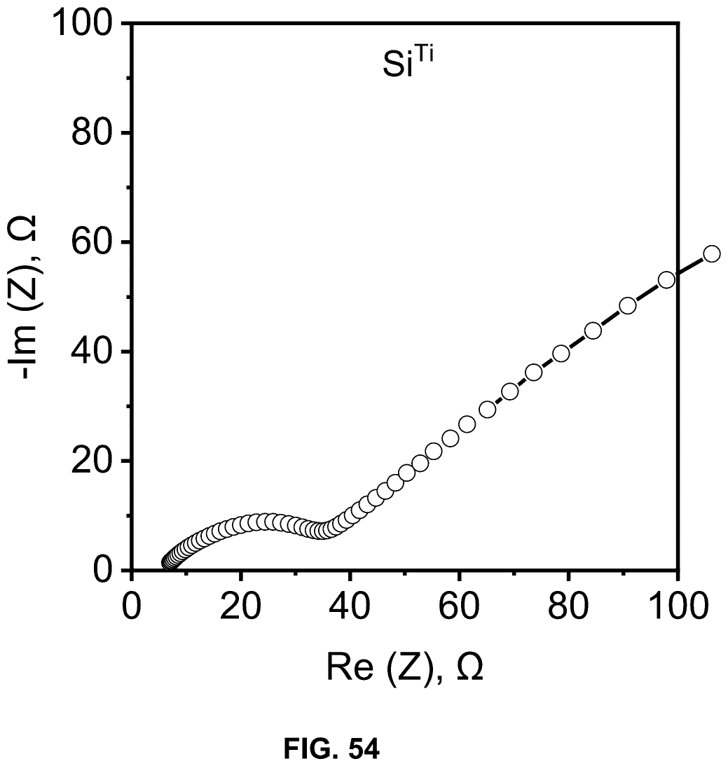

FIGS. 53 and 54 are Nyquist plots (FIG. 54 is a magnified image of FIG. 53) after the 20^{th} delithiation in half-cell obtained for Si^{Ti} (5 vol % Ti) with a mass ratio of 5:35 for Ti:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

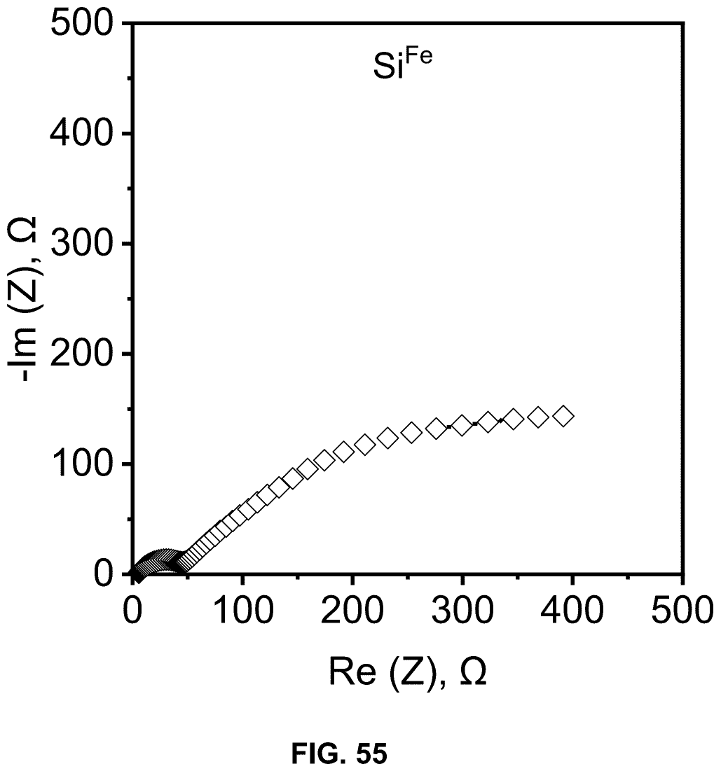

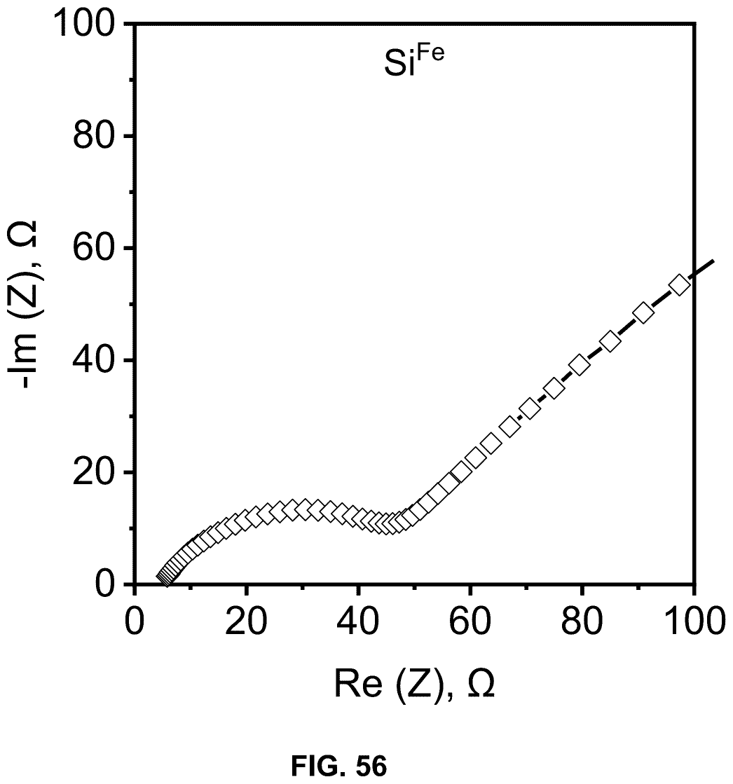

FIGS. 55 and 56 are Nyquist plots (FIG. 56 is a magnified image of FIG. 55) after the 20^{th} delithiation in half-cell obtained for Si^{Fe} (5 vol % Fe) with a mass ratio of 8.5:35 for Fe:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

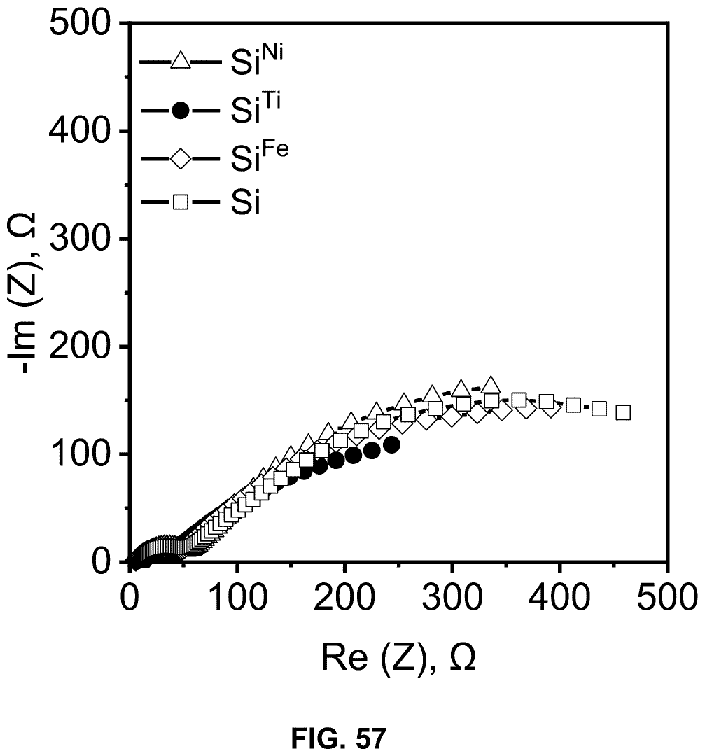

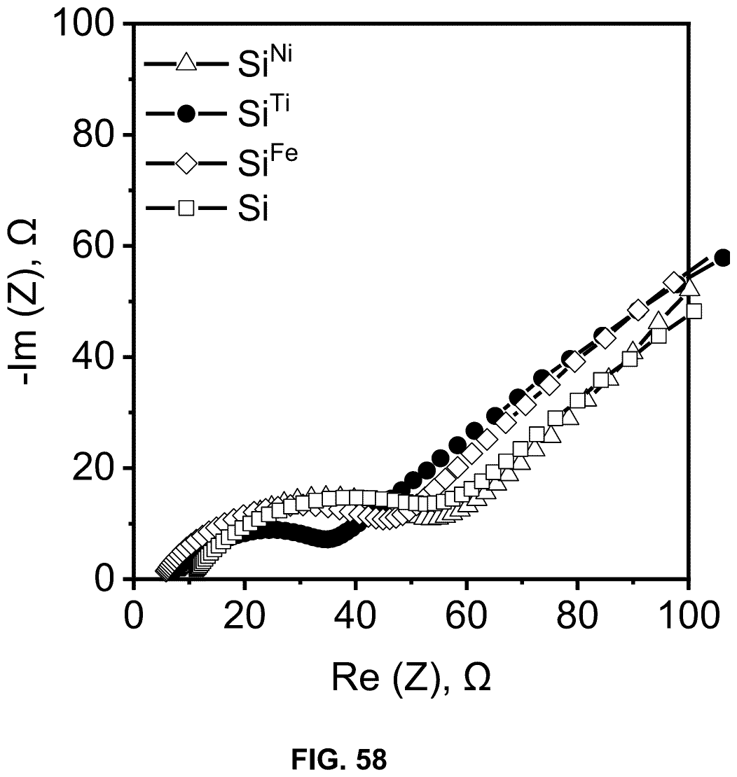

FIGS. 57 and 58 are a comparison of the Nyquist plots (FIG. 58 is a magnified image of FIG. 57) after the 20^{th} delithiation in half-cell obtained for baseline and Si^{M} (5 vol % M) with a mass ratio of 10:35 for Ni:Si, 5:35 for Ti:Si, 8.5:35 for Fe:Si. The cells were cycled in half-cell configuration using coin cells and using Li metal as a counter electrode and 1.2 M LiPF₆ in 3/7 w/w ethylene carbonate/ethyl methyl carbonate+3 wt % fluoroethylene carbonate as electrolyte. Cycling was performed in galvanostatic mode with a voltage window of 0.05 V and 1 V and a cycling rate of C/20 for the formation steps (performed 3 times) and C/3 for long-term cycling. Data were measured at room temperature.

Full Cell Performance of Si^{M} Electrodes with 10 vol % of M

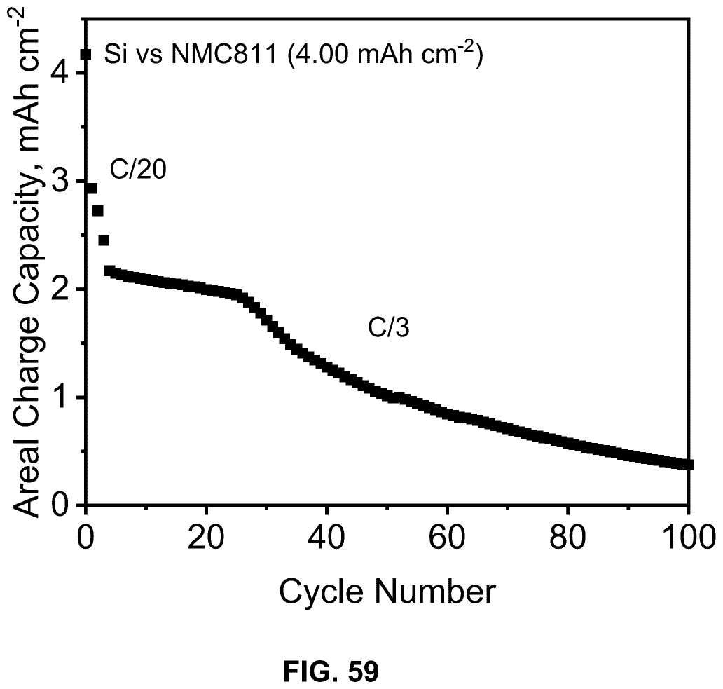

FIG. 59 is a plot of areal charge capacity (mAh cm⁻²) as a function of cycle number obtained for the baseline Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

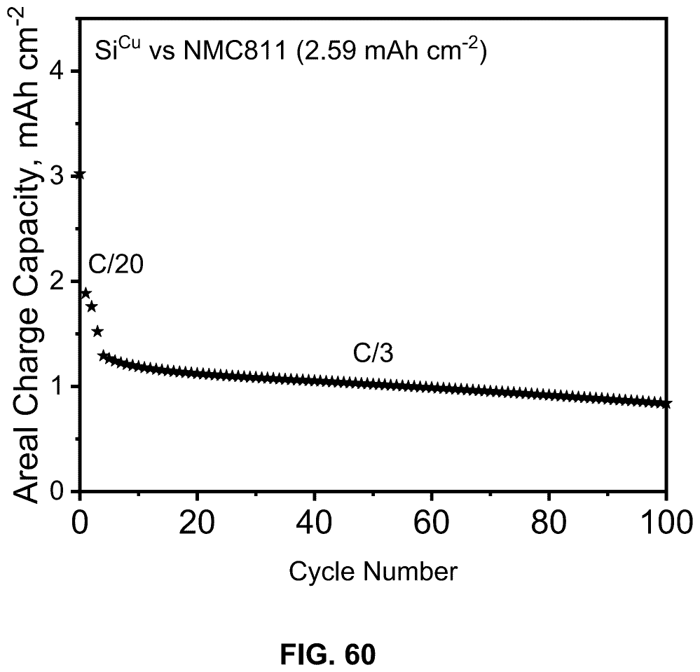

FIG. 60 is a plot of areal charge capacity (mAh cm⁻²) as a function of cycle number obtained for Si^{Cu} (10 vol % Cu) with a mass ratio of 20:35 for Cu:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

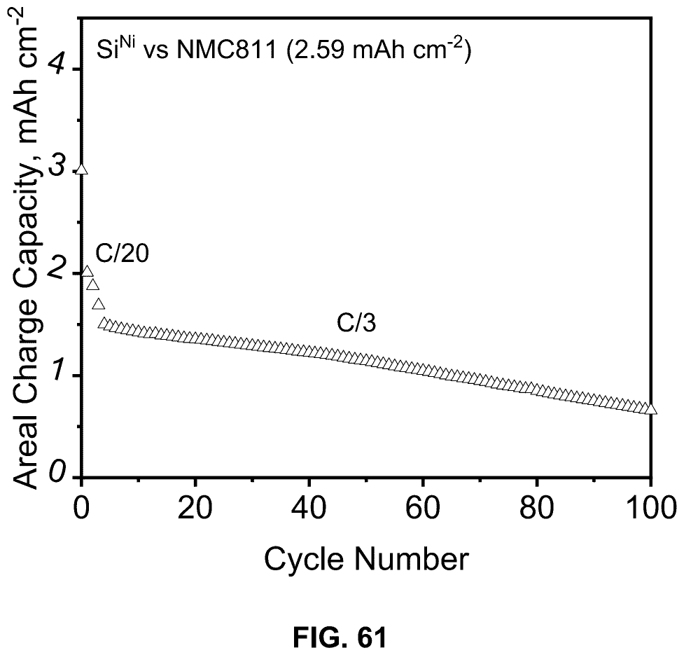

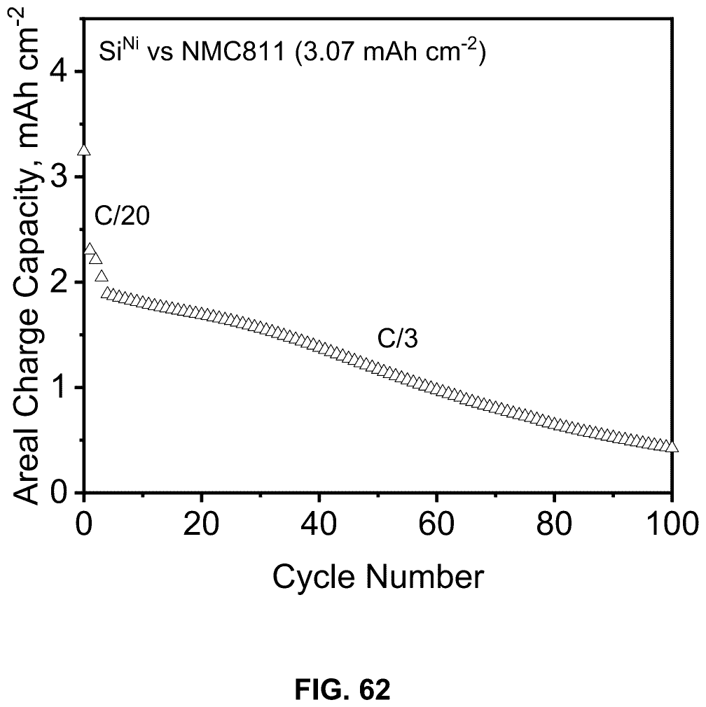

FIGS. 61 and 62 are plots of areal charge capacity (mAh cm⁻²) as a function of cycle number with two different areal loadings (2.59 and 3.07 mAh cm⁻², respectively) obtained for Si^{Ni} (10 vol % Ni) with a mass ratio of 20:35 for Ni:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

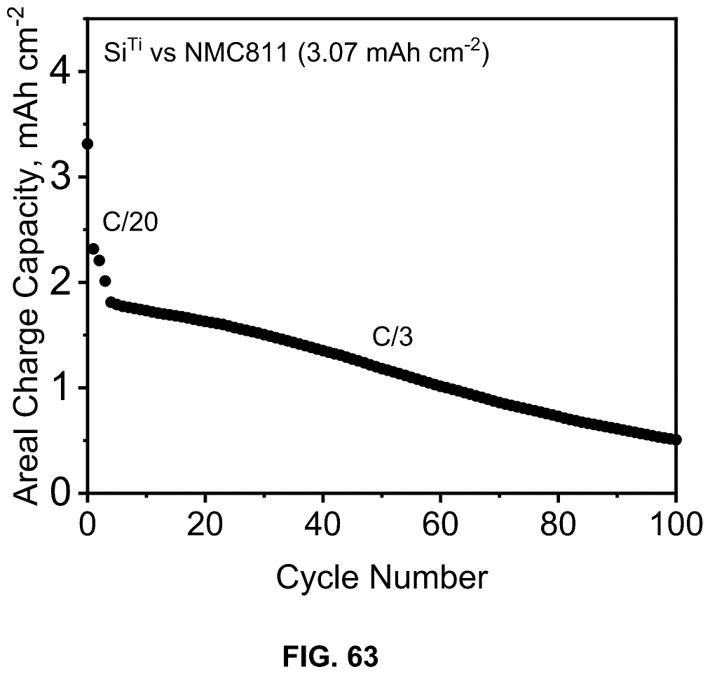

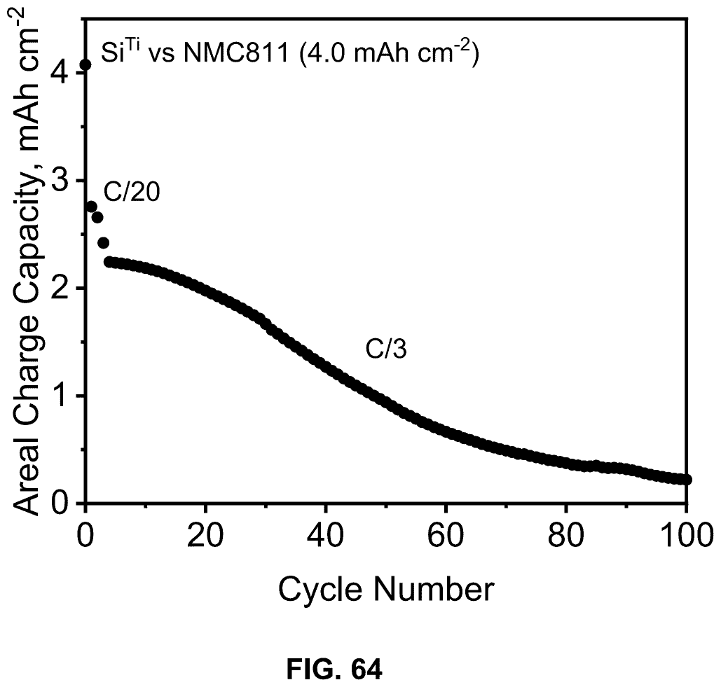

FIGS. 63 and 64 are plots of areal charge capacity (mAh cm⁻²) as a function of cycle number with two different loadings (3.07 and 4.0 mAh cm⁻², respectively) obtained for Si^{Ti} (10 vol % Ti) with a mass ratio of 10:35 for Ti:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

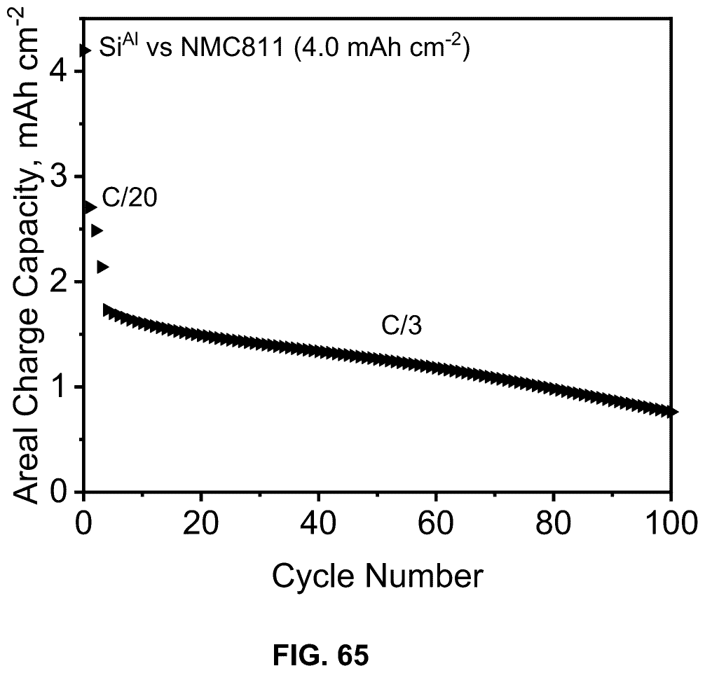

FIG. 65 is a plot of areal charge capacity (mAh cm⁻²) as a function of cycle number obtained for Si^{Al} (10 vol % Al) with a mass ratio of 6:35 for Al:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

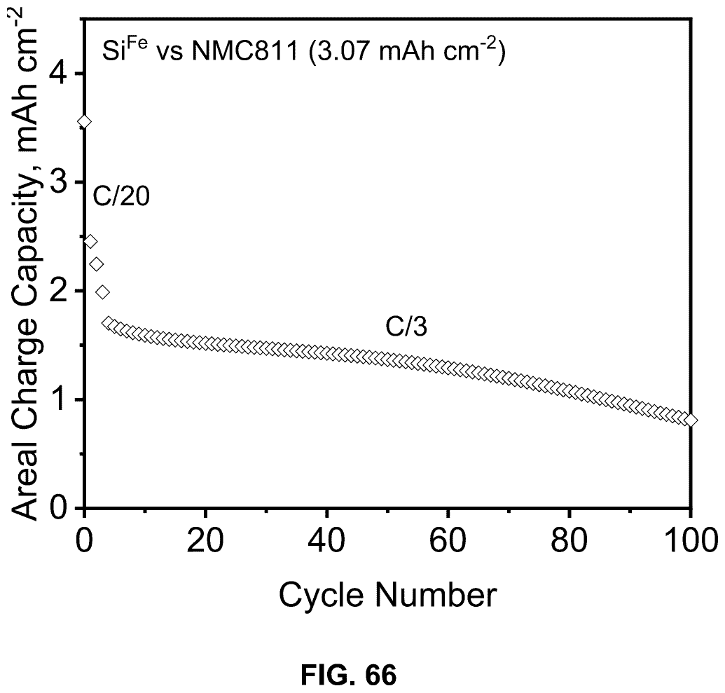

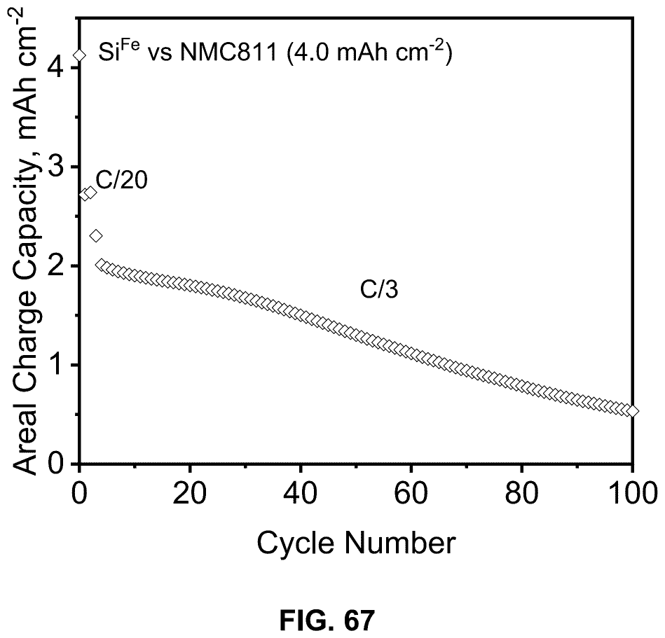

FIGS. 66 and 67 are plots of areal charge capacity (mAh cm⁻²) as a function of cycle number with different areal loadings (3.07 and 4.0 mAh cm 2, respectively) obtained for Si^{Fe} (10 vol % Fe) with a mass ratio of 17:35 for Fe:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

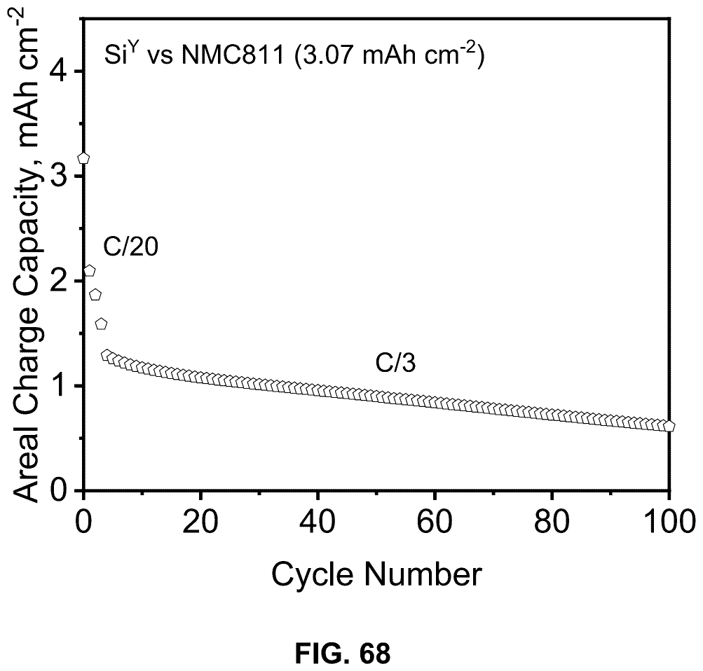

FIG. 68 is a plot of areal charge capacity (mAh cm⁻²) as a function of cycle number obtained for Si^{Y} (10 vol % Y) with a mass ratio of 10:35 for Y:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

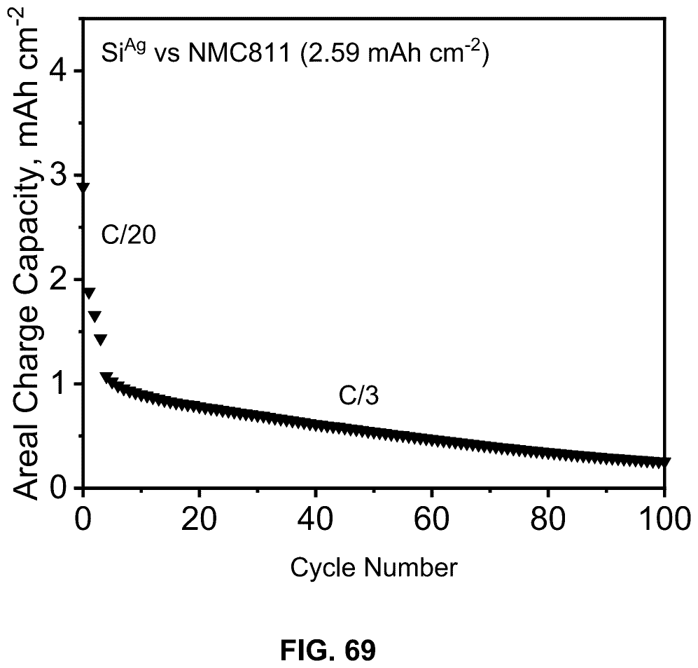

FIG. 69 is a plot of areal charge capacity (mAh cm⁻²) as a function of cycle number obtained for Si^{Ag} (10 vol % Ag) with a mass ratio of 20:35 for Ag:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

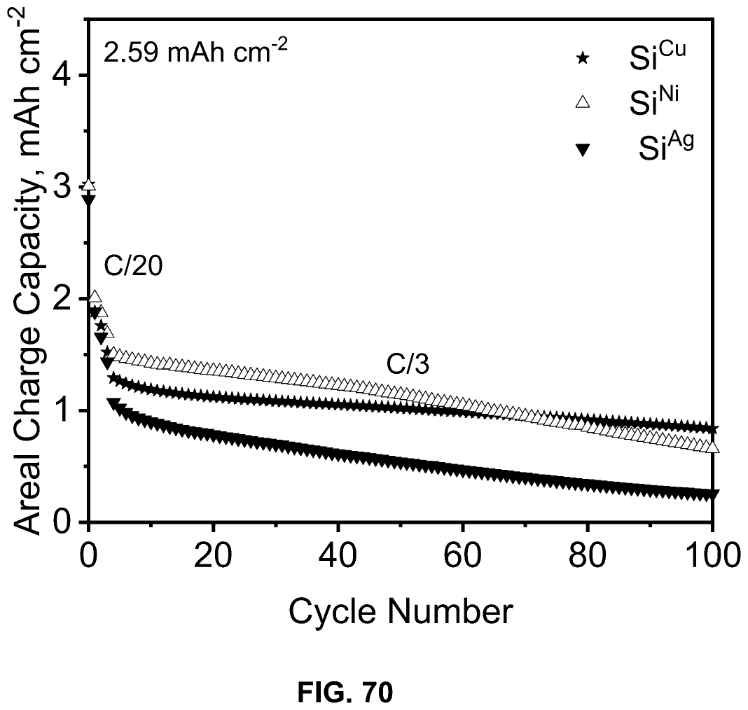

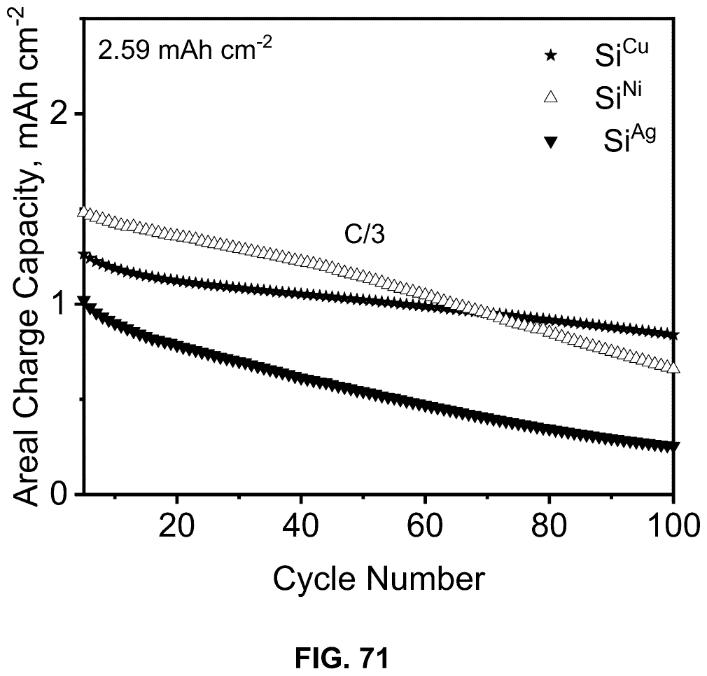

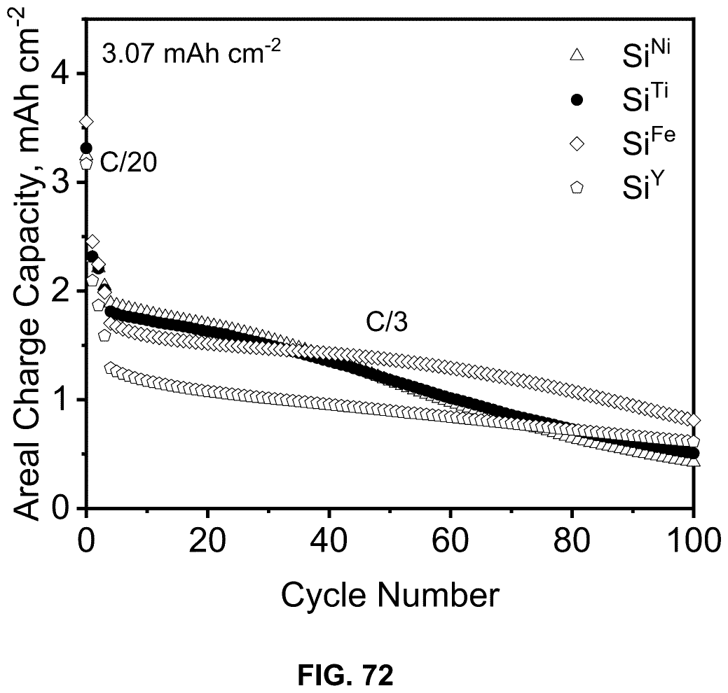

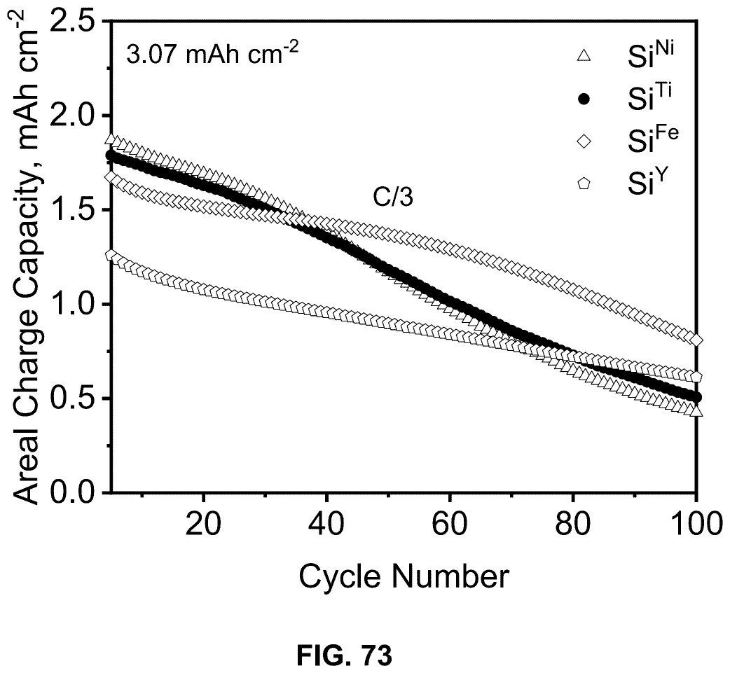

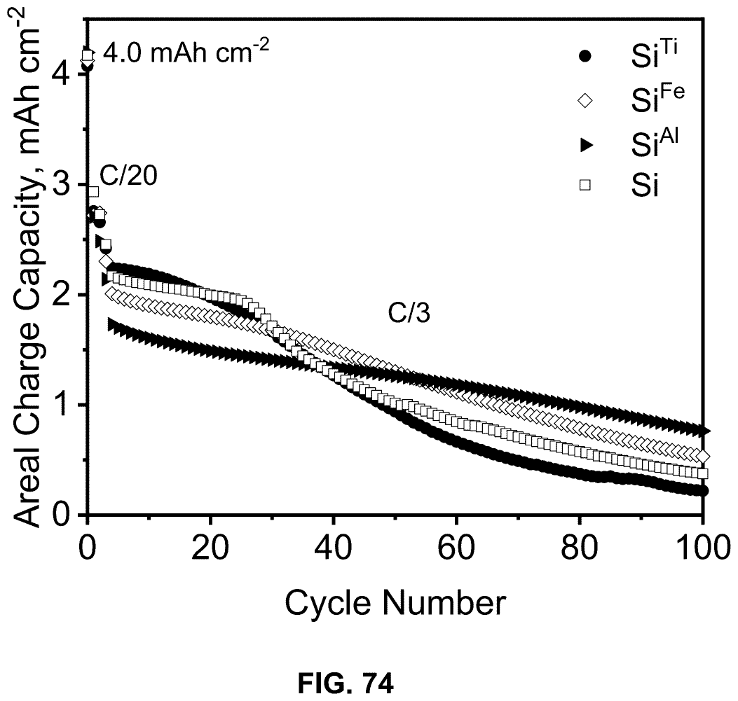

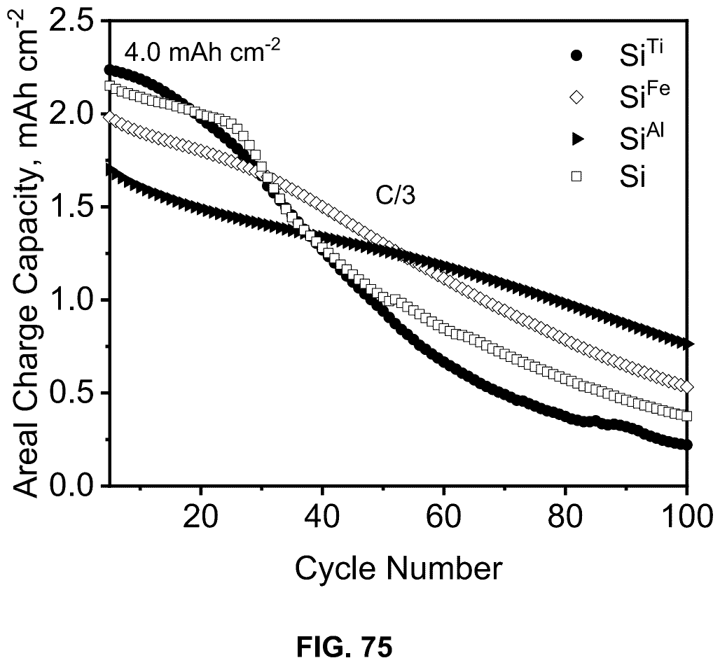

FIGS. 70-75 are comparisons of the areal charge capacities (mAh cm⁻²) with different areal loadings (FIGS. 70-71: 2.59; FIGS. 72-73: 3.07; FIGS. 74-75 4.0 mAh cm⁻², where FIGS. 71, 73 and 75 are magnified images of FIGS. 70, 72 and 74, respectively) as a function of cycle number obtained for Si^{M} (10 vol % M) with mass ratio of Cu:Si (20:35), Ni:Si (20:35), Ti:Si (10:35), Fe:Si (17:35), Al:Si (6:35) Y:Si (10:35), and Ag:Si (20:35). The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

Full Cell Performance of Si^{M} Electrodes with 5 vol % of M

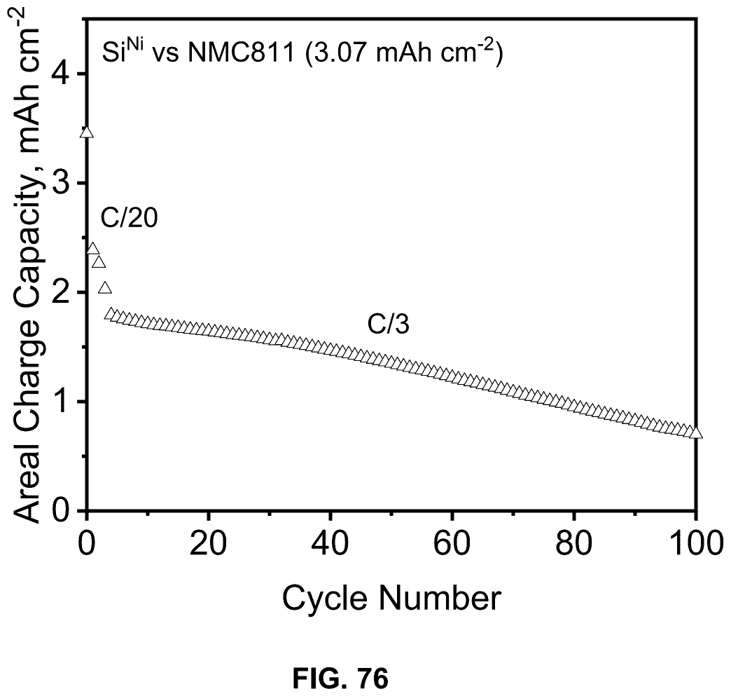

FIG. 76 is a plot of areal charge capacity (mAh cm⁻²) as a function of cycle number obtained for Si^{Ni} (5 vol % Ni) with a mass ratio of 10:35 for Ni:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

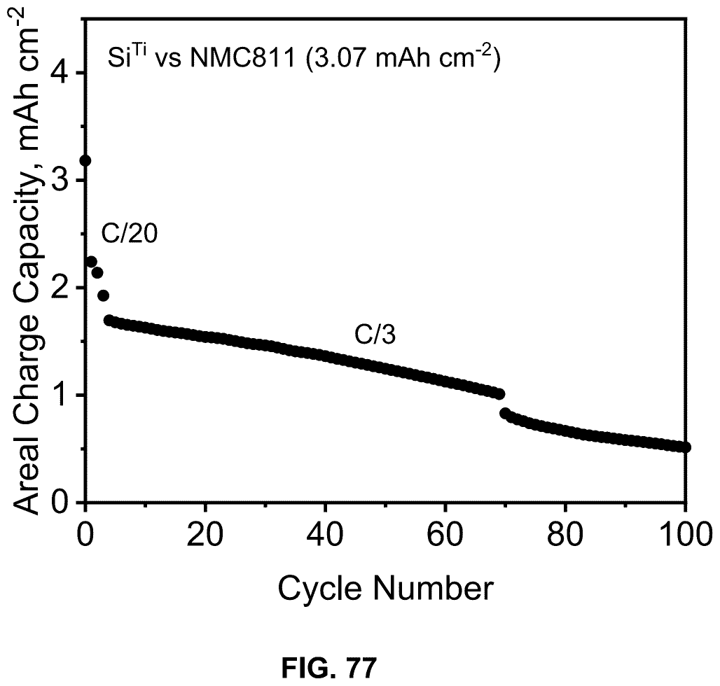

FIG. 77 is a plot of areal charge capacity (mAh cm⁻²) as a function of cycle number obtained for Si^{Ti} (5 vol % Ti) with a mass ratio of 5:35 for Ti:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

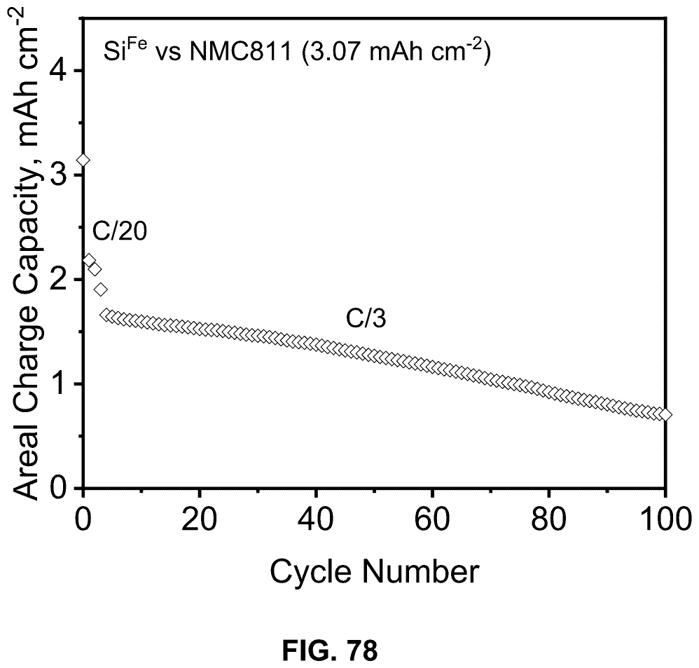

FIG. 78 is a plot of areal charge capacity (mAh cm⁻²) as a function of cycle number obtained for Si^{Fe} (5 vol % Fe) with a mass ratio of 8.5:35 for Fe:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

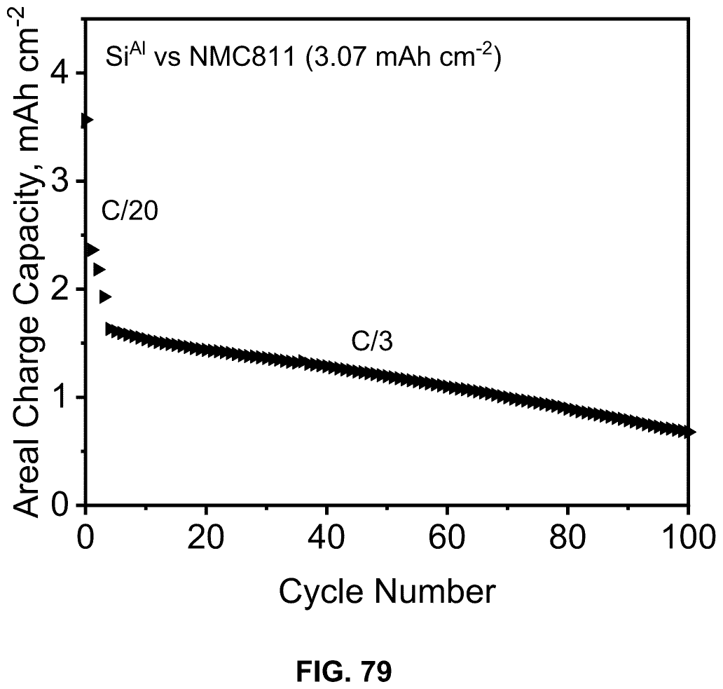

FIG. 79 is a plot of areal charge capacity (mAh cm⁻²) as a function of cycle number obtained for Si^{Al} (5 vol % Al) with a mass ratio of 3:35 for Al:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

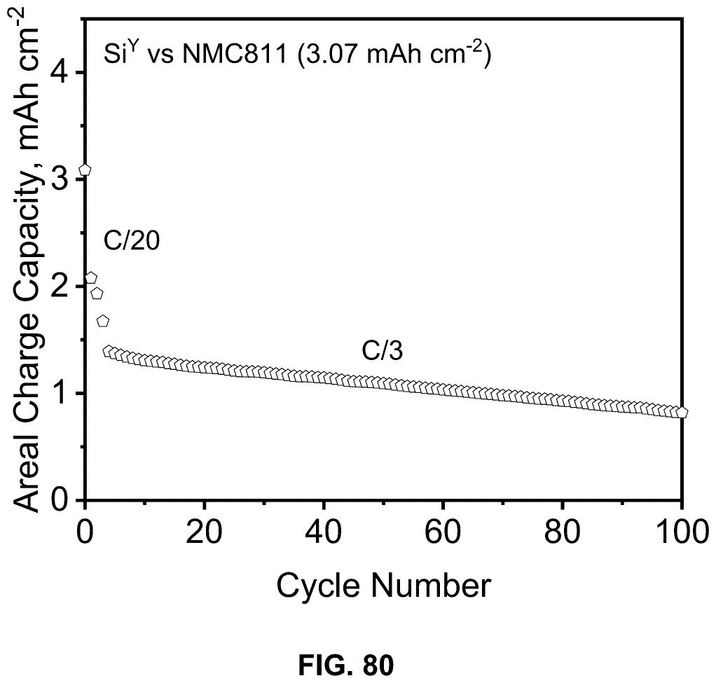

FIG. 80 is a plot of areal charge capacity (mAh cm⁻²) as a function of cycle number obtained for Si^{Y} (5 vol % Y) with a mass ratio of 5:35 for Y:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

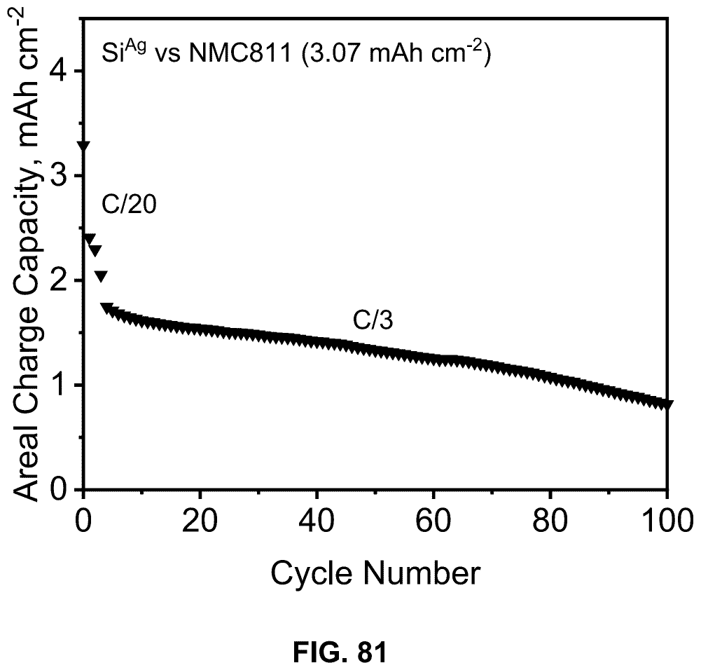

FIG. 81 is a plot of areal charge capacity (mAh cm⁻²) as a function of cycle number obtained for Si^{Ag} (5 vol % Ag) with a mass ratio of 10:35 for Ag:Si. The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

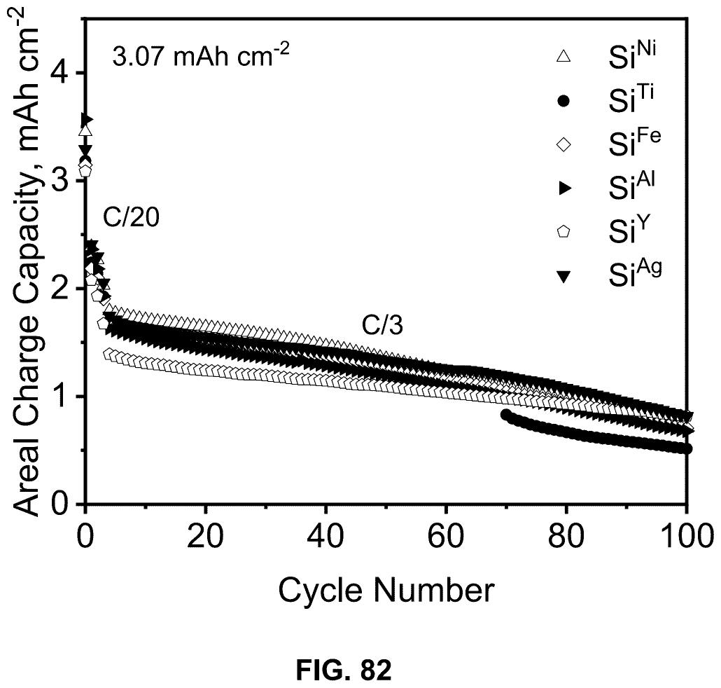

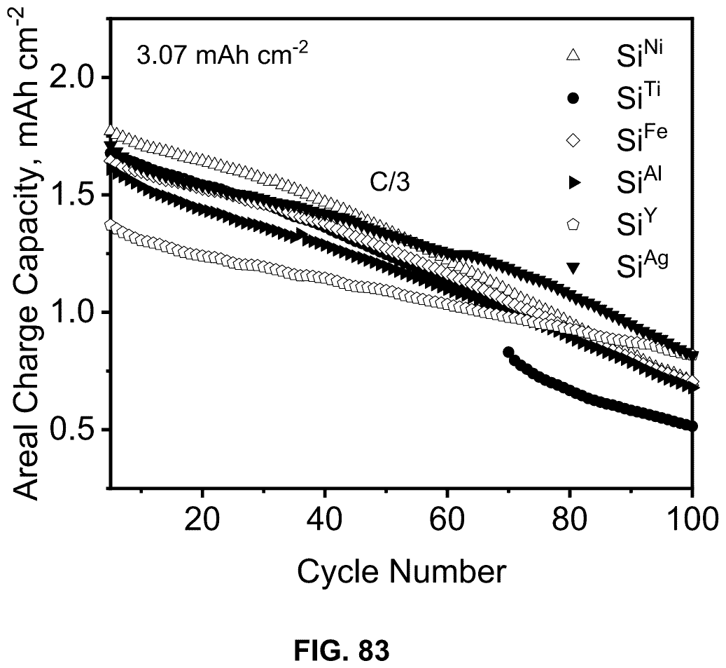

FIGS. 82 and 83 are comparisons of areal charge capacities (mAh cm⁻²) (FIG. 83 is a magnified image of FIG. 82) as a function of cycle number obtained for Si^{M} (5 vol % M) with mas ratio of Ni:Si (10:35), Ti:Si (5:35), Fe:Si (8.5:35), Al:Si (6:35), and Y:Si (5:35). The cells were cycled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Cycling was performed in galvanostatic mode with a voltage window of 4.1 V and 3.0 V and a cycling rate of C/20 for the formation steps (performed 3 times) and C/3 for long-term cycling. Data were measured at room temperature.

Parasitic Currents of Si^{M} Electrodes with 10 Vol % of M Vs NMC811

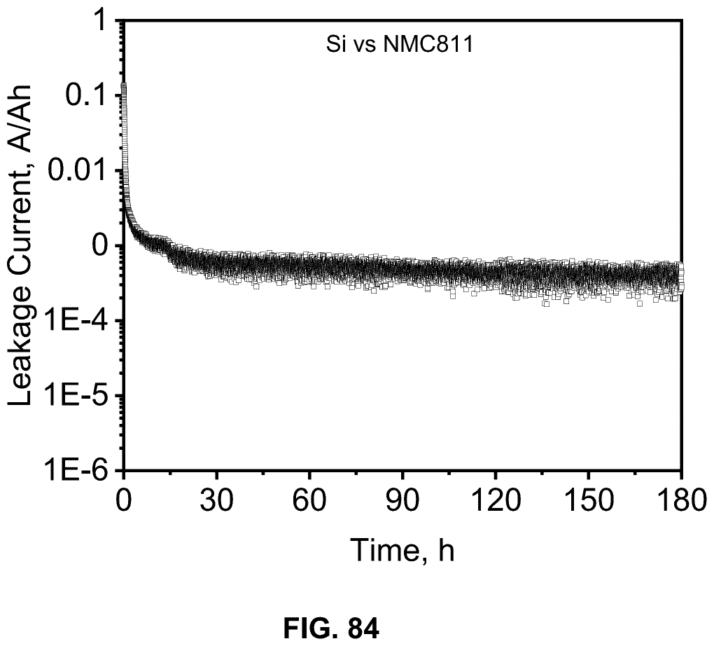

FIG. 84 is a plot of parasitic currents for the baseline Si measured during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

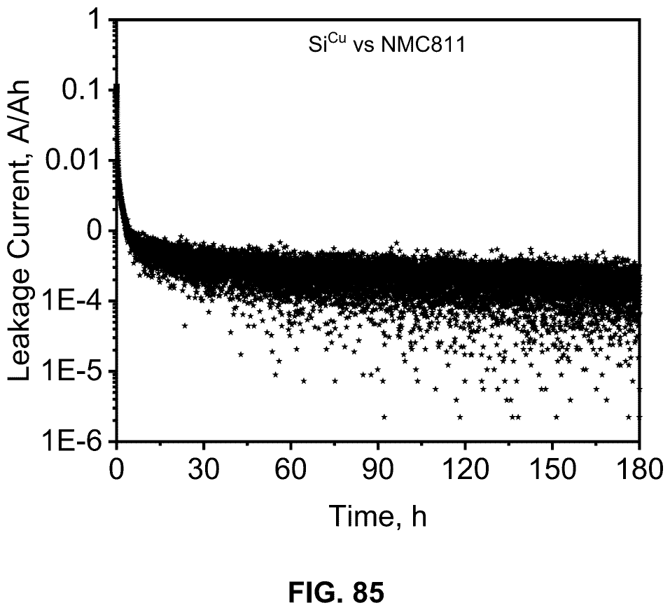

FIG. 85 is a plot of parasitic currents measured for Si^{Cu} (10 vol % Cu) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

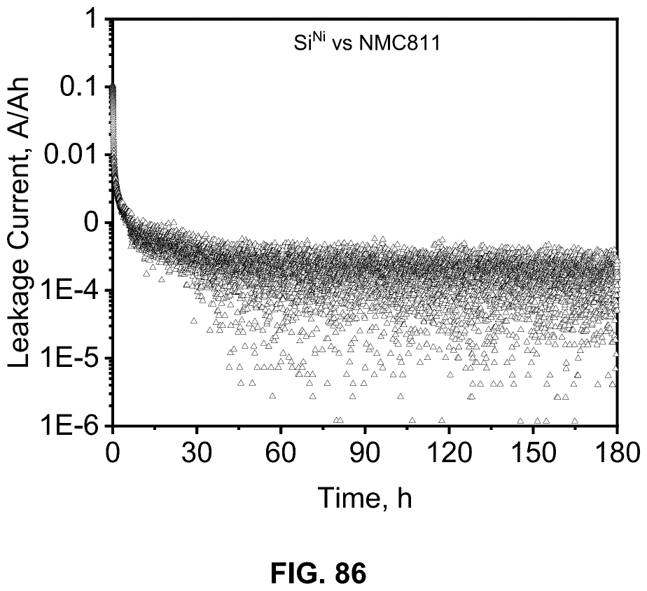

FIG. 86 is a plot of parasitic currents measured for Si^{Ni} (10 vol % Ni) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

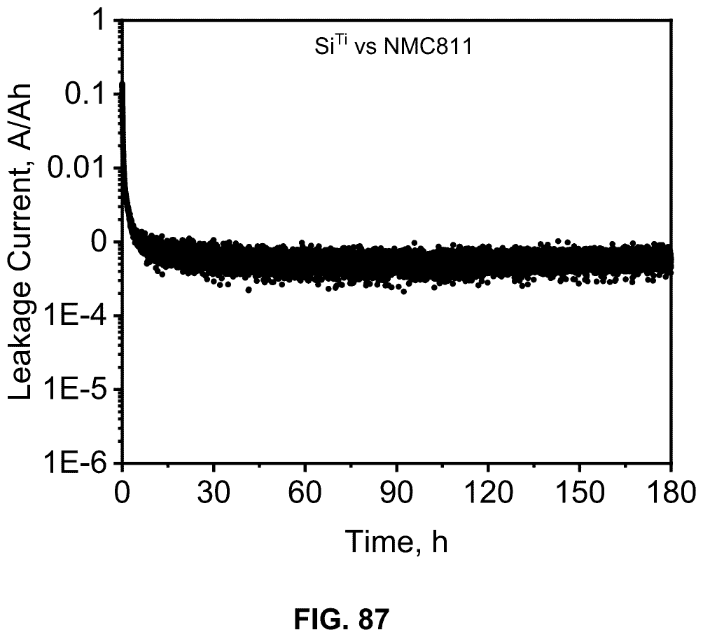

FIG. 87 is a plot of parasitic currents measured for Si^{Ti} (10 vol % Ti) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

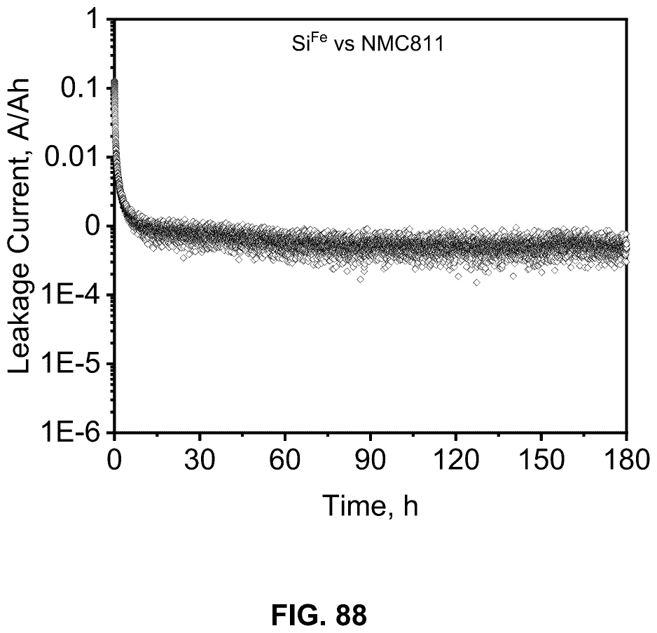

FIG. 88 is a plot of parasitic currents measured for Si^{Fe} (10 vol % Fe) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

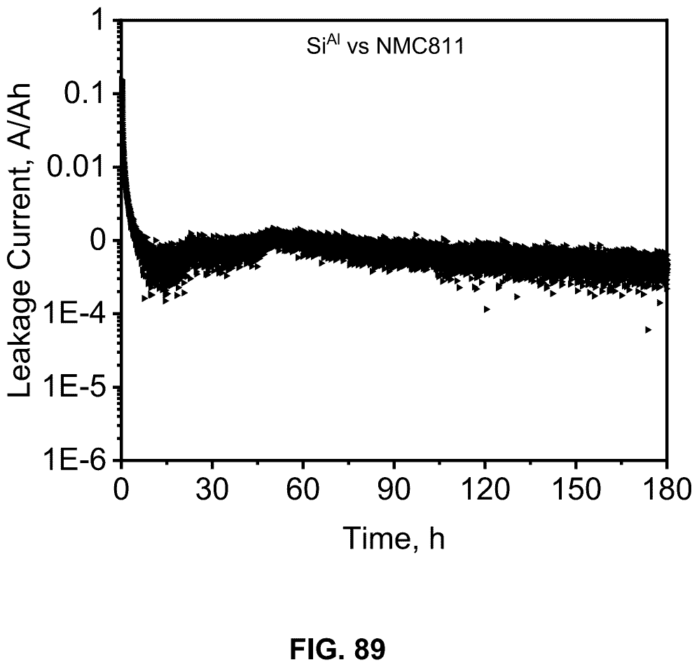

FIG. 89 is a plot of parasitic currents measured for Si^{Al} (10 vol % Al) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

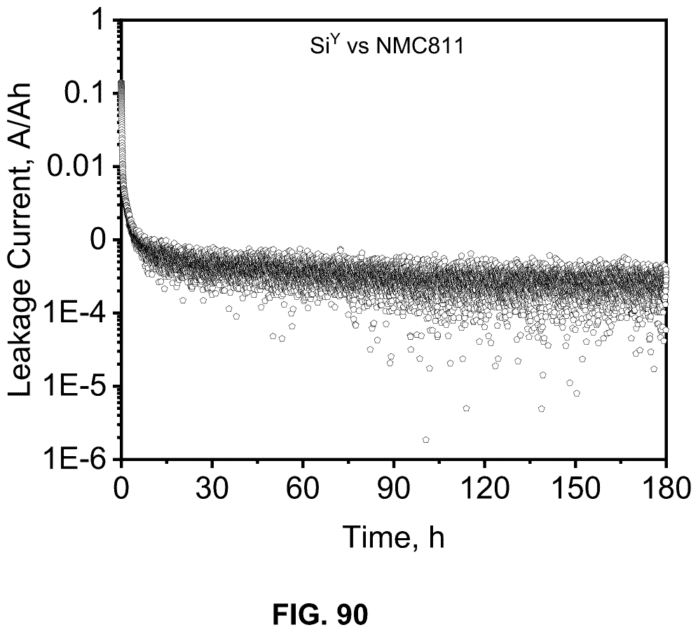

FIG. 90 is a plot of parasitic currents measured for Si^{Y} (10 vol % Y) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

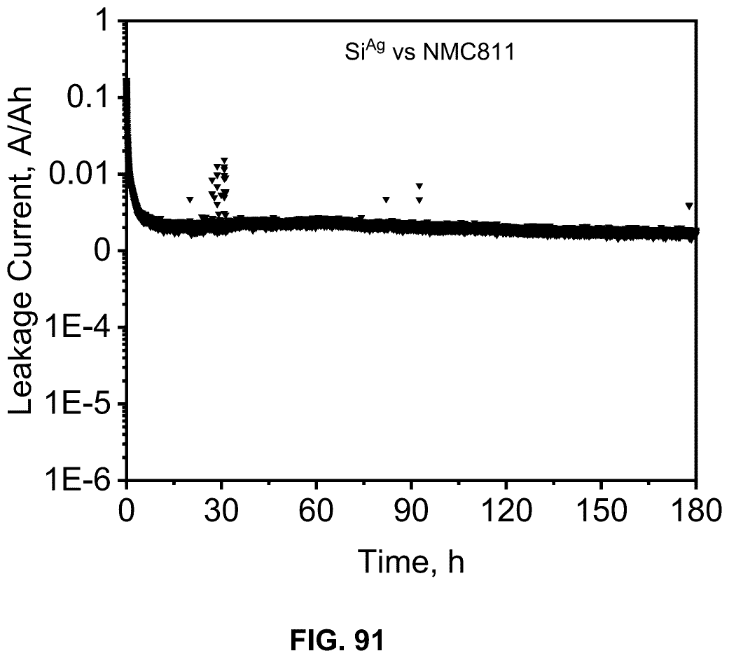

FIG. 91 is a plot of parasitic currents measured for Si^{Ag} (10 vol % Ag) during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

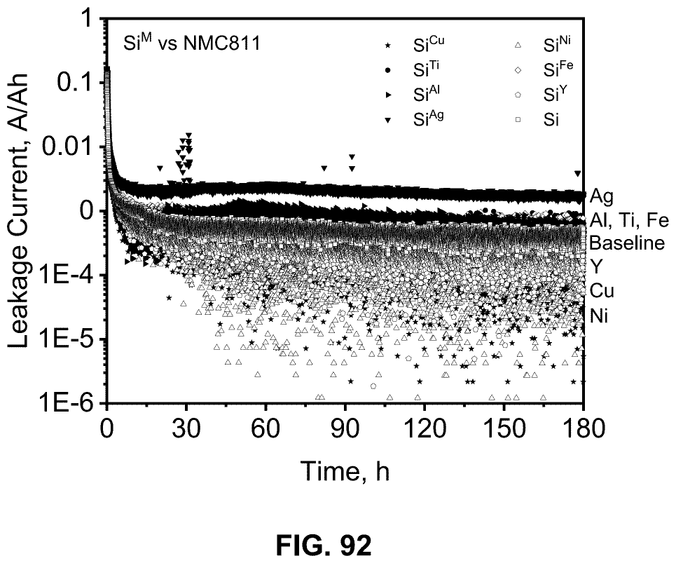

FIG. 92 is a comparison of the parasitic currents for Si^{M} (10 vol % M) measured during a 180-hour voltage hold period at 4.1 V (Leakage Current, A/Ah vs. Time, h). The cells were assembled in full-cell configuration using coin cells and using NMC811 as the cathode and 1.2 M LiPF₆ in 3/7 w/w ethylene carbonate/ethyl methyl carbonate+3 wt % fluoroethylene carbonate as the electrolyte. Formation cycling was performed in galvanostatic mode with a voltage window of 4.1 V and 3.0 V and a cycling rate of C/10 prior to the voltage hold period. Data were measured at room temperature.

TEM Images of the Decorated Si Particles (Si^{M}) with 10 vol % M

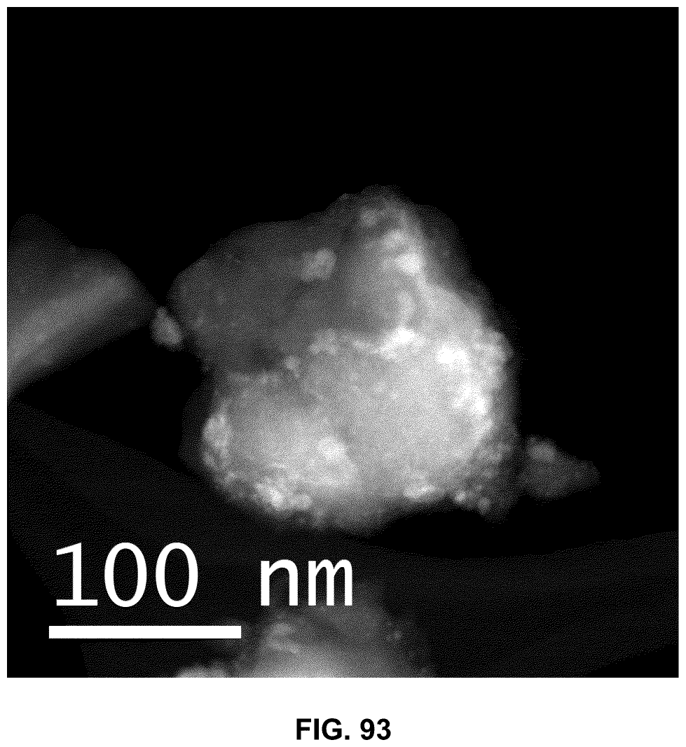

FIG. 93 is a TEM annular dark-field image of Si^{Cu} (20:35 Cu:Si or 10 vol % Cu) and TEM EELS image for Cu showing clusters of Cu dotting the surface of Si.

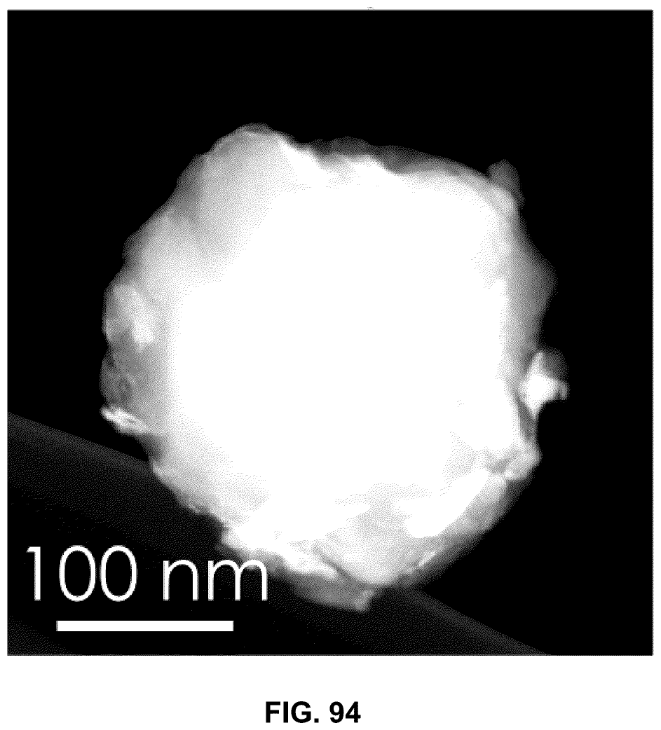

FIG. 94 is a TEM annular dark-field image of Si^{Ni} (20:35 Ni:Si or 10 vol % Ni) and TEM EELS image for Ni showing clusters of Ni dotting the surface of Si.

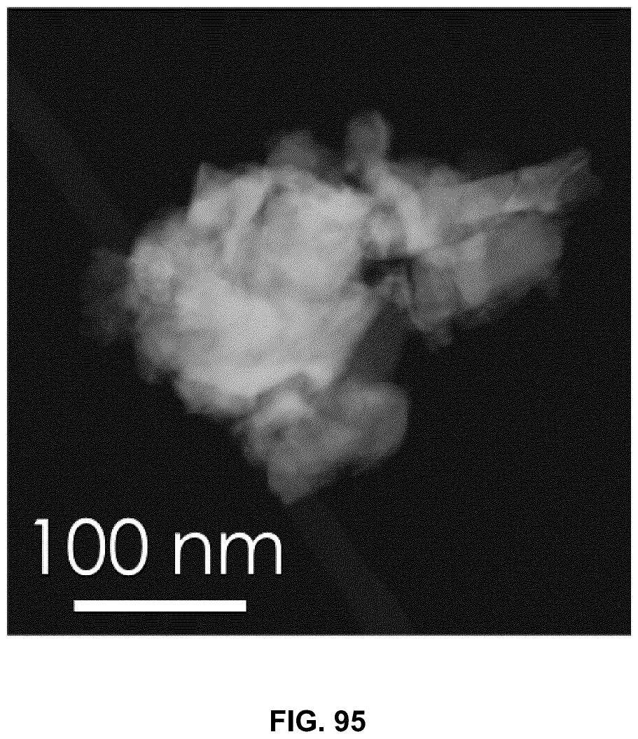

FIG. 95 is a TEM annular dark-field image of Si^{Ti} (10:35 Ti:Si or 10 vol % Ti) and TEM EELS image for Ti showing clusters of Ti dotting the surface of Si.

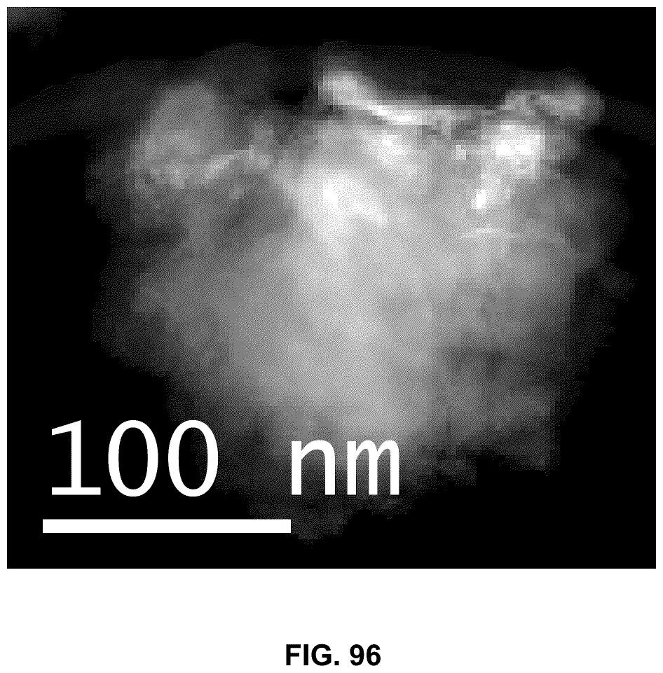

FIG. 96 is a TEM annular dark-field image of Si^{Fe} (17:35 Fe:Si or 10 vol % Fe) and TEM EELS image for Fe showing clusters of Fe dotting the surface of Si.

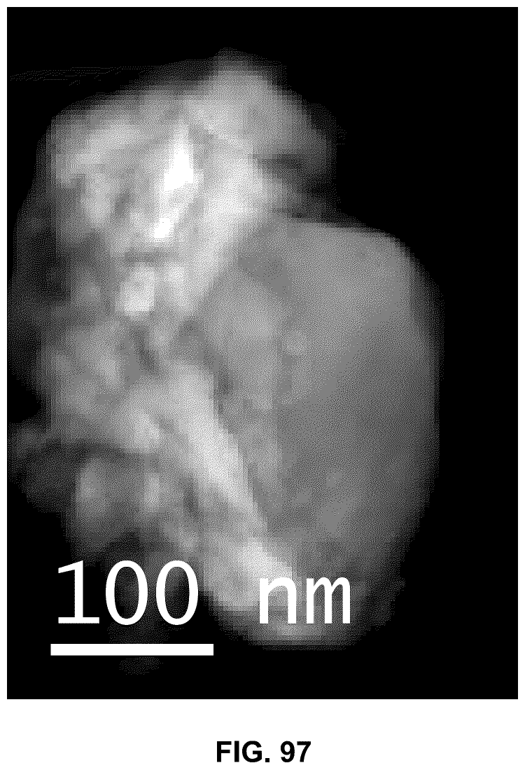

FIG. 97 is a TEM annular dark-field image of Si^{Al} (6:35 Al:Si or 10 vol % Al) and TEM EELS image for Al showing clusters of Al dotting the surface of Si.

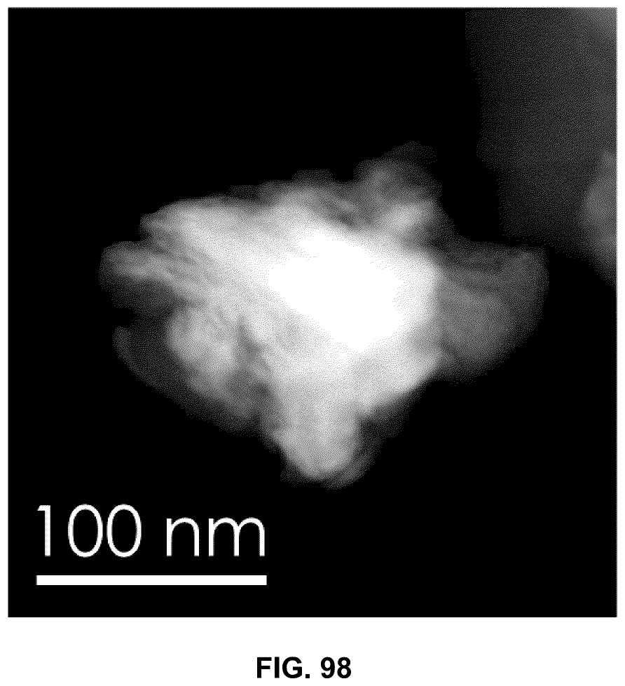

FIG. 98 is a TEM annular dark-field image of Si^{Y} (10:35 Y:Si or 10 vol % Y) and TEM EELS image for Y showing clusters of Y dotting the surface of Si.

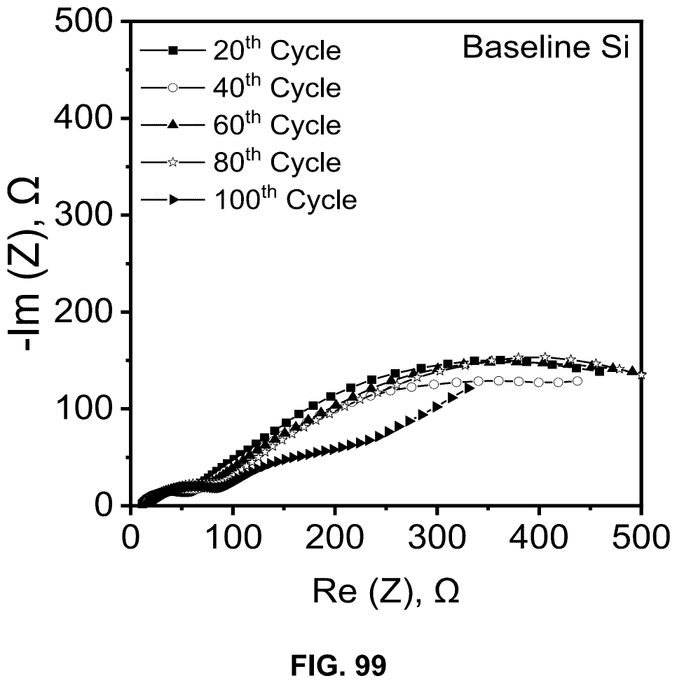

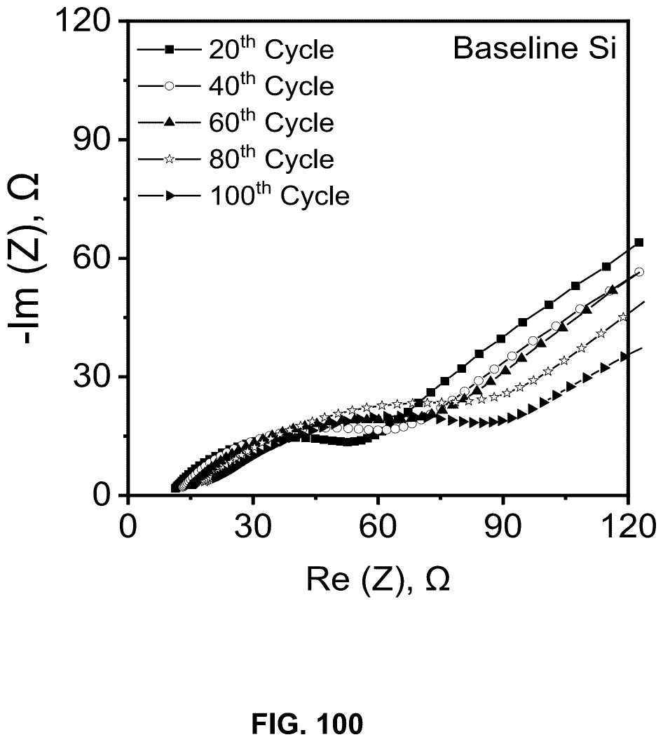

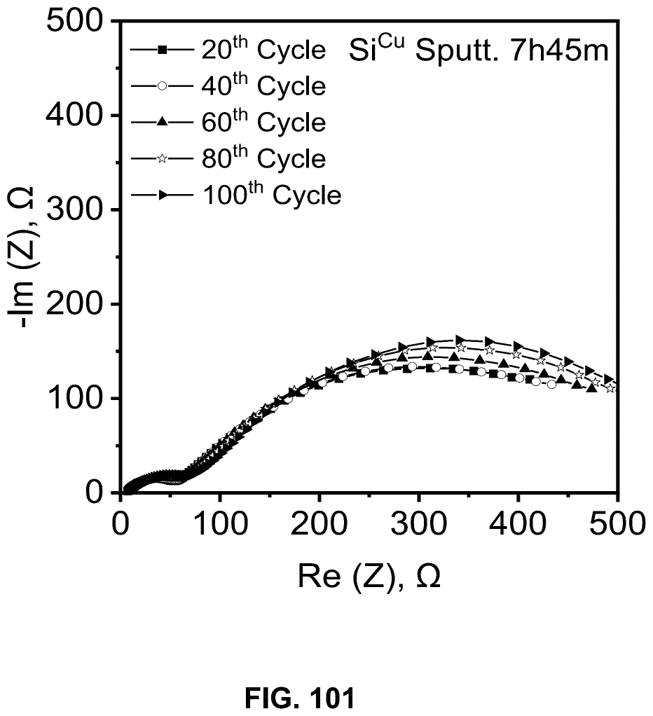

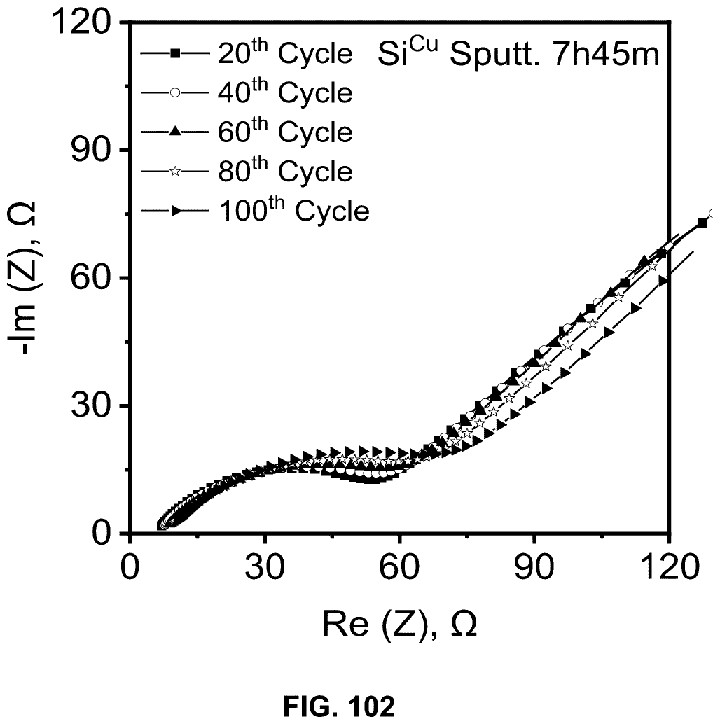

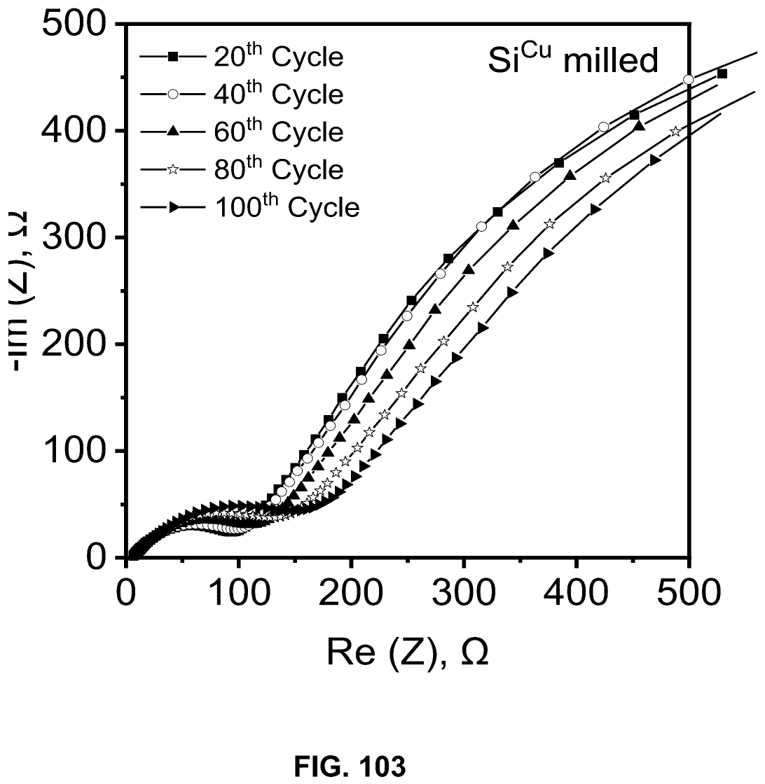

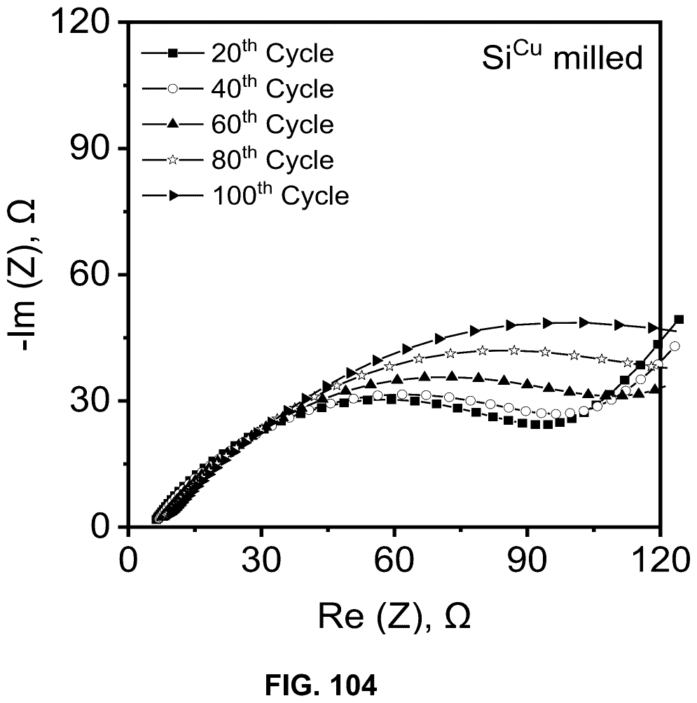

FIGS. 99-104 are plots of impedance data (—Im(Z),Ω vs Re(Z),Ω) measured for bare silicon (FIGS. 99-100), PVD grown silicon (FIGS. 101-102), and Si^{Cu} electrodes (FIGS. 103-104), where FIGS. 100, 102 and 104 are magnified images of FIGS. 99, 101, and 103, respectively. The data shows a change in interfacial resistance with the addition of copper. The Si^{Cu} material has much higher resistance than the baseline materials and sputtered material indicating in this case the resistance improves electrode stability by preventing electrochemical degradation.

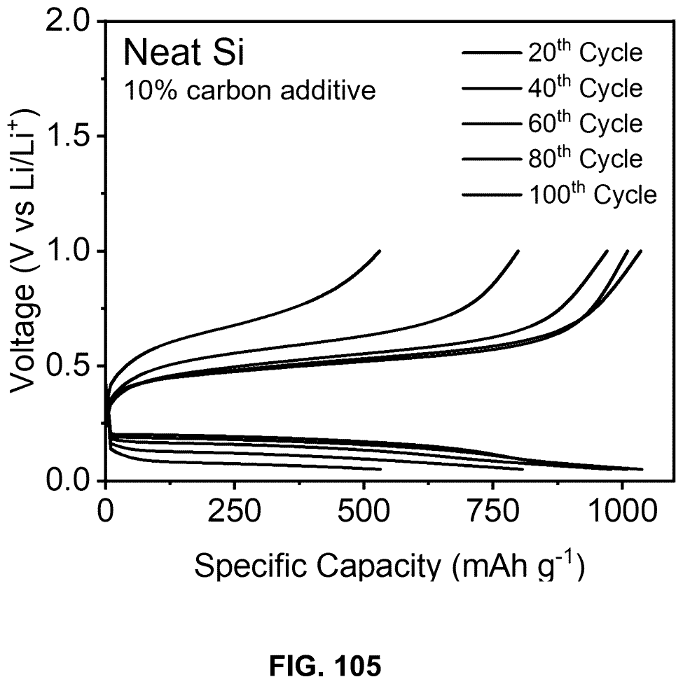

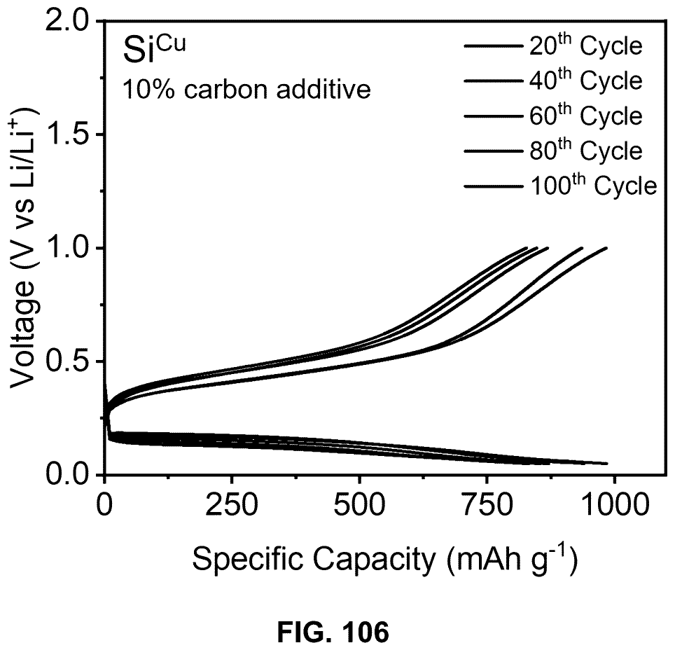

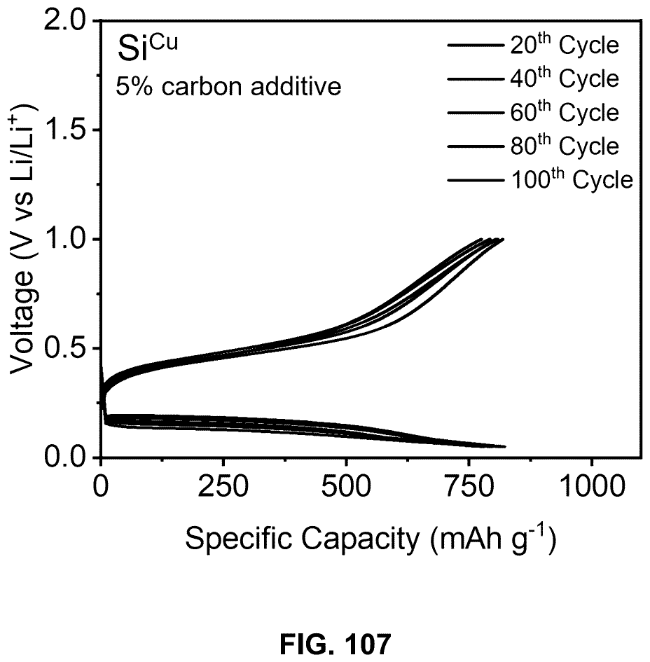

FIGS. 105-107 are plots of voltage (V vs. Li/Li⁺) vs specific capacity (mAh cm⁻²) for neat Si (*FIG. 105), Si^{Cu} with 10% carbon additive (FIG. 106) and Si^{Cu} with 5% carbon additive (FIG. 107), illustrating unique features as measured in half cell geometries with 3% FEC in 1.2M LiPF₆ EC/EMC (3:7 wt %). First, electrodes with less and less carbon exhibit lower overvoltages with cycling than standard cell chemistry with 10% carbon additive as is traditionally done. Second, even with 10% carbon added the Si^{Cu} cells perform significantly better as exhibited by lower overvoltage with charging and less drift in capacity and voltages with cycling compared to neat silicon. The copper improves electrical interconnections (as evident by the lower overvoltages) and reduces losses with cycling due to the elimination of carbon.

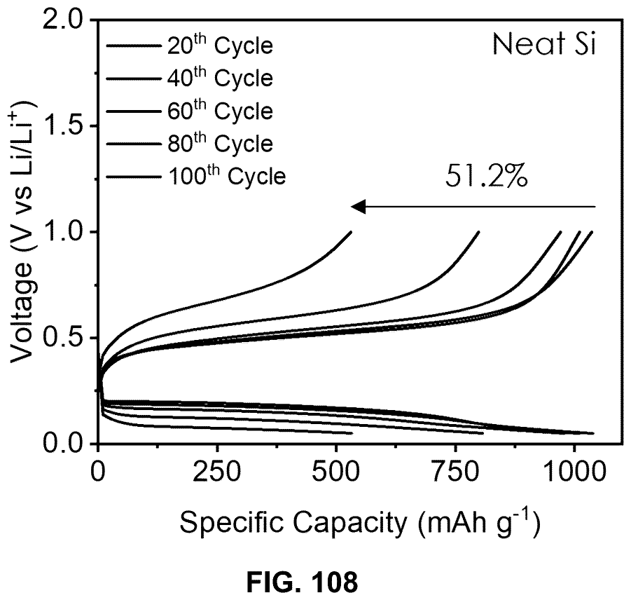

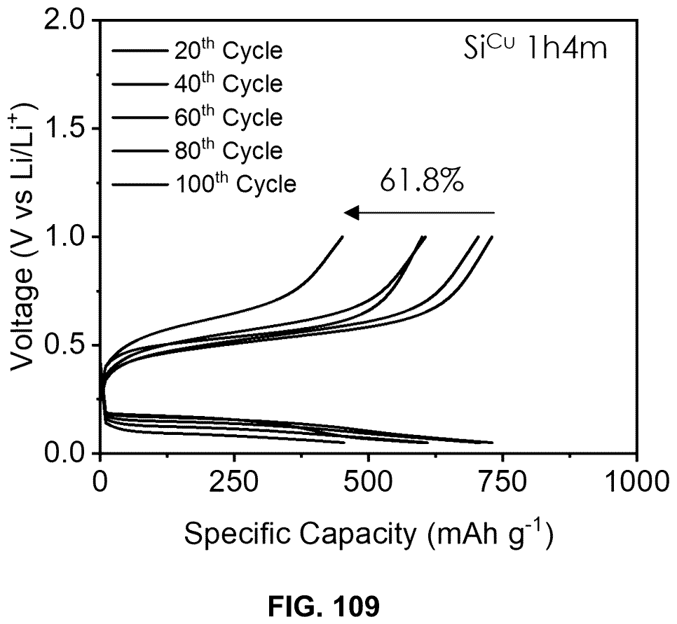

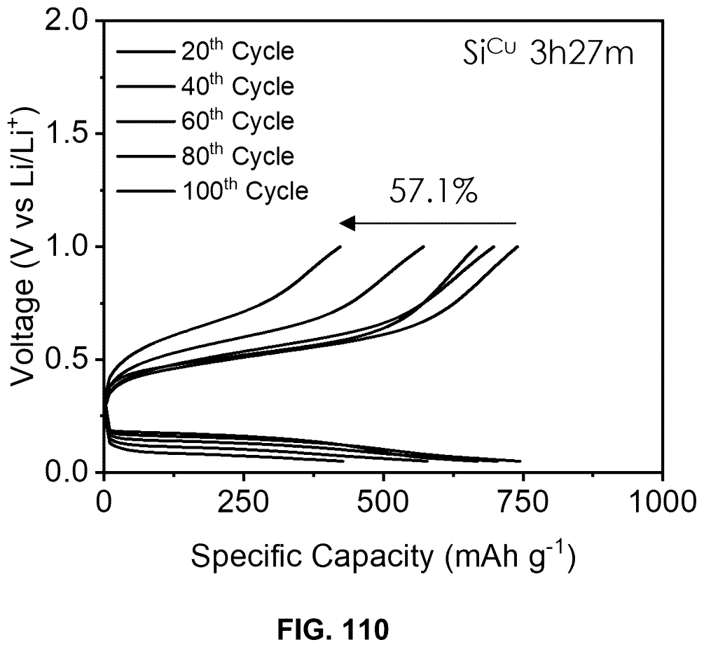

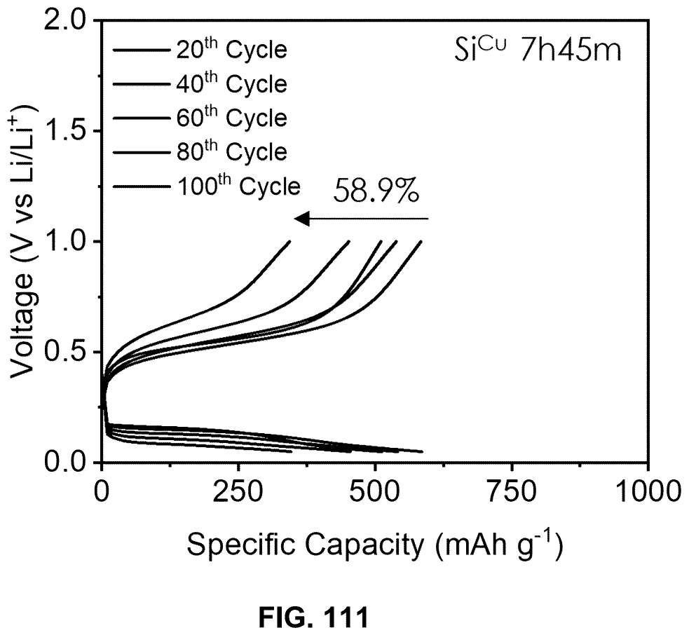

FIGS. 108-111 are plots of voltage (V vs. Li/Li⁺) vs specific capacity (mAh cm⁻²) for neat Si (FIG. 108), Si^{Cu} 1 h4 m (FIG. 109), Si^{Cu} 3 h27 m (FIG. 110, and Si^{Cu} 7 h45 m (FIG. 111). The figures demonstrate the power of the unique microballast geometry measurements in half cell geometries with 3% FEC in 1.2M LiPF₆ EC/EMC (3:7 wt %). The conformal coating of silicon by copper through a PVD process results in a steady decrease in capacity due to the conformal nature of copper blocking ion transport and the higher surface coverage commensurate with longer deposition times (neat, 1H14 min, 3 h27 min, and 7 h45 m). The microballast electrodes don't suffer these limitations due to the isolated domains of metal that improve electrical interconnections while still facilitating interactions with the liquid electrolytes.

The origin of this enhancement is due to the nature of the electrode active heteroclusters and their electrochemical stability with lithium metal as well as their reactivity with silicon. Critical to this work is the heterostructure nature. If the particles are homogeneously distributed throughout the electrode this would constitute an alloy or an intermetallic depending on the phase diagram. This technology requires discrete locations of the metal particles to get the ballast effect.

The manufacturing of these particles requires a process that is high enough energy to promote mixing but low enough energy to prevent alloying. Typically in ball milling the use of large media, >20× the size of the silicon particles, causes alloying due to the large mass and energy associated with impacts. Therefore, the mass of media should be small enough to promote mixing but not high enough to promote alloying. Materials with promoting behavior include Ni, Ti, Cu. Negative behavior includes Y, Ag. Intermediate metals include Al and Fe.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. An electrode, the electrode comprising an electrode active material layer comprising electrode active heteroclusters, the electrode active heteroclusters comprising an electrode active material particle having an electrolyte contacting outer surface and a plurality of metal particles non-homogeneously distributed around and confined to and in electrical contact with the electrolyte contacting outer surface, wherein the metal particles have a largest dimension that is smaller than the largest dimension of the electrode active material particle to which they are attached, and wherein the metal particles of an electrode active heterocluster are in electrical contact with at least one adjacent electrode active heterocluster.

2. The electrode of claim 1, wherein the non-homogeneous distribution of the metal particles over the outer surface of the electrode active material particle includes a metal particle dense portion relative to other portions of the electrolyte contacting outer surface, and wherein the metal particle dense portions are oriented in a common direction.

3. The electrode of claim 2, further comprising a current collector, and wherein the metal particle dense portions of the electrode active heteroclusters are oriented toward the current collector.

4. The electrode of claim 1, wherein the metal particles have a largest dimension of from 5 nm to 100 nm.

5. The electrode of claim 1, wherein the electrode active material particles have a largest dimension of from 10 nm to 10 microns.

6. The electrode of claim 1, wherein the electrode active heteroclusters have a largest dimension of from 5 nm to 1.1 microns.

7. The electrode of claim 1, wherein the electrolyte contacting outer surface has a surface area, and the metal particles cover from 5% to 50% of the surface area of the electrolyte contacting surface.

8. The electrode of claim 1, wherein the metal particles have a thickness of from 1 to 20 monolayers.

9. The electrode of claim 1, wherein the electrode is an anode and the electrode active material comprises at least one selected from the group consisting of Si, graphite, Li₄Ti₅O₁₂, Sn, and Sb.

10. The electrode of claim 1, wherein the electrode is a cathode and the electrode active material comprises at least one selected from the group consisting of Li(MnNiCo)O₂, LiFePO₄, LiMnPO₄, LiMn_{1.5}Ni_{0.5}O₄, and LiMn₂O₄.

11. The electrode of claim 1, wherein the metal particles comprise at least one selected from the group consisting of Cu, Ni, Ag, Al, Fe, Ti, Y, or Ce.

12. The electrode of claim 1, wherein the metal particles are confined to the electrolyte contacting outer surface through at least one selected from the group consisting of van der Waals, ionic, static, and steric forces.

13. The electrode of claim 1, wherein the metal particles of the electrode active heteroclusters have a reduction potential around ±0.5V relative to H₂/H⁺.

14. The electrode of claim 1, wherein the heteroclusters of metal particles are capable of forming an electrochemical double layer in the electrolyte adjacent the electrolyte contacting surface.

15. A method of making an electrode, comprising the steps of:
providing a plurality of heteroclusters, comprising an electrode active material particle having an electrolyte contacting outer surface and a plurality of metal particles non-homogeneously distributed around and confined to and in electrical contact with the electrolyte contacting outer surface, wherein the metal particles have a largest dimension that is smaller than the largest dimension of the electrode active material particle to which they are attached, wherein the non-homogeneous distribution of the metal particles over the outer surface of the electrode active material particle includes a metal particle dense portion relative to other portions of the electrolyte contacting outer surface
preparing a solvent mixture of the heteroclusters in a solvent;
forming the solvent mixture into an electrode preform, wherein the metal particle dense portions are oriented in a common direction under the influence of gravity;
removing the solvent from the electrode preform to form an electrode wherein the metal particles of an electrode active heterocluster are in electrical contact with at least one adjacent electrode active heterocluster.

16. The method of claim 15, wherein the step of removing solvent from the electrode preform comprises heating the electrode preform.

17. The method of claim 16, wherein the heating step comprises heating the electrode preform to a temperature below 300° C.

18. The method of claim 15, wherein the step of forming the solvent mixture into an electrode preform comprises the step of applying the solvent mixture to a current collector.

19. The method of claim 15, wherein the mixing step comprises ball milling with media having a largest dimension greater than 20 times the largest dimension of the electrode active material particles.

20. The method of claim 15, wherein the metal particles have a largest dimension of from 5 nm to 100 nm.

21. The method of claim 15, wherein the electrode active material particles have a largest dimension of from 20 nm to 10 microns.

22. The method of claim 1, wherein the electrode active heteroclusters have a largest dimension of from 25 nm to 1.1 microns.

23. A battery, comprising an electrode, comprising an electrode active material layer comprising electrode active heteroclusters, the electrode active heteroclusters comprising an electrode active material particle having an electrolyte contacting outer surface and a plurality of metal particles non-homogeneously distributed around and confined to and in electrical contact with the electrolyte contacting outer surface, wherein the metal particles have a largest dimension that is smaller than the largest dimension of the electrode active material particle to which they are attached, and wherein the metal particles of an electrode active heterocluster are in electrical contact with at least one adjacent electrode active heterocluster.

24. The battery of claim 23, wherein the electrode is an anode and the electrode active material comprises at least one selected from the group consisting of Si, graphite, Li₄Ti₅O₁₂, Sn, and Sb.

25. The battery of claim 23, wherein the electrode is a cathode and the electrode active material comprises at least one selected from the group consisting of Li(MnNiCo)O₂, LiFePO₄, LiMnPO₄, LiMn_{1.5}Ni_{0.5}O₄, and LiMn₂O₄.

26. The battery of claim 23, wherein the metal particles comprise at least one selected from the group consisting of Cu, Ni, Ag, Al, Fe, Ti, Y, or Ce.

27. A method of making a battery, comprising the steps of:
providing a plurality of heteroclusters, comprising an electrode active material particle having an electrolyte contacting outer surface and a plurality of metal particles non-homogeneously distributed around and confined to and in electrical contact with the electrolyte contacting outer surface, wherein the metal particles have a largest dimension that is smaller than the largest dimension of the electrode active material particle to which they are attached, wherein the non-homogeneous distribution of the metal particles over the outer surface of the electrode active material particle includes a metal particle dense portion relative to other portions of the electrolyte contacting outer surface;
preparing a solvent mixture of the heteroclusters in a solvent;
forming the solvent mixture into an electrode preform, wherein the metal particle dense portions are oriented in a common direction under the influence of gravity, and wherein the metal particles of an electrode active heterocluster are in electrical contact with at least one adjacent electrode active heterocluster;
removing the solvent from the electrode preform to form an electrode;
electrically connecting the electrode to a counter electrode and adding an electrolyte to form a battery.

28. The method of claim 27, wherein the step of forming the solvent mixture into an electrode preform comprises the step of applying the solvent mixture to a current collector.
